(19) United States
(12) Patent Application Publication
(10) Pub. No.: US 2018/0243636 A1
(43) Pub. Date: Aug. 30, 2018

(54) SKI SYSTEM AND TRACK SYSTEM FOR A VEHICLE

(71) Applicant: CAMSO INC., MAGOG (CA)

(72) Inventors: JEREMIE ZUCHOSKI, SHERBROOKE (CA); BERNARD JEAN, ST-MATHIEU DU PARC (CA); GUILLAUME LAPLANTE, SHERBROOKE (CA)

(21) Appl. No.: 15/755,382

(22) PCT Filed: Aug. 25, 2016
(86) PCT No.: PCT/CA2016/051005

§ 371 Date: Feb. 26, 2018

Related U.S. Application Data
(60) Provisional application No. 62/293,024, filed on Feb. 9, 2016.
(60) Provisional application No. 62/209,557, filed on Aug. 25, 2015.

(51) Int. Cl. A63C 5/035; B62D 55/04; B62D 55/07; B62M 27/02

(52) U.S. Cl. CPC A63C 5/035; B62D 55/04; B62D 55/07; B62M 27/02; B62M 2027/027; B62M 2027/022; B62M 2027/025; B62M 2027/026; B62M 2027/021

(57) ABSTRACT

A ski system and a track system for a vehicle. The ski system includes a ski and a ski mount to connect the ski to the vehicle. The track system includes a track-engaging assembly and a track disposed around the track-engaging assembly. The ski system and the track system may be designed to enhance travel of the vehicle on the ground, including to facilitate banking of the vehicle (e.g., to turn, on a side hill, etc.), steering of the vehicle by turning the ski system, and/or moving on harder snow (e.g., packed snow).

### CROSS-REFERENCE TO RELATED APPLICATIONS

This application claims priority from U.S. Provisional Patent Applications 62/209,557 and 62/293,024 respectively filed on Aug. 25, 2015 and Feb. 9, 2016 and incorporated by reference herein.

### FIELD

The invention relates generally to off-road vehicles and, more particularly, to ski systems and track systems for such vehicles.

### BACKGROUND

Snow vehicles for travelling on snow may comprise a ski system in their front for steering and a track system in their rear for traction. In some cases, such as snowmobiles, the ski system includes a pair of skis and the vehicle may remain generally upright when turned. In other cases, such as snow bikes, the ski system includes a single ski and the vehicle may be leaned significantly when turned.

For instance, an off-road motorcycle can be converted into a snow bike by replacing its front wheel and its rear wheel with a ski system and a track system, respectively, thereby allowing the motorcycle to be used in snow. While this is certainly useful, the ski system and/or the track system may cause performance issues. For example, in some cases, this may perform adequately in certain snow conditions (e.g., powder snow) but not in others (e.g., hard packed snow), adversely affect leaning capability and/or stability, and/or generate undesirable feedback at handlebars or otherwise affect ride quality.

Similar considerations may arise in other types of snow vehicles that are not motorcycles but are rather originally built with ski systems and track systems.

For these and/or other reasons, there is a need to improve ski systems and/or track systems for vehicles.

### SUMMARY

In accordance with one aspect of the invention, there is provided a ski system for a vehicle on snow. The ski system comprises a ski to slide on the snow and a ski mount to connect the ski to the vehicle. The ski is configured to facilitate a transition from an upright position of the vehicle to a leaning position of the vehicle when the vehicle is banked.

In accordance with another aspect of the invention, there is provided a ski system for a vehicle on snow. The ski system comprises a ski to slide on the snow and a ski mount to connect the ski to the vehicle. The ski is disposed in a center of the vehicle in a widthwise direction of the vehicle when the ski mount connects the ski to the vehicle. The ski comprises a ground-engaging lower side to slide on the snow and an upper side opposite to the ground-engaging lower side and facing towards the ski mount. The ground-engaging lower side of the ski comprises a ground-engaging lower surface and four keels projecting from the ground-engaging lower surface and spaced apart in a widthwise direction of the ski.

In accordance with another aspect of the invention, there is provided a ski system for a vehicle on snow. The ski system comprises a ski to slide on the snow and a ski mount to connect the ski to the vehicle. The ski is disposed in a center of the vehicle in a widthwise direction of the vehicle when the ski mount connects the ski to the vehicle. The ski comprises a ground-engaging lower side to slide on the snow and an upper side opposite to the ground-engaging lower side and facing towards the ski mount. The ground-engaging lower side of the ski comprises a ground-engaging lower surface and a plurality of keels projecting from the ground-engaging lower surface and spaced apart in a widthwise direction of the ski. Every keel of the ski is spaced from a midpoint of the ski in the widthwise direction of the ski.

In accordance with another aspect of the invention, there is provided a ski system for a vehicle on snow. The ski system comprises a ski to slide on the snow and a ski mount to connect the ski to the vehicle. The ski allows a leaning angle of at least 20°.

In accordance with another aspect of the invention, there is provided a ski system for a vehicle on snow. The ski system comprises a ski to slide on the snow and a ski mount to connect the ski to the vehicle. The ski is configured to apply more pressure on the ground inward of a midpoint of the ski in a widthwise direction of the ski when the vehicle is banked.

In accordance with another aspect of the invention, there is provided a ski system for a vehicle on snow. The ski system comprises a ski to slide on the snow and a ski mount to connect the ski to the vehicle. Lowest points of the ski are spaced from a steering axis of the ski.

In accordance with another aspect of the invention, there is provided a ski system for a vehicle on snow. The ski system comprises a ski to slide on the snow and a ski mount to connect the ski to the vehicle. The ski is pivotable relative to the ski mount about a pivot axis. The pivot axis is located to intersect a drag force of the snow on the ski.

In accordance with another aspect of the invention, there is provided a ski system for a vehicle on snow. The ski system comprises a ski to slide on the snow and a ski mount to connect the ski to the vehicle. The ski is pivotable relative to the ski mount about a pivot axis. The pivot axis is not located above a floatation surface of an upper side of the ski.

In accordance with another aspect of the invention, there is provided a ski system for a vehicle on snow. The ski system comprises a ski to slide on the snow and a ski mount to connect the ski to the vehicle. The ski is pivotable relative to the ski mount about a pivot axis. The pivot axis is located forward of a connection of the ski mount to a front steerable member of the vehicle in a longitudinal direction of the ski system.

In accordance with another aspect of the invention, there is provided a ski system for a vehicle on snow. The ski system comprises a ski to slide on the snow and a ski mount to connect the ski to the vehicle. The ski is pivotable relative to the ski mount about a pivot axis. The ski comprises a front rocker section and a rear flat section. The front rocker section extends over at least a majority of a distance between the pivot axis of the ski and a front end of the ski in a longitudinal direction of the ski.

In accordance with another aspect of the invention, there is provided a ski system for a vehicle on snow. The ski system comprises a ski to slide on the snow and a ski mount to connect the ski to the vehicle. The ski mount is resiliently deformable.

In accordance with another aspect of the invention, there is provided a ski system for a vehicle on snow. The ski system comprises a ski to slide on the snow and a ski mount to connect the ski to a front steerable member of the vehicle. The ski mount is less stiff than the front steerable member of the vehicle.

In accordance with another aspect of the invention, there is provided a ski system for a vehicle on snow. The ski system comprises a ski to slide on the snow, and a ski mount to connect the ski to a front steerable member of the vehicle. The ski mount is adjustably connectable to a front steerable member of the vehicle.

In accordance with another aspect of the invention, there is provided a track for a track system providing traction to a vehicle. The track system is disposed in a rear of the vehicle. The vehicle comprises a ski system disposed in a front of the vehicle and turnable to steer the vehicle. The ski system comprises a ski disposed in a center of the vehicle in a widthwise direction of the vehicle. The track system comprises a track-engaging assembly to drive the track and guide the track around the track-engaging assembly. The track is elastomeric to move around the track-engaging assembly. The track comprises an inner side for facing the track-engaging assembly and a ground outer side for engaging the ground. The ground-engaging outer side comprises a ground-engaging outer surface and a plurality of traction projections projecting from the ground-engaging outer surface and spaced apart in a longitudinal direction of the track. Each traction projection occupies at least a majority of at least one of the lateral halves of the track in a widthwise direction of the track.

In accordance with another aspect of the invention, there is provided a track for a track system providing traction to a vehicle. The track system is disposed in a rear of the vehicle. The vehicle comprises a ski system disposed in a front of the vehicle and turnable to steer the vehicle. The ski system comprises a ski disposed in a center of the vehicle in a widthwise direction of the vehicle. The track system comprises a track-engaging assembly to drive the track and guide the track around the track-engaging assembly. The track is elastomeric to move around the track-engaging assembly. The track comprises an inner side for facing the track-engaging assembly and a ground-engaging outer side for engaging the ground. The ground-engaging outer side comprises a ground-engaging outer surface and a plurality of traction projections projecting from the ground-engaging outer surface and spaced apart in a longitudinal direction of the track. Each traction projection is at least as high in a lateral edge portion of the track than outside of the lateral edge portion of the track. The lateral edge portion of the track extends from a lateral edge of the track in a widthwise direction of the track for no more than 20% of a width of the track.

In accordance with another aspect of the invention, there is provided a track for a track system providing traction to a vehicle. The track system is disposed in a rear of the vehicle. The vehicle comprises a ski system disposed in a front of the vehicle and turnable to steer the vehicle. The ski system comprises a ski disposed in a center of the vehicle in a widthwise direction of the vehicle. The track system comprises a track-engaging assembly to drive the track and guide the track around the track-engaging assembly. The track is elastomeric to move around the track-engaging assembly. The track comprises an inner side for facing the track-engaging assembly and a ground-engaging outer side for engaging the ground. The ground-engaging outer side comprises a ground-engaging outer surface and a plurality of traction projections projecting from the ground-engaging outer surface and spaced apart in a longitudinal direction of the track. Each traction projection remains substantially level in a widthwise direction of the track.

In accordance with another aspect of the invention, there is provided a track system for traction of a vehicle on snow. The track system is mountable in a rear of the vehicle. The vehicle comprises a ski system disposed in a front of the vehicle and turnable to steer the vehicle. The ski system comprises a ski disposed in a center of the vehicle in a widthwise direction of the vehicle. The track system comprises a track comprising a ground-engaging outer side for engaging the ground and an inner side opposite to the ground-engaging outer side. The track system also comprises a track-engaging assembly for driving and guiding the track around the track-engaging assembly. The track is elastomeric to move around the track-engaging assembly. The track-engaging assembly comprises a drive wheel for driving the track and an elongate support comprising a rail extending in a longitudinal direction of the track system along a bottom run of the track. The elongate support comprises a sliding surface for sliding on the inner side of the track along the bottom run of the track. The rail comprises polymeric material making up at least a majority of the rail.

In accordance with another aspect of the invention, there is provided a track system for traction of a vehicle on snow. The track system is mountable in a rear of the vehicle. The vehicle comprises a ski system disposed in a front of the vehicle and turnable to steer the vehicle. The ski system comprises a ski disposed in a center of the vehicle in a widthwise direction of the vehicle. The track system comprises a track comprising a ground-engaging outer side for engaging the ground and an inner side opposite to the ground-engaging outer side. The track system also comprises a track-engaging assembly for driving and guiding the track around the track-engaging assembly. The track is elastomeric to move around the track-engaging assembly. The track-engaging assembly comprises a drive wheel for driving the track and an elongate support comprising a rail extending in a longitudinal direction of the track system along a bottom run of the track. The elongate support comprises a sliding surface for sliding on the inner side of the track along the bottom run of the track. The rail overlaps a centerline of the track in a widthwise direction of the track system.

In accordance with another aspect of the invention, there is provided a track system for traction of a vehicle on snow. The track system comprises a track comprising a ground-engaging outer side for engaging the ground and an inner side opposite to the ground-engaging outer side. The track system also comprises a track-engaging assembly for driving and guiding the track around the track-engaging assembly. The track is elastomeric to move around the track-engaging assembly. The track-engaging assembly comprises a drive wheel for driving the track; an elongate support comprising a rail extending in a longitudinal direction of the track system along a bottom run of the track, the elongate support comprising a sliding surface for sliding on the inner side of the track along the bottom run of the track; and a plurality of roller wheels for rolling on the inner side of the track along the bottom run of the track, the roller wheels being mounted to the elongate support. In a cross-section of the track system in a widthwise direction of the track system, the sliding surface and a bottom of a given one of the roller wheels are offset in a heightwise direction of the track system.

In accordance with another aspect of the invention, there is provided a track system for traction of a vehicle on snow. The track system comprises a track comprising a ground-engaging outer side for engaging the ground and an inner side opposite to the ground-engaging outer side; and a track-engaging assembly for driving and guiding the track around the track-engaging assembly. The track is elastomeric to move around the track-engaging assembly. The track-engaging assembly comprises a drive wheel for driving the track; an elongate support comprising a rail extending in a longitudinal direction of the track system along a bottom run of the track, the elongate support comprising a sliding surface for sliding on the inner side of the track along the bottom run of the track; and a plurality of roller wheels for rolling on the inner side of the track along the bottom run of the track, the roller wheels being mounted to the elongate support. An orientation of a surface of the track-engaging assembly in contact with the bottom run of the track relative to the frame of the vehicle is changeable when the vehicle travels. In a cross-section of the track system in a widthwise direction of the track system, the sliding surface and a bottom of a given one of the roller wheels are offset in a heightwise direction of the track system. When the vehicle transitions from an upright position to a leaning position, the orientation of the surface of the track-engaging assembly in contact with the bottom run of the track relative to the frame of the vehicle changes and then the bottom run of the track deflects because of the sliding surface and the bottom of the given one of the roller wheels that are offset in the heightwise direction of the track system.

In accordance with another aspect of the invention, there is provided a system for traction of a vehicle. The system comprises a ski system mountable in a front of the vehicle and turnable to steer the vehicle, the ski system comprising a ski disposed in a center of the vehicle in a widthwise direction of the vehicle. The system also comprises a track system mountable in a rear of the vehicle to generate traction. The track system comprises a track and a track-engaging assembly to drive the track and guide the track around the track-engaging assembly. The track is elastomeric to move around the track-engaging assembly. The track comprises a ground-engaging outer side for engaging the ground and an inner side opposite to the ground-engaging outer side. A leaning capability of the ski system and a leaning capability of the track when the vehicle is banked are generally matched.

In accordance with another aspect of the invention, there is provided a track system for traction of a vehicle on snow. The track system is mountable in a rear of the vehicle. The vehicle comprises a ski system disposed in a front of the vehicle and turnable to steer the vehicle. The ski system comprises a ski disposed in a center of the vehicle in a widthwise direction of the vehicle. The track system comprises a track comprising a ground-engaging outer side for engaging the ground and an inner side opposite to the ground-engaging outer side. The track system also comprises a track-engaging assembly for driving and guiding the track around the track-engaging assembly. The track is elastomeric to move around the track-engaging assembly. The track-engaging assembly comprises a drive wheel for driving the track. The track system also comprises a transmission for transmitting power from a powertrain of the vehicle to the drive wheel. The transmission comprises an input transmission portion connectable to the powertrain of the vehicle. The input transmission portion comprises wheels and an elongate transmission link to transmit motion between the wheels of the input transmission portion. The transmission further comprises an output transmission portion connectable to the drive wheel. The output transmission portion comprises wheels and an elongate transmission link to transmit motion between the wheels of the output transmission portion. The track system also comprises a tensioner for simultaneously adjusting a tension of the elongate transmission link of the input transmission portion and a tension of the elongate transmission link of the output transmission portion.

In accordance with another aspect of the invention, there is provided a track system for traction of a vehicle on snow. The track system is mountable in a rear of the vehicle. The vehicle comprises a ski system disposed in a front of the vehicle and turnable to steer the vehicle. The ski system comprises a ski disposed in a center of the vehicle in a widthwise direction of the vehicle. The track system comprises a track comprising a ground-engaging outer side for engaging the ground and an inner side opposite to the ground-engaging outer side. The track system also comprises a track-engaging assembly for driving and guiding the track around the track-engaging assembly. The track is elastomeric to move around the track-engaging assembly. The track-engaging assembly comprises a drive wheel for driving the track. The track system also comprises a transmission for transmitting power from a powertrain of the vehicle to the drive wheel. The track system also comprises a subframe for interconnecting the track system to a frame of the vehicle. The subframe comprises a pair of elongated lateral members that are elongated in a longitudinal direction of the track system and disposed outside of lateral edges of the track such that the track is located between the elongated lateral members, a given one of the elongated lateral members defining a recess to receive at least part of the transmission.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided below, by way of example only, with reference to the accompanying drawings, in which:

FIG. 1 shows an example of a snow vehicle comprising a ski system and a track system in accordance with an embodiment of the invention;

FIG. 2 shows the snow vehicle converted from a motorcycle comprising a front wheel and a rear wheel in place of the ski system and the track system;

FIG. 3 is a cross-sectional view of the rear wheel of the motorcycle;

FIG. 4 is a perspective view of the ski system when it is secured to a front steerable member of the snow vehicle;

FIGS. 5 to 7 are side, top and front views of the ski system;

FIG. 8 is a cross-sectional view of the ski system taken along line 8-8 of FIG. 7;

FIG. 9 is a cross-sectional view of the ski system along a longitudinal direction of the ski system;

FIG. 10 is a partial front view of the ski system showing lateral and central keels of a ski;

FIGS. 11 to 13 are perspective, side and bottom views of the ski;

FIG. 14 shows an example of a leaning angle of the ski;

FIG. 15 shows a tire of the front wheel of the motorcycle when it is banked;

FIG. 16 shows the ski system when the snow vehicle is banked;

FIG. 17 shows a cross-sectional area of a body of snow between a given central keel and an adjacent lateral keel when the snow vehicle is banked;

FIG. 18 shows a cross-sectional area of a body of snow between the central keels when the snow vehicle is upright;

FIG. 19 shows a drag force exerted by the snow on the ski;

FIG. 20 is a perspective view of a ground-engaging lower side of the ski;

FIG. 21 shows a perspective view of a cross-section of a pivot of the ski;

FIG. 22 shows a position of a pivot of the ski in relation to a connection between a ski mount and the front steerable member of the snow vehicle;

FIG. 23 is a perspective view of the ski mount of the ski system;

FIG. 24 is an exploded view of part of the ski mount of the ski system;

FIG. 25 is a side view of part of the ski mount of the ski system;

FIG. 26 is a cross-sectional view of the ski mount as indicated in FIG. 25;

FIGS. 27 to 30 are perspective, side, top and front views of the ski system in accordance with a variant of the ski system;

FIG. 31 is a cross-sectional view of the ski system as indicated in FIG. 30;

FIG. 32 is another cross-sectional view of the ski system as indicated in FIG. 30;

FIG. 33 is a detailed view of a limiter of the ski and an engaging member of the ski mount shown in FIG. 31;

FIGS. 34 and 35 are perspective and side views of the track system;

FIGS. 36 and 37 are perspective and side views of a track-engaging assembly of the track system;

FIG. 38 is a perspective view of a cross-section of the track system taken along line 38-38 of FIG. 35;

FIG. 39 is a cross-sectional view of a rail of an elongate support of a frame of the track-engaging assembly;

FIG. 40 is a perspective view of a slider of the elongated support;

FIG. 41 is a cross-sectional view of the slider as indicated in FIG. 40;

FIGS. 42 to 45 are perspective, side, top and front views of the track-engaging assembly in accordance with another embodiment of the invention;

FIG. 46 is a partial cross-sectional view of the track-engaging assembly of FIG. 42 as it engages a track;

FIG. 47 is a side view of a roller wheel of the track-engaging assembly of FIG. 42 showing a vertical offset of a bottom of the roller wheel relative to a sliding surface of the elongate support;

FIG. 48 is an exploded view of part of the elongate support of the track-engaging assembly of FIG. 42;

FIGS. 49 and 50 are side and top views of part of the elongate support of the track-engaging assembly of FIG. 42;

FIG. 51 shows a bottom run of the track being movable relative to a frame of the snow vehicle in a heightwise direction of the snow vehicle;

FIGS. 52 and 53 respectively show the rail of the elongate support of the track-engaging assembly in a neutral and a biased configuration;

FIG. 54 is a flowchart illustrating an example of a blow-molding process used to mold the frame of the track-engaging assembly;

FIG. 55 shows a cross-sectional view of a slider in accordance with another embodiment of the track system;

FIGS. 56 and 57 respectively show the slider of FIG. 55 in a neutral and a biased configuration;

FIGS. 58 and 59 respectively show the rail and the slider in accordance with another variant of the track system in which the track-engaging assembly comprises a movable mechanical joint between an upper part and a lower part of the track-engaging assembly;

FIGS. 60 and 61 respectively show an upper portion of the rail of the track system of FIGS. 58 and 59 in a neutral position and in an inclined position;

FIG. 62 shows an embodiment in which the movable mechanical joint comprises a resilient device;

FIG. 63 is a perspective view of a portion of a track of the track system;

FIG. 64 is top plan view of the track showing a ground-engaging outer side of the track;

FIG. 65 is a partial side elevational view of the track;

FIG. 66 is a partial front elevational view of the track in accordance with an embodiment in which succeeding traction projections of the track overlap one another in a widthwise direction of the track;

FIG. 67 is a partial front elevational view of the track in accordance with another embodiment of the track in which the traction projections of the track occupy at least a majority of a width of the track in its widthwise direction;

FIG. 68 is a partial cross-sectional view of the track of FIGS. 63 to 66;

FIG. 69 shows the track of FIGS. 63 to 66 as the snow vehicle engages a side hill;

FIG. 70 is a side view of the track system showing a mounting arrangement of the track system;

FIG. 71 is a side view of the track system showing a transmission of the mounting arrangement;

FIG. 72 is a perspective view of the transmission and a tensioner of the mounting arrangement;

FIG. 73 is an enlarged perspective view of part of the transmission and tensioner of the mounting arrangement;

FIG. 74 is a cross-sectional view of an elongated lateral member of a subframe of the mounting arrangement;

FIG. 75 is an enlarged perspective view of part of the mounting arrangement of the track system, showing a pivot of the subframe; and

FIG. 76 is a side view of the snow vehicle showing a swing arm of the motorcycle when equipped with the front and rear wheels.

It is to be expressly understood that the description and drawings are only for the purpose of illustrating certain embodiments of the invention and are an aid for understanding. They are not intended to be a definition of the limits of the invention.

### DETAILED DESCRIPTION OF EMBODIMENTS

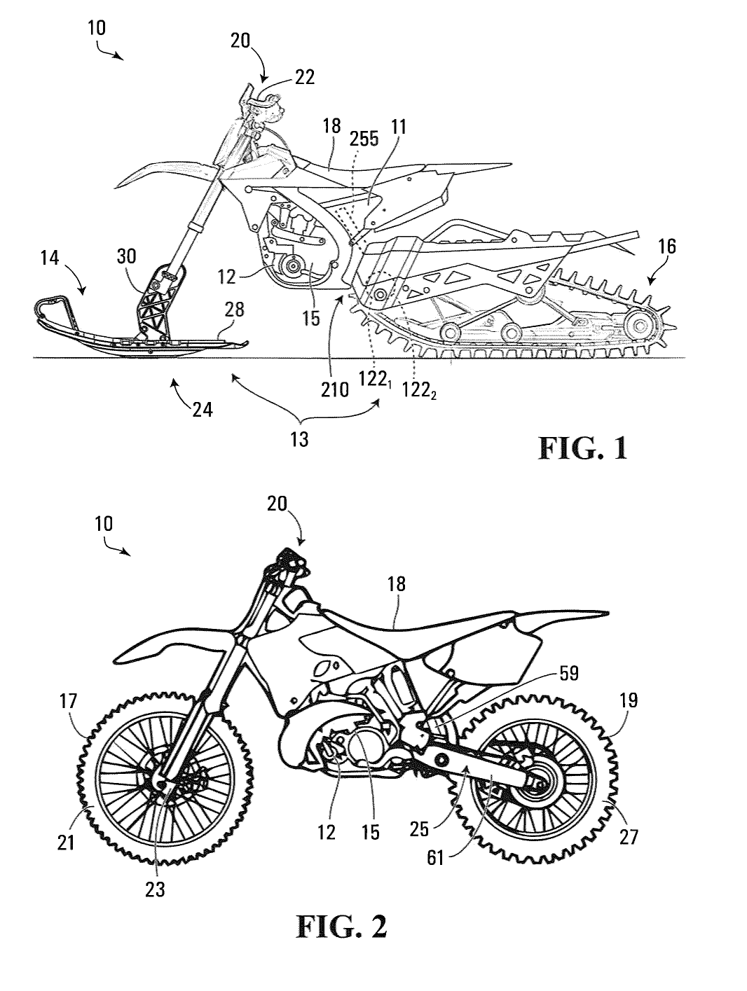

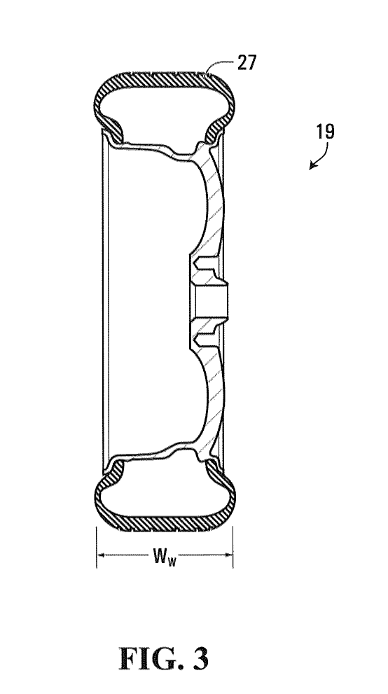

FIG. 1 shows an example of a snow vehicle 10 for travelling on snow in accordance with an embodiment of the invention. The snow vehicle 10 comprises a frame 11, a powertrain 12, a ski system 14, a track system 16, a seat 18, and a user interface 20, which enables a user to ride, steer and otherwise control the snow vehicle 10. The snow vehicle 10 has a length, a width, and a height that respectively define a longitudinal direction, a widthwise direction, and a heightwise direction of the snow vehicle 10.

In this embodiment, the snow vehicle 10 is a snow bike. More particularly, in this embodiment, with additional reference to FIG. 2, the snow bike 10 is a motorcycle equipped with the ski system 14 mounted in place of a front wheel 17 of the motorcycle and the track system 16 mounted in place of a rear wheel 19 of the motorcycle. In this example, the track system 16 also replaces a rear suspension unit 25 (e.g., a shock absorber 59 and a swing arm 61) of the motorcycle. Basically, in this embodiment, the ski system 14 and the track system 16 are part of a conversion system 13 that converts the motorcycle into a skied and tracked vehicle for travelling on snow.

As further discussed below, in this embodiment, the ski system 14 and the track system 16 are designed to enhance travel of the snow bike 10 on the ground, including to facilitate banking of the snow bike 10 (e.g., to turn, on a side hill, etc.), steering of the snow bike 10 by turning the ski system 14, and/or moving on harder snow (e.g., packed snow).

The powertrain 12 is configured for generating motive power and transmitting motive power to the track system 16 to propel the snow bike 10 on the ground. To that end, the powertrain 12 comprises a prime mover 15, which is a source of motive power that comprises one or more motors (e.g., an internal combustion engine, an electric motor, etc.). For example, in this embodiment, the prime mover 15 comprises an internal combustion engine. In other embodiments, the prime mover 15 may comprise another type of motor (e.g., an electric motor) or a combination of different types of motor (e.g., an internal combustion engine and an electric motor). The prime mover 15 is in a driving relationship with the track system 16. That is, the powertrain 12 transmits motive power from the prime mover 15 to the track system 16 in order to drive (i.e., impart motion to) the track system 16.

The seat 18 accommodates the user of the snow bike 10. In this case, the seat 18 is a straddle seat and the snow bike 10 is usable by a single person such that the seat 18 accommodates only that person driving the snow bike 10. In other cases, the seat 18 may be another type of seat, and/or the snow bike 10 may be usable by two individuals, namely one person driving the snow bike 10 and a passenger, such that the seat 18 may accommodate both of these individuals (e.g., behind one another).

The user interface 20 allows the user to interact with the snow bike 10 to control the snow bike 10. More particularly, in this embodiment, the user interface 20 comprises an accelerator, a brake control, and a steering device comprising handlebars 22 that are operated by the user to control motion of the snow bike 10 on the ground. The user interface 20 also comprises an instrument panel (e.g., a dashboard) which provides indicators (e.g., a speedometer indicator, a tachometer indicator, etc.) to convey information to the user.

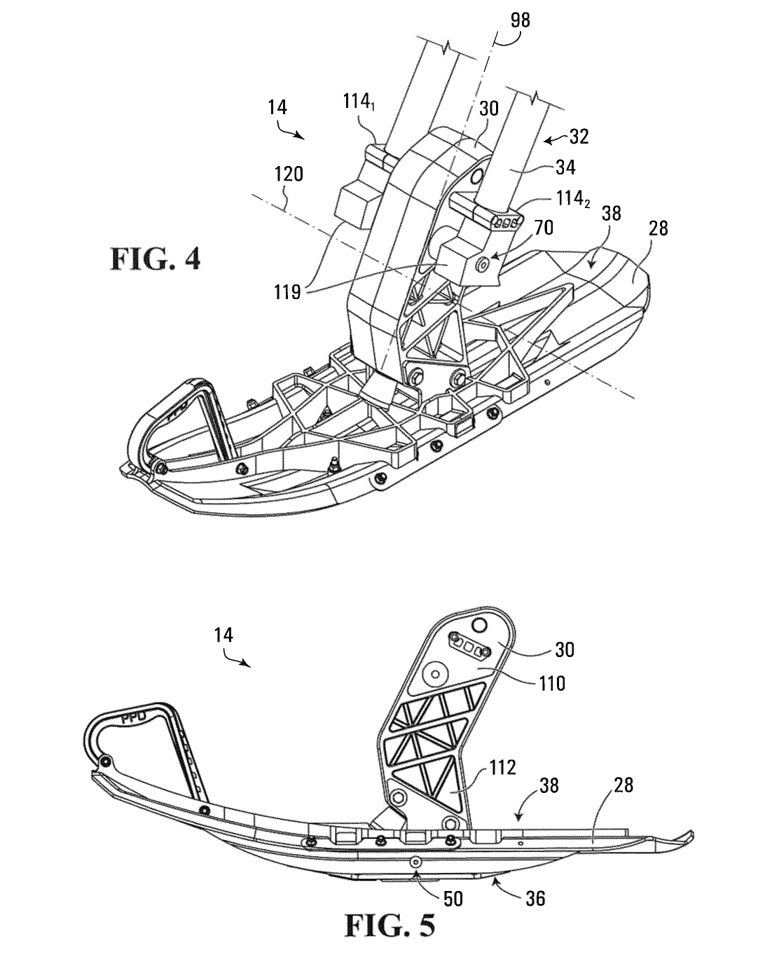

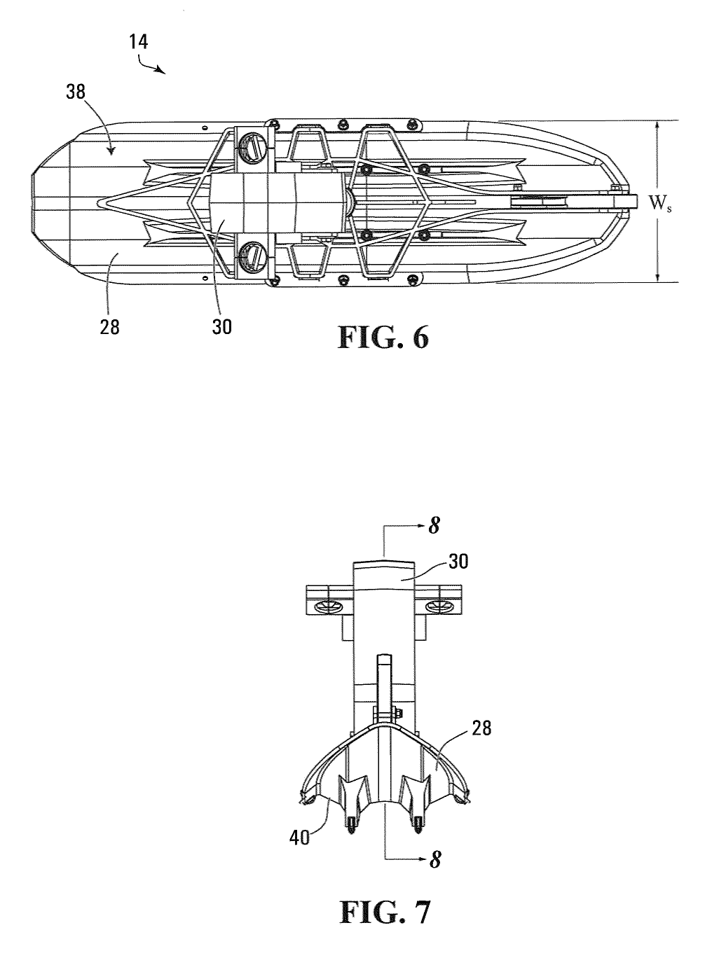

The ski system 14 is disposed in a front 24 of the snow bike 10 to engage the ground and is turnable to steer the snow bike 10. To that end, the ski system 14 is turnable about a steering axis 26 of the snow bike 10. As shown in FIGS. 4 to 9, the ski system 14 comprises a ski 28 to slide on the snow and a ski mount 30 that connects the ski 28 to a front steerable member 32 of the snow bike 10. In this embodiment where the snow bike 10 is a motorcycle and the ski system 14 replaces the front wheel 17 of the motorcycle, the front steerable member 32 comprises a front fork 34 of the snow bike 10 that would otherwise carry the front wheel 17.

The ski 28 is a sole ski of the snow bike 10. That is, the snow bike 10 has no other ski. Notably, the ski 28 is disposed in a center of the snow bike 10 in a widthwise direction of the snow bike 10. In this embodiment in which the snow bike 10 is a motorcycle and the ski system 14 replaces the front wheel 17 of the motorcycle, the ski 28 contacts the ground where the front wheel 17 would contact the ground.

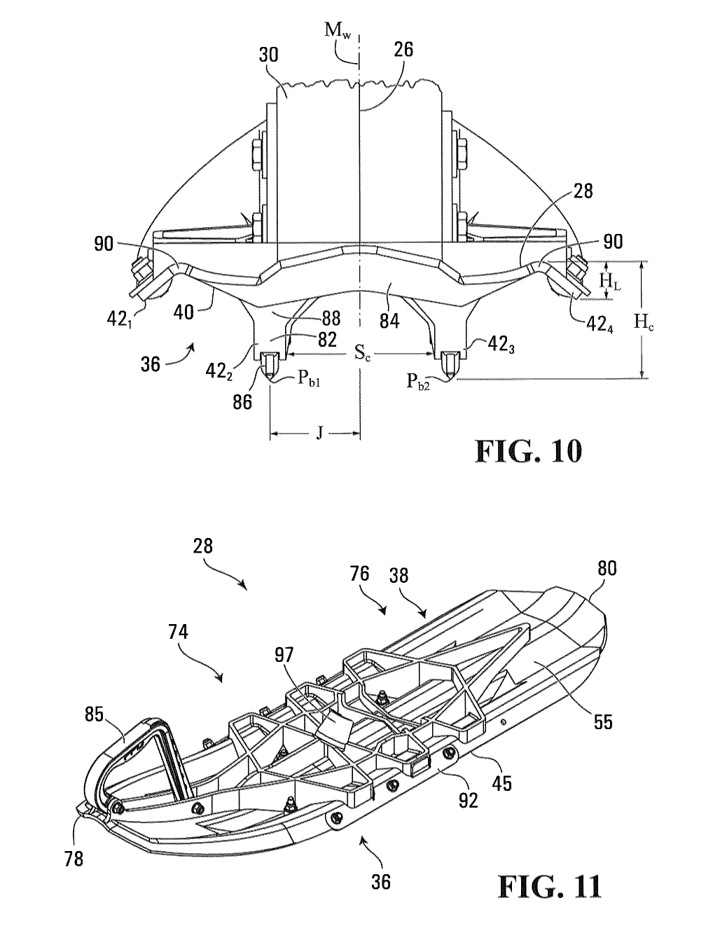

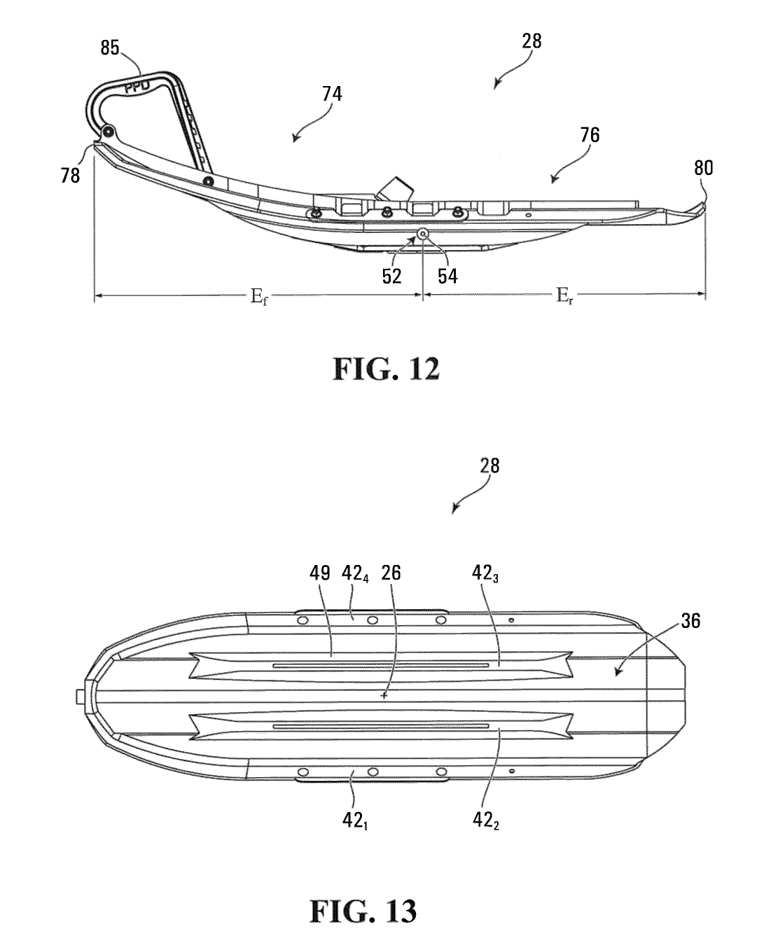

As shown in FIG. 10, the ski 28 comprises a ground-engaging lower side 36 to slide on the snow and an upper side 38 opposite to the ground-engaging lower side 36 and facing towards the ski mount 30. The ski 28 has a longitudinal axis which defines a longitudinal direction of the ski 28 (i.e., a direction generally parallel to its longitudinal axis), transversal directions of the ski 28 (i.e., directions transverse to its longitudinal axis), including a widthwise direction of the ski 28 (i.e., a lateral direction generally perpendicular to its longitudinal axis), and a heightwise direction normal to its longitudinal and widthwise directions.

The ground-engaging lower side 36 of the ski 28 comprises a ground-engaging lower surface 40. In this embodiment, the ground-engaging lower side 36 also comprises a plurality of projections 42₁-42₄, which are referred to as “keels”, projecting from the ground-engaging lower surface 40 and spaced apart in the widthwise direction of the ski 28.

More particularly, in this embodiment, there are four keels 42₁-42₄. The keels 42₂, 42₃ are central keels that are disposed between the keels 42₁, 42₄, which are lateral keels, in the widthwise direction of the ski 28.

As shown in FIG. 10, in this example, each of the central keels 42₂, 42₃ projects lower than the lateral keels 42₁, 42₄ in the heightwise direction of the ski 28. To that end, in this example, each of the central keels 42₂, 42₃ is taller than the lateral keels 42₁, 42₄. For example, in some embodiments, a ratio of a height H_{C} of each of the central keels 42₂, 42₃ over a height H_{L} of each of the lateral keels 42₁, 42₄ may be at least 2, in some cases at least 3, in some cases at least 4, and in some cases even more. Also, in this example, the lateral keels 42₁, 42₄ are shorter than the central keels 42₂, 42₃ in the longitudinal direction of the ski system 14.

In this embodiment, every keel of the ski 28, including each of the central keels 42₂, 42₃, is spaced from a midpoint M_{w} of the ski 28 in the widthwise direction of the ski 28. A spacing S_{c} of the central keels 42₂, 42₃ in the widthwise direction of the ski 28 may be relatively large. For instance, in some embodiments, a ratio of the spacing S_{c} of the central keels 42₂, 42₃ in the widthwise direction of the ski 28 over a width Wₛ of the ski 28 may be at least 0.2, in some cases at least 0.3, in some cases at least 0.4, and in some cases even more (e.g., 0.5, 0.6, etc.).

The ground-engaging lower side 36 of the ski 28 is configured to facilitate movement of the ski 28 on the ground, including when the snow bike 10 is banked (e.g., to turn, on a side hill, etc.), steered by turning the ski 28, and/or travels on harder snow (e.g., packed snow). For instance, in this embodiment, the ground-engaging lower side 36 of the ski 28 may facilitate a transition from an upright position of the snow bike 10 to a leaning position of the snow bike 10 when the snow bike 10 is banked. In this embodiment where the ski system 14 replaces the front wheel 17 of the motorcycle, this may allow the ski 28 to better emulate dynamics of the front wheel 17.

For example, in this embodiment, a bottom area of the ground-engaging lower side 36 of the ski 28 may be relatively wide. That is, a dimension W_{b} of the bottom area of the ground-engaging lower side 36 of the ski 28 in the widthwise direction of the ski 28 may be relatively large. The dimension W_{b} of the bottom area of the ground-engaging lower side 36 of the ski 28 is a distance in the widthwise direction of the ski 28 between lowest points P_{b1}, P_{b2} of the ground-engaging lower side 36 of the ski 28 when horizontal. In this embodiment, the lowest points P_{b1}, P_{b2} of the ground-engaging lower side 36 of the ski 28 are respectively part of the central keels 42₂, 42₃. For instance, in some embodiments, a ratio of the dimension W_{b} of the bottom area of the ground-engaging lower side 36 of the ski 28 in the widthwise direction of the ski 28 over the width Wₛ of the ski 28 may be at least 0.2, in some cases at least 0.3, in some cases at least 0.4, in some cases at least 0.5, and in some cases even more (e.g., 0.6).

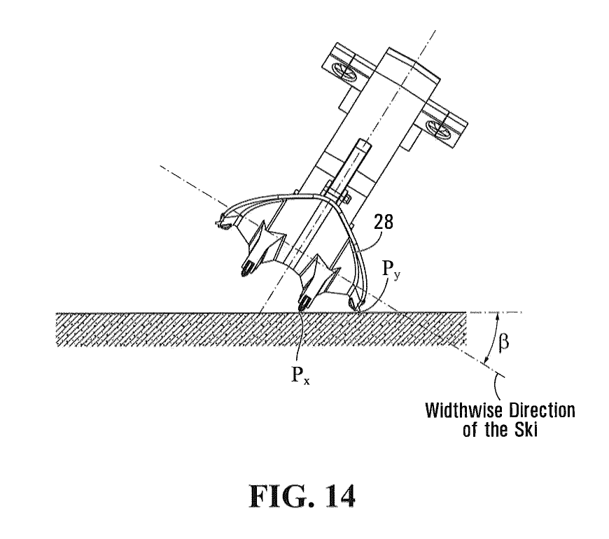

Also, in this embodiment, the ground-engaging lower side 36 of the ski 28 allows a leaning angle β that may be relatively large. As shown in FIG. 14, the leaning angle β is defined between the widthwise direction of the ski 28 and a horizontal ground surface when the snow bike 10 is banked. For instance, in this embodiment, the leaning angle β is defined between the widthwise direction of the ski 28 and a tangent to two points Pₓ, P_{y} of the ground-engaging lower side 36 of the ski 28 that contact the snow when the snow bike 10 is banked. In this embodiment, the points Pₓ, P_{y} of the ground-engaging lower side 36 are part of a given one of the central keels 42₂, 42₃ and a given one of the lateral keels 42₁, 42₄ that is closest to the given one of the central keels 42₂, 42₃. For example, in some embodiments, the leaning angle β may be at least 10°, in some cases at least 20°, in some cases at least 25°, in some cases at least 30°, and in some cases even more (e.g., 40°).

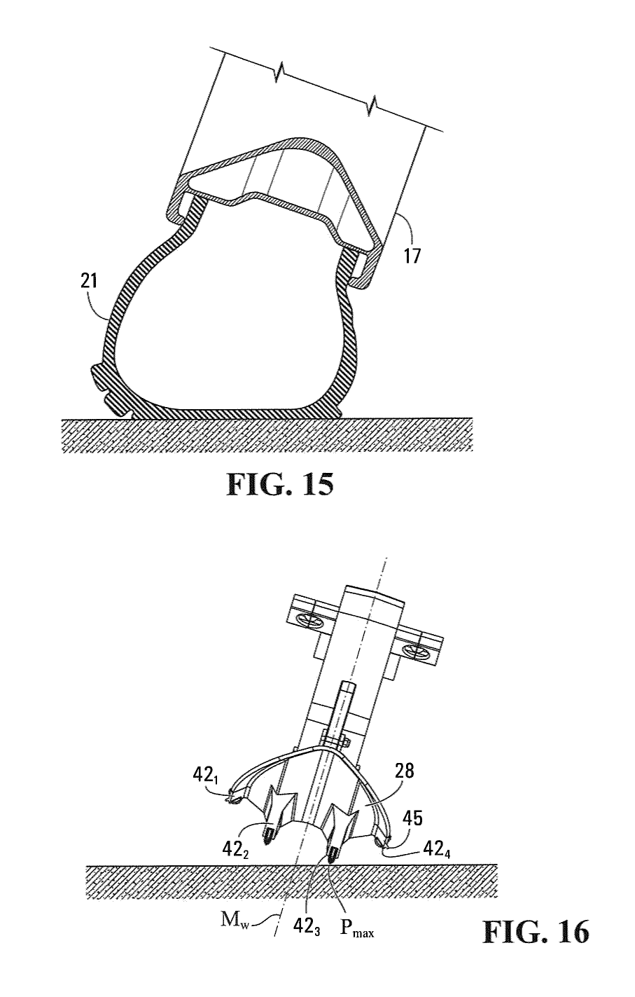

Furthermore, in this embodiment, the ground-engaging lower side 36 of the ski 28 is configured such that, when the snow bike 10 is banked, the ski 28 applies more pressure on the ground inward of the midpoint M_{w} of the ski 28 in the widthwise direction of the ski 28. The ski 28 thus applies more pressure on the ground inside of a turning radius of the snow bike 10. In this embodiment where the ski system 14 replaces the front wheel 17 of the vehicle 10, as shown in FIG. 15, this may better emulate dynamics of a tire 21 of the front wheel 17 when the vehicle 10 is banked. For example, as shown in FIG. 16, the ground-engaging lower side 36 of the ski 28 is configured such that, when the snow bike 10 is banked, a point of maximal pressure Pₘₐₓ of the ski 28 on the ground is located inward of the midpoint M_{w} of the ski 28 in the widthwise direction of the ski 28. Notably, the point of maximal pressure Pₘₐₓ of the ski 28 on the ground is located between a lateral edge 45 of the ski 28 and the midpoint M_{w} of the ski 28 in the widthwise direction of the ski 28. In this example, Pₘₐₓ is part of the central keel 42₃. Eventually, if the snow bike 10 is banked sufficiently, the lateral keel 42₄ also applies pressure on the ground.

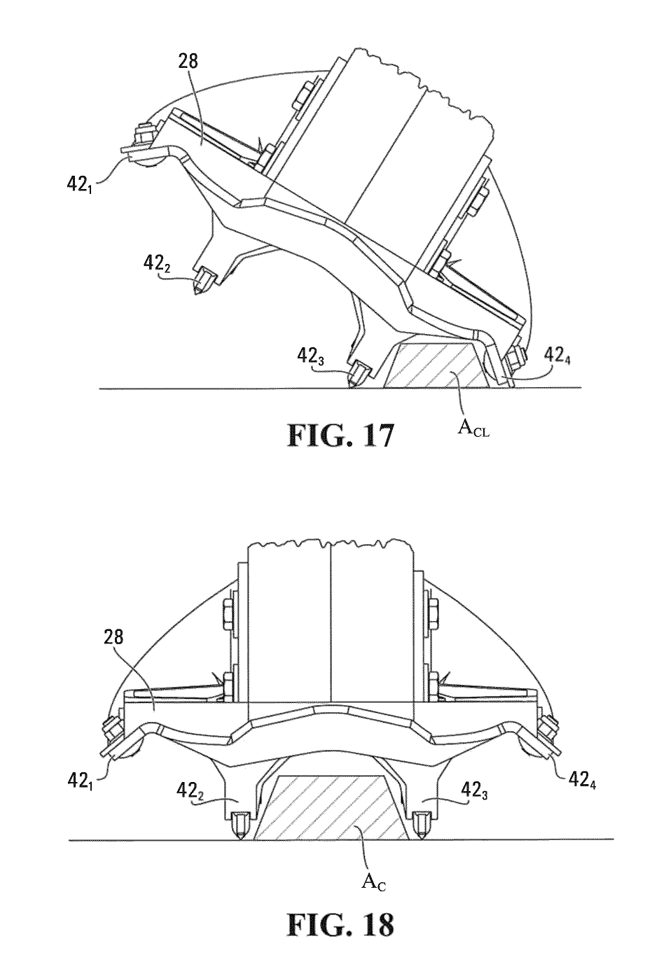

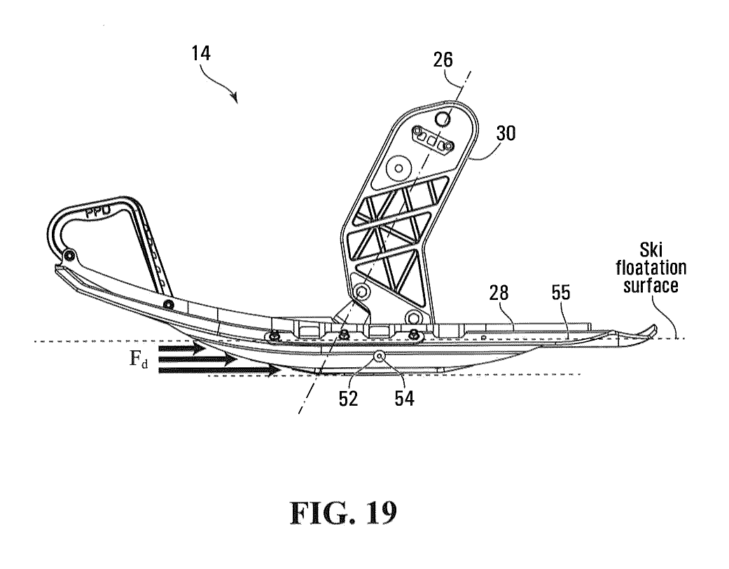

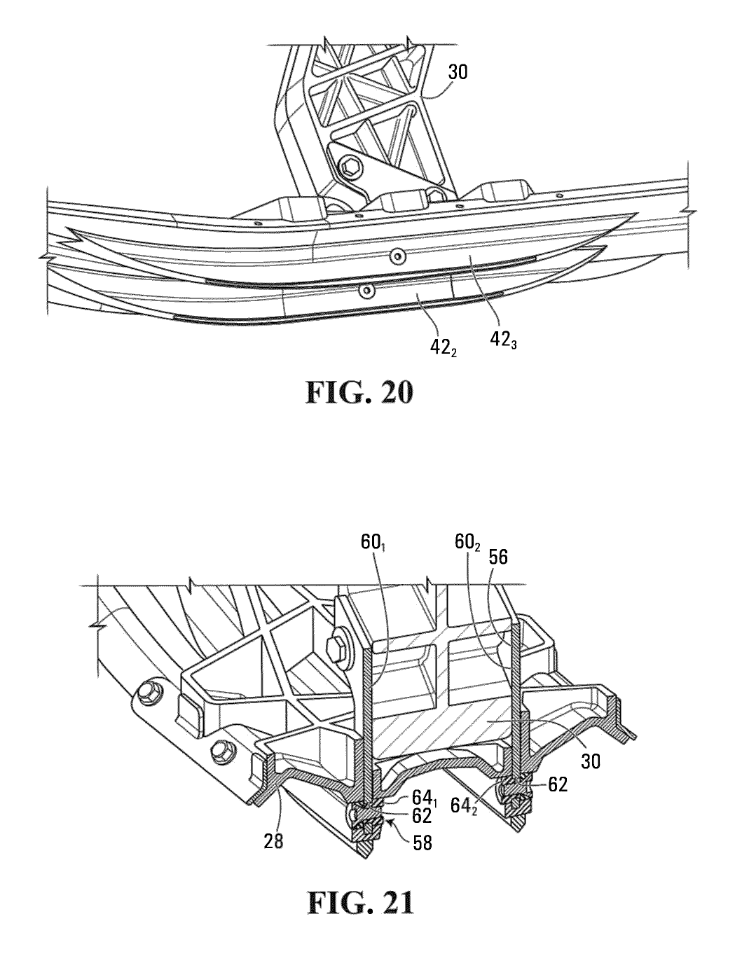

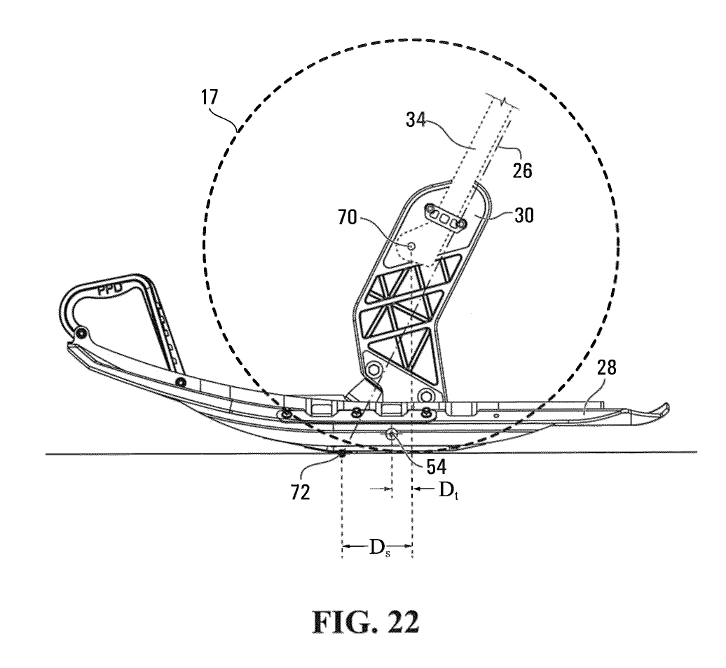

The keels 42₁-42₄ may have any suitable shape. In this embodiment, the keels 42₁-42₄ are shaped such that a body of snow A_{cl} between the central and lateral keels 42₃, 42₄ (or 42₂, 42₁) when the snow bike 10 is banked such that the central and lateral keels 42₃, 42₄ (or 42₂, 42₁) apply pressure on the ground, as shown in FIG. 17, is similar to a body of snow A_{c} between the central keels 42₂, 42₃ when the snow bike 10 is upright, as shown in FIG. 18. For example, in this embodiment, the body of snow A_{cl} between the central and lateral keels 42₃, 42₄ (or 42₂, 42₁) when the snow bike 10 is banked tapers upwardly and the body of snow A_{c} between central keels 42₂, 42₃ when the snow bike 10 is upright tapers upwardly. As another example, a ratio between a cross-sectional area of the body of snow A_{cl} between the central and lateral keels 42₃, 42₄ (or 42₂, 42₁) when the snow bike 10 is banked and a cross-sectional area of the body of snow A_{c} between central keels 42₂, 42₃ when the snow bike 10 is upright may be between 0.7 and 1.3, in some cases between 0.8 and 1.2, in some cases between 0.9 and 1.1.

In this embodiment, the ground-engaging lower side 36 of the ski 28 may also facilitate steering of the snow bike 10 when the ski 28 is turned. More particularly, in this embodiment, as shown in FIG. 9, the lowest points P_{M}, P_{b2} of the ground-engaging lower side 36 of the ski 28 are spaced from the steering axis 26. That is, the steering axis 26 does not intersect the lowest points P_{b1}, P_{b2} of the ground-engaging lower side 36 of the ski 28. Notably, in this embodiment, the central keels 42₂, 42₃, which include the lowest points P_{b1}, P_{b2} of the ground-engaging lower side 36 of the ski 28, are spaced from the steering axis 26. This may reduce a steering effort by reducing friction between the ski 28 and the ground as segments 49 of the central keels 42₂, 42₃, which include the lowest points P_{b1}, P_{b2} of the ground-engaging lower side 36 of the ski 28 that apply more pressure onto the ground, move generally tangentially to a rotational motion of the ski 28 about the steering axis 26.

For example, in some embodiments, a ratio of (i) a lateral distance J between each of the lowest points P_{b1}, P_{b2} of the ground-engaging lower side 36 of the ski 28, which are part of the central keels 42₂, 42₃, and the steering axis 26 in the widthwise direction of the ski 28 over (ii) the width Wₛ of the ski 28 may be at least 0.2, in some cases at least 0.3, in some cases at least 0.4, in some cases at least 0.5, and in some cases even more (e.g., 0.6).

The ski 28 may be configured in any other suitable way in other embodiments. For example, in other embodiments, the ground-engaging lower side 36 of the ski 28 may comprise any number of keels like the keels 42₁-42₄ projecting from the ground-engaging lower surface 40. For instance, in some embodiments, the ground-engaging lower side 36 of the ski 28 may comprise a single keel. In other embodiments, the ground-engaging lower side 36 of the ski 28 may comprise two, three or more than four keels.

In this embodiment, the ski 28 is movable relative to the ski mount 30 about a joint 50 to allow the ski 28 to move up and down to accommodate terrain that is uneven in a direction of motion of the snow bike 10. In this embodiment, the joint 50 comprises a pivot 52 such that the ski 28 is pivotable relative to the ski mount 30 about a pivot axis 54 of the pivot 52.

The pivot 52 about which the ski 28 is pivotable relative to the ski mount 30 may be configured to allow the ski 28 to be aggressive on the snow (e.g., by having the central keels 42₂, 42₃ relatively tall) while avoiding certain undesirable effects, such as instability of the ski 28 and/or unwanted feedback at the handlebars 22. Notably, in this embodiment, the pivot axis 54 of the pivot 52 is located such that a drag force F_{D} of the snow on the ski 28 substantially does not create a moment on the ski 28 about the pivot axis 54 that would otherwise tend to tip a front of the ski 28 downwards. To that end, in this embodiment, the pivot axis 54 of the pivot 52 is located to be intersected by the drag force F_{D} of the snow on the ski 28.

More particularly, in this embodiment, the pivot axis 54 of the pivot 52 is not located above (i.e., is located at or below) a floatation surface 55 of the upper side 38 of the ski 28. The floatation surface 55 of the upper side 38 of the ski 28 is that surface below which the snow extends when the ground is horizontal. In this example, the pivot axis 54 of the pivot 52 is not located above the floatation surface 55, and more specifically, is located below the floatation surface 55 of the upper side 38 of the ski 28. More specifically, in this example, the pivot axis 54 of the pivot 52 intersects the central keels 42₂, 42₃.

In this example of implementation, as shown in FIG. 21, the pivot 52 comprises a portion 56 of the ski mount 30 that is configured to extend into the ski 28 past the floatation surface 55 of the ski 28 and a pivot axle structure 58 defining the pivot axis 54 of the pivot 52. In particular, the portion 56 of the ski mount 30 that extends into the ski 28 past the floatation surface 55 of the ski 28 comprises a pair of extensions 60₁, 60₂ of the ski mount 30 that together form a fork-like extension of the ski mount 30. Each extension 60ᵢ of the ski mount 30 comprises an opening 62 for receiving the pivot axle structure 58 of the pivot 52. In this example, the pivot axle structure 58 comprises a plurality of pivot elements 64₁, 64₂ that are configured to be received in each opening 62 of the extensions 60₁, 60₂ of the ski mount 30 and in respective openings of the central keels 42₂, 42₃. The pivot elements 64₁, 64₂ may comprise any suitable type of mechanical structure that can define a pivot axis. For instance, in this example, each pivot element 64ᵢ comprises a bushing about which the extensions 60₁, 60₂ of the ski mount 30 are pivotable. The pivot elements 64₁, 64₂ may comprise any other suitable type of mechanical element in other embodiments. Moreover, in this embodiment, each pivot element 64ᵢ is retained in its position by a fastener 66 that engages the pivot element 64ᵢ. In this example, the fastener 66 comprises a screw that threadedly engages an inner portion of the pivot element 64ᵢ to secure the pivot element 64ᵢ in the opening 62. A washer (e.g., a conical washer) may also be provided for load bearing purposes. In other embodiments, the pivot element 64ᵢ may be press-fitted into the opening 62 in order to retain the pivot element 64ᵢ in the opening 62.

In this embodiment, the portion 56 of the ski mount 30 that extends into the ski 28 comprises a pair of brackets that are fastened to the ski mount 30 (e.g., via a bolted connection). Each one of the pair of brackets constitutes one of the extensions 60₁, 60₂ of the ski mount 30. In other embodiments, the portion 56 of the ski mount 30 may be integrally made with a remainder of the ski mount 30 such as to constitute a one-piece construction together with the remainder of the ski mount 30.

The pivot 52 about which the ski 28 is pivotable relative to the ski mount 30 may also be configured to create a “trail” of the ski 28 forward of a connection 70 of the ski mount 30 to the front fork 34 of the snow bike 10. In this embodiment where the ski system 14 replaces the front wheel 17 of the vehicle 10, this may better emulate dynamics of the front wheel 17. The connection 70 of the ski mount 30 to the front fork 34 may be located at a location of an axle 23 of the front wheel 17 when mounted to the front fork 34.

More particularly, in this embodiment, the pivot axis 54 of the pivot 52 is located forward of the connection 70 of the ski mount 30 in the longitudinal direction of the ski system 14. A distance Dₜ between the pivot axis 54 of the pivot 52 and the connection 70 of the ski mount 30 in the longitudinal direction of the ski system 14 may have any suitable value. For example, in some embodiments, a ratio of (i) the distance Dₜ between the pivot axis 54 of the pivot 52 and the connection 70 of the ski mount 30 in the longitudinal direction of the ski system 14 over (ii) a distance Dₛ between the connection 70 of the ski mount 30 and an intersection 72 of the steering axis 26 with the ground in the longitudinal direction of the ski system 14 may be at least 0.1, in some cases 0.2, in some cases at least 0.5, in some cases at least 0.8, in some cases at least 1 or in some cases even more.

The ski 28 may be designed to enhance floatation. In this embodiment, the ski 28 comprises a front rocker section 74 to provide an efficient approach angle and snow compaction and a rear flat section 76 to maintain pressure of the ski 28 in front.

The front rocker section 74 of the ski 28 is a section of the ski 28 that is curved upwardly towards a front end 78 of the ski 28. In this embodiment, the front rocker section 74 extends over a significant part of the ski 28 in the longitudinal direction of the ski 28. More particularly, in this embodiment, the front rocker section 74 extends over at least a majority of a distance E_{f} between the pivot axis 54 of the ski 28 and the front end 78 of the ski 28 in the longitudinal direction of the ski 28. For example, in some embodiments, the front rocker section 74 may extend over at least three-quarters, in some cases four-fifths, in some cases nine-tenths, and in some cases an entirety of the distance E_{f} between the pivot axis 54 of the ski 28 and the front end 78 of the ski 28 in the longitudinal direction of the ski 28. In this embodiment, the front rocker section 74 extends over the entirety of the distance E_{f} between the pivot axis 54 of the ski 28 and the front end 78 of the ski 28 in the longitudinal direction of the ski 28, i.e., the ski 28 is curved upwardly from the pivot axis 54 of the ski 28 to the front end 78 of the ski 28.

The rear flat section 76 of the ski 28 is a section of the ski 28 that is substantially flat towards a rear end 80 of the ski 28. In this embodiment, the rear flat section 76 extends over a significant part of the ski 28 in the longitudinal direction of the ski 28. More particularly, in this embodiment, the rear flat section 76 extends over at least a majority of a distance Eᵣ between the pivot axis 54 of the ski 28 and the rear end 80 of the ski 28 in the longitudinal direction of the ski 28. For example, in some embodiments, the rear flat section 76 may extend over at least three-quarters, in some cases four-fifths, in some cases nine-tenths, and in some cases an entirety of the distance Eᵣ between the pivot axis 54 of the ski 28 and the rear end 80 of the ski 28 in the longitudinal direction of the ski 28. In this embodiment, the rear flat section 76 extends over the entirety of the distance Eᵣ between the pivot axis 54 of the ski 28 and the rear end 80 of the ski 28 in the longitudinal direction of the ski 28, i.e., the ski 28 is flat from the pivot axis 54 of the ski 28 to the rear end 80 of the ski 28.

The ski 28 may be constructed in any suitable way. In this embodiment, the ski 28 comprises polymeric material. More particularly, in this example, the polymeric material of the ski 28 comprises ultra-high-molecular-weight polyethylene (UHMWPE). In other examples, the polymeric material of the ski 28 may include any other suitable polymer (e.g., polypropylene, ethylene-vinyl acetate (EVA), nylon, polyester, vinyl, polyvinyl chloride, polycarbonate, polyethylene, or any other thermoplastic or thermosetting polymer). The ski 28 may be molded into shape in a molding process during which the polymeric material of the ski 28 is molded in a mold and cured.

The keels 42₁-42₄ of the ski 28 may be configured in various ways. In this embodiment, each one of the central keels 42₂, 42₃ comprises a projecting portion 82 that is integrally molded with a body 84 of the ski 28, and a tip portion 86 that is harder than the projecting portion 82. In this example, a dimension of each one of the central keels 42₂, 42₃ in the widthwise direction of the ski 28 decreases from a base 88 of the projecting portion 82 which is adjacent the body 84 of the ski 28 to the tip portion 86 which is furthest from the body 84 of the ski 28. As such, in this example, each one of the central keels 42₂, 42₃ has a cross-section normal to the longitudinal direction of the ski 28 that tapers downwardly (e.g., generally shaped like a triangle).

In this embodiment, the tip portion 86 of the central keels 42₂, 42₃ comprises an insert that is secured to the projecting portion 82 of the central keels 42₂, 42₃. The tip portion 86 may be secured to the projecting portion 82 of the central keel in any suitable way. For instance, the tip portion 86 may be permanently secured to the projecting portion 82 such that the tip portion 86 is not meant to be removed from engagement therewith. In other embodiments, the tip portion 86 may be replaceable such that it can be selectively disengaged from the projecting portion 82 and replaced with another tip portion. The tip portion 86 comprises a material that is harder than a material of the projecting portion 82. For instance, in this example, the tip portion 86 of each of the central keels 42₂, 42₃ comprises metallic material, such as carbide. In other embodiments, the tip portion 86 may comprise any other suitable material that is harder than the material of the projecting portion 82.

In this embodiment, each one of the lateral keels 42₁, 42₄ is formed by a bend 90 in the body 84 of the ski 28. That is, each one of the lateral keels 42₁, 42₄ comprises a bent portion 53 of the body 84 of the ski 28. Moreover, in this embodiment, each of the lateral keels 42₁, 42₄ comprises a tip member 92 for providing a sharp and durable grip on the snow to respective ones of the lateral keels 42₁, 42₄. Each tip member 92 is disposed on the upper side 38 of the ski 28 and is secured to the lateral keels 42; (e.g., via fasteners). In this example, the tip member 92 comprises a plate extending along the longitudinal direction of the ski 28. The tip member 92 comprises a material that has material properties that are different from material properties of a material of the body of the ski 28. For example, the tip member 92 may comprise a material that is stiffer, harder and/or denser than the material of the body 84 of the ski 28. In this embodiment, the tip member 92 comprises metallic material, such as high strength steel (HSS) or carbide. The tip member 92 may comprise any other suitable material in other embodiments.

Furthermore, in this embodiment, the ski 28 comprises a handle 85 that is connected to the body 84 of the ski 28 on the upper side 38 of the ski 28. The handle 85 forms a loop for attaching a cable or other looping member therefrom that can be used for towing or otherwise pulling the snow bike 10.

The ski mount 30 interconnects the ski 28 to the front fork 34 of the snow bike 10. In this embodiment, the ski mount 30 comprises a connector 94 to implement the connection 70 of the ski system 14 to the front fork 34 of the snow bike 10 and a connector 96 for connecting the ski mount 30 to the ski 28. The connector 96 comprises the pivot 52 about which the ski 28 is pivotable relative to the ski mount 30.

In this embodiment, the ski mount 30 is compliant to protect the structural integrity of the snow bike 10, including the front fork 34. That is, the ski mount 30 is resiliently deformable (i.e., changeable in configuration) under load in use to allow movement of a part of the ski mount 30 relative to another part of the ski mount 30 such that the ski mount 30 is changeable from a first configuration to a second configuration in response to the load and recover the first configuration in response to removal of the load.

For example, in this embodiment, the ski mount 30 is not stiffer than (i.e., is as stiff as or less stiff than) the front fork 34 of the snow bike 10. In other words, the front fork 34 of the snow bike 10 is at least as stiff (i.e., as stiff as or stiffer than) the ski mount 30. More particularly, in this embodiment, the ski mount 30 is less stiff than the front fork 34 of the snow bike 10. The ski mount 30 thus deflects more than the front fork 34 of the snow bike 10 when loaded.

For instance, in this embodiment, a torsional stiffness of the ski mount 30 is less than a torsional stiffness of the front fork 34 of the snow bike 10. The torsional stiffness of the ski mount 30 is a resistance to torsion of the ski mount 30 about a longitudinal axis 98 of the front fork 34. Similarly, the torsional stiffness of the front fork 34 is a resistance to torsion of the front fork 34 about its longitudinal axis 98. For example, in some embodiments, the torsional stiffness of the ski mount 30 may be no more than 80 ft-lbs/deg, in some cases than 70 ft-lbs/deg, in some cases than 60 ft-lbs/deg, in some cases no more than 50 ft-lbs/deg and in some cases even (e.g., 40 ft-lbs/deg). For instance, in some cases, a ratio of the torsional stiffness of the ski mount 30 over the torsional stiffness of the front fork 34 may be no more than 0.9, in some cases no more than 0.8, in some cases no more than 0.7, and in some cases even less.

Also, in this embodiment, a bending stiffness of the ski mount 30 is less than a bending stiffness of the front fork 34 of the vehicle 10. The bending stiffness of the ski mount 30 is a resistance to bending of the ski mount 30 about an axis 102 parallel to the widthwise direction of the ski system 14 (i.e., bending in a front/rear direction). Similarly, the bending stiffness of the front fork 34 is a resistance to bending of the front fork 34 about an axis 120 parallel to the widthwise direction of the ski system 14. For example, in some embodiments, the bending stiffness of the ski mount 30 measured about the pivot axis 54 may be no more than 2000 lbs/inch, in some cases no more than 1750 lbs/inch, in some cases no more than 1500 lbs/inch, in some cases no more than 1250 lbs/inch, and in some cases even less (e.g., 1000 lbs/inch). For instance, in some cases, a ratio of the bending stiffness of the ski mount 30 over the bending stiffness of the front fork 34 may be no more than 0.9, in some cases no more than 0.8, in some cases no more than 0.7, and in some cases even less.

In this embodiment, the ski mount 30 comprises a resilient material 104 which provides compliance. In this case, the resilient material 104 makes up at least a majority (i.e., a majority or an entirety) of the ski mount 30.

The resilient material 104 of the ski mount 30 may have any suitable degree of compliance. For example, in some embodiments, a modulus of elasticity (i.e., Young's modulus) of the resilient material 104 may be no more than 20 GPa, in some cases no more than 10 GPa, in some cases no more than 1 GPa, and in some cases even less (e.g., 0.2 GPa). The modulus of elasticity of the resilient material 104 may have any other suitable value in other embodiments.

In this embodiment, the resilient material 104 of the ski mount 30 is a polymeric material. In this example, the polymeric material 104 comprises polyurethane (PU). In other examples, the polymeric material 104 may include any other suitable polymer (e.g., polypropylene, ethylene-vinyl acetate (EVA), nylon, polyester, vinyl, polyvinyl chloride, polycarbonate, polyethylene, or any other thermoplastic or thermosetting polymer).

In some examples of implementation, the polymeric material 104 may be a composite material that comprises a polymeric matrix in which fibers are embedded. The matrix may include any suitable polymeric resin, such as a thermosetting polymeric material (e.g., polyester, vinyl ester, vinyl ether, polyurethane, epoxy, cyanate ester, etc.), a thermoplastic polymeric material (e.g., polyethylene, polypropylene, acrylic resin, polyether ether ketone, polyethylene terephthalate, polyvinyl chloride, polymethyl methacrylate, polycarbonate, acrylonitrile butadiene styrene, nylon, polyimide, polysulfone, polyamide-imide, self-reinforcing polyphenylene, etc.), or a hybrid thermosetting-thermoplastic polymeric material. The fibers may be made of any suitable material such as carbon fibers, polymeric fibers such as aramid fibers, boron fibers, glass fibers, ceramic fibers, etc.).

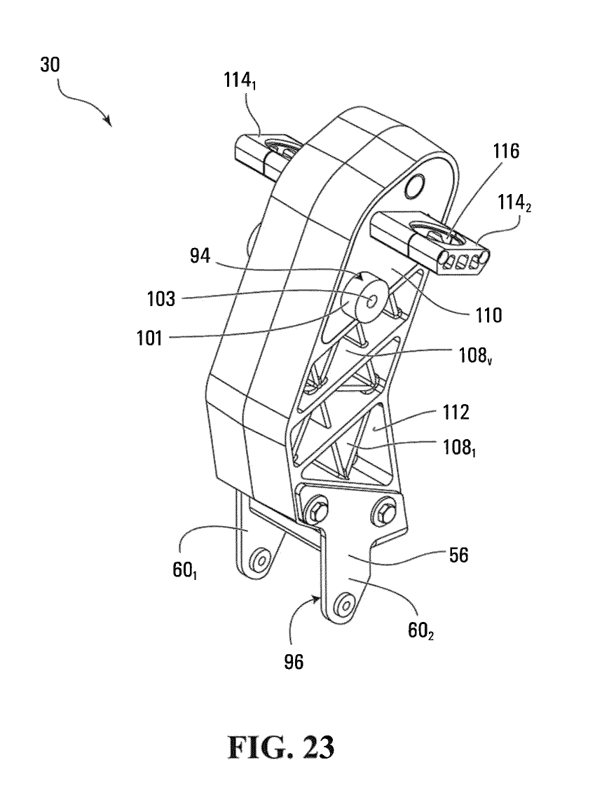

In this embodiment, the ski mount 30 comprises a hollow structural member 106 that is made of the polymeric material 104. The hollow structural member 106 includes voids 108₁-108_{V} (e.g., holes, recesses or other openings) that may further contribute to compliance of the ski mount 30. As shown in FIG. 23, in this embodiment, the hollow structural member 106 comprises an upper portion 110 and a lower portion 112 disposed at an angle (e.g., an obtuse angle) relative to the upper portion 110.

The upper portion 110 of the hollow structural member 106 comprises the connector 94. In this example, the connector 94 comprises a pair of positioning members 114₁, 114₂ that protrude from lateral surfaces of the hollow structural member 106 and are configured for receiving the front fork 34 of the snow bike 10 and thereby position the front fork 34 relative to the ski mount 30. To that end, each positioning member 114ᵢ comprises an opening 116 configured for receiving a respective fork member of the front fork 34 of the snow bike 10. In this example, the connector 94 also comprises an axle-receiving member 101 on each lateral side of the hollow structural member 106. The axle-receiving member 101 is configured to receive the axle 23 to which is typically mounted the front wheel 17. As the shape (e.g., dimensions) of the axle 23 may vary from one model of motorcycle to another, the axle-receiving member 101 is configured to adapt to different shapes (e.g., dimensions) of the axle 23. In this embodiment, the axle-receiving member 101 comprises a resilient material which allows the axle-receiving member 101 to resiliently adapt to the shape of the axle 23. In this example, the resilient material of the axle-receiving member 101 is disposed within an opening 103 of the axle-receiving member 101 in which the axle 23 is received.

In this embodiment, each of the positioning members 114₁, 114₂ comprises a first clamping member 115 and a second clamping member 117 that are assembled together such as to clamp around a fork member of the front fork 34 of the snow bike 10, as shown in FIG. 4. More specifically, the opening 116 of a given positioning member 114ₓ is defined by the assembly of the clamping members 115, 117 of the positioning member 114ₓ. Since the clamping members 115, 117 clamp around the fork member of the front fork 34, a size of the opening 116 may vary accordingly. As such, the positioning member 114ₓ may be configured to fit a range of fork member sizes (such that the ski mount 30 can be mounted to a range of motorcycle models).

In order to affix the positioning member 114ₓ to the hollow structural member 106 of the ski mount 30, in this embodiment, each of the clamping members 115, 117 comprises a pair of openings for receiving a respective fastener 118 that secures the positioning member 114ₓ to the hollow structural member 106. The fastener 118 extends through the clamping member 115, which is most adjacent to the hollow structural member 106, and through the clamping member 117 and is received in a fastener-engaging opening of the hollow structural member 106.

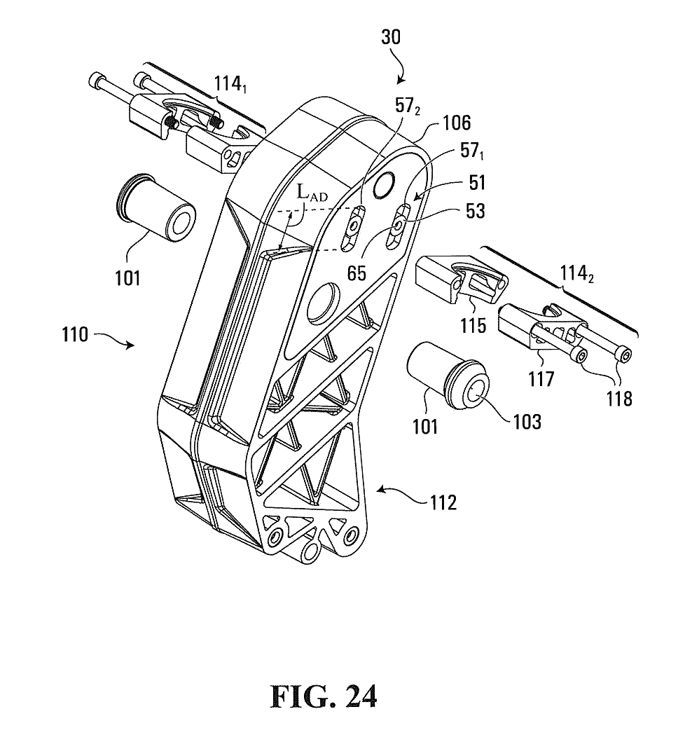

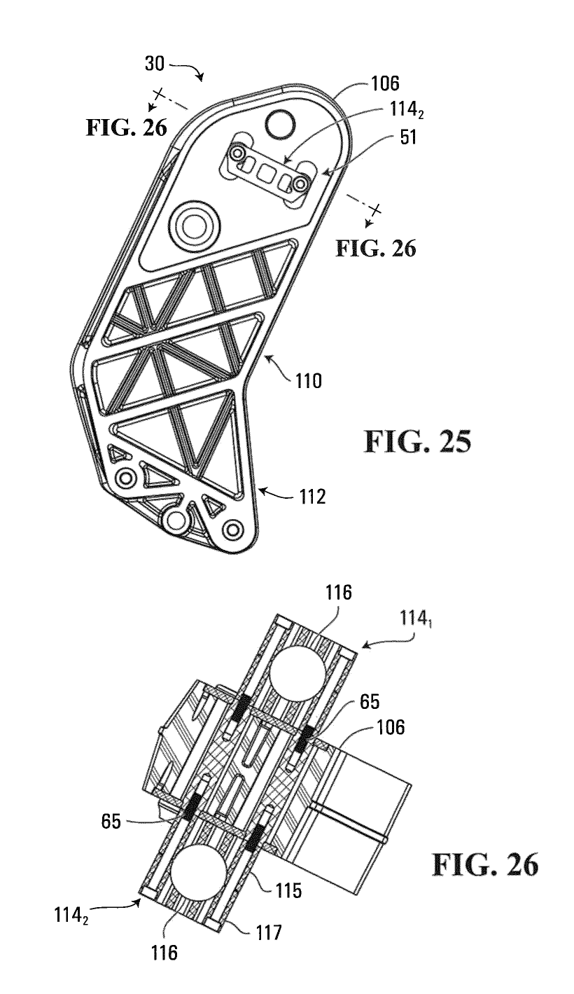

In this embodiment, the ski mount 30 is adjustably connected to the front fork 34 of the snow bike 10 so that a position in which the ski mount 30 is connected to the front fork 34 of the snow bike 10 is adjustable. To that end, as shown in FIG. 24, the connector 94 comprises an adjuster 51 to adjust the position in which the ski mount 30 is connected to the front fork 34 of the snow bike 10. This allows adjusting the ski mount 30 to accommodate different models of motorcycles whose front forks may be configured differently.

More particularly, in this embodiment, the adjuster 51 is configured to adjust the position in which the ski mount 30 is connected to the front fork 34 of the snow bike 10 in the heightwise direction of the snow bike 10.

For instance, in some embodiments, a ratio of a distance of adjustment of position L_{AD} in which the ski mount 30 is connected to the front fork 34 of the snow bike 10 over a height H_{SM} of the ski mount 30 may be at least 0.1, in some cases at least 0.2, in some cases at least 0.3, in some cases at least 0.4 and in some cases even more.

In this embodiment, the adjuster 51 comprises an adjustable mount 53 to which the positioning members 114₁, 114₂ can be mounted. More particularly, in this example of implementation, the adjustable mount 53 comprises a pair of slots 57₁, 57₂ and a fastener-engaging member 65 disposed in each slot 57ₓ. The fastener-engaging member 65 is configured to securedly receive a given one of the fasteners 118 (i.e., threadedly engage the fastener 118) such as to secure a given positioning member 114ₓ to the hollow structural member 106 of the ski mount 30. The fastener-engaging member 65 is moveable along a length of the slot 57ₓ.

Thus, by adjusting a position of the fastener-engaging member 65 along the length of the slot 57ₓ, a height of the positioning member 114ₓ relative to the ski mount 30 and/or the front fork 34 can be adjusted. A center-to-center distance between a first and a second end position of the fastener-engaging member 65 corresponding to extremities of a range of motion provided by the slot 57ₓ thus defines the distance of adjustment of position L_{AD} in which the ski mount 30 is connected to the front fork 34 of the snow bike 10. As such, in this embodiment, the adjuster 51 provides a continuous range of heights at which the positioning member 114ₓ may be adjusted, in which any value within the continuous range of heights may be assumed by the positioning member 114ₓ.

In some embodiments, the adjustable mount 53 may comprise a plurality of fastener-engaging members (e.g., threaded holes) at different heights of the hollow structural member 106 such that the positioning members 114₁, 114₂ can be secured at different heights of the ski mount 30 by securing the positioning members 114₁, 114₂ at a selected set of the fastener-engaging members. In such embodiments, the adjuster 51 provides a discontinuous range of heights at which the positioning member 114x may be adjusted, in which a finite number of values within the discontinuous range of heights may be assumed by the positioning member 114ₓ.

The adjustability provided by the adjuster 51 may be useful in installing the ski mount 30 to the front fork 34 at a correct height. For example, it may be desirable that the positioning members 114₁, 114₂ be installed on the front fork 34 such that they abut an axle-receiving member 119 disposed at an end of each fork member of the front fork 34 of the snow bike 10 (as shown in FIG. 4). Notably, when a front suspension member of the front fork 34 attains an end of travel position, the positioning members 114₁, 114₂ bump off the axle-receiving members 119 which may be undesirable (e.g., by inducing high stresses) if a distance between the positioning members 114₁, 114₂ and the axle-receiving members 119 is too great. As the axle-receiving members 119 may be positioned at a different height of the front fork 34 for different motorcycle models, the adjustability of the ski mount 30 relative to the front fork 34 provided by the adjuster 51 may accommodate this variance.

In addition to or instead of the position in which the ski mount 30 is connected to the front fork 34 of the snow bike 10 being adjustable in some embodiments, the ski mount 30 is adjustably connected to the ski 28 such that a position in which the ski mount 30 is connected to the ski 28 is adjustable. For instance, a set of connectors such as the connector 96 may be provided and the user may select a given one of the connectors for use with the ski mount 30. Each connector of the set of connectors may be configured differently (e.g., the positioning of the opening 62 of the extensions 60₁, 60₂ may be higher or lower) such that a position of the ski mount 30 relative to the ski 28 is different when each of the connectors is installed. For example, a vertical position of the ski mount 30 relative to the ski 28 may be different when each connector is installed.

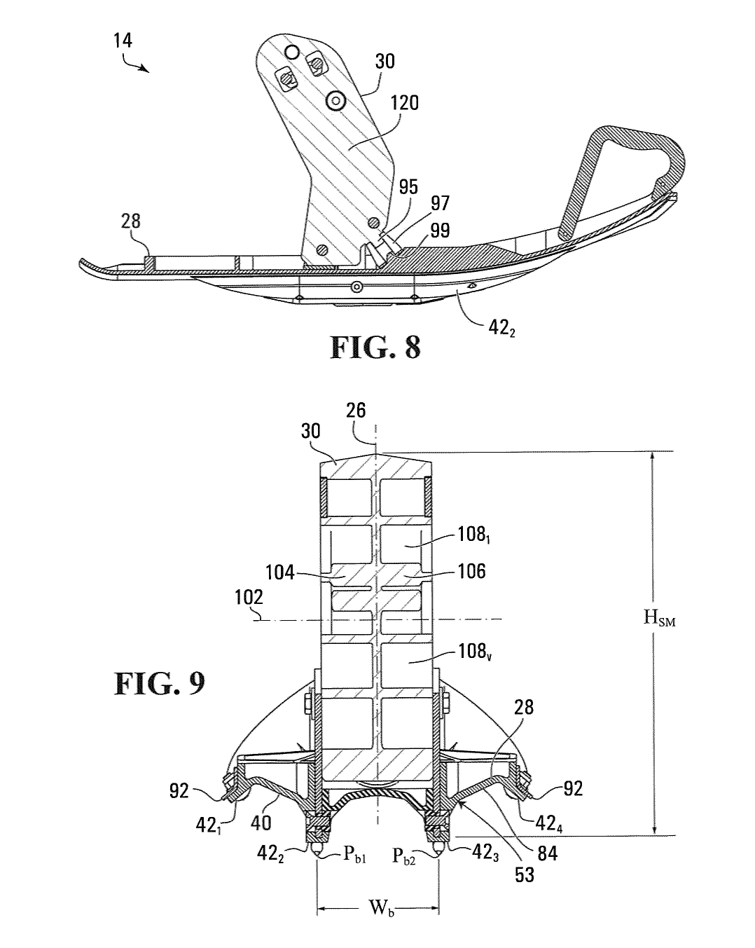

In this embodiment, the lower portion 112 of the hollow structural member 106 comprises the connector 96 and an engaging member 95 for connecting to a limiter 97 of the ski 28 that is configured to limit displacement (e.g., pivoting) of the ski 28 relative to the ski mount 30. The connector 96 comprises the portion 56 of the ski mount 30 that extends into the ski 28 past its floatation surface 55. As shown in FIG. 8, the limiter 97 is disposed on the upper side 38 of the ski 28 and is affixed to a portion 99 (e.g., a protrusion) of the body 84 of the ski 28. In this example, the limiter 97 comprises a bushing that is made of a resilient material such as to allow a certain amount of elastic deformation. The engaging member 95 may engage the limiter 97 in any suitable way. For instance, in this example, the engaging member 95 comprises a protrusion that is received within an opening of the limiter 97 and affixed thereto in any suitable way (e.g., a press fit, a fastener, an adhesive, etc.).

The ski mount 30 may be made in any suitable way. For example, in some embodiments, the ski mount 30 may be made via blow molding such that the ski mount 30 comprises a body comprising the resilient material 104 and which substantially encloses a hollow interior of the ski mount 30.

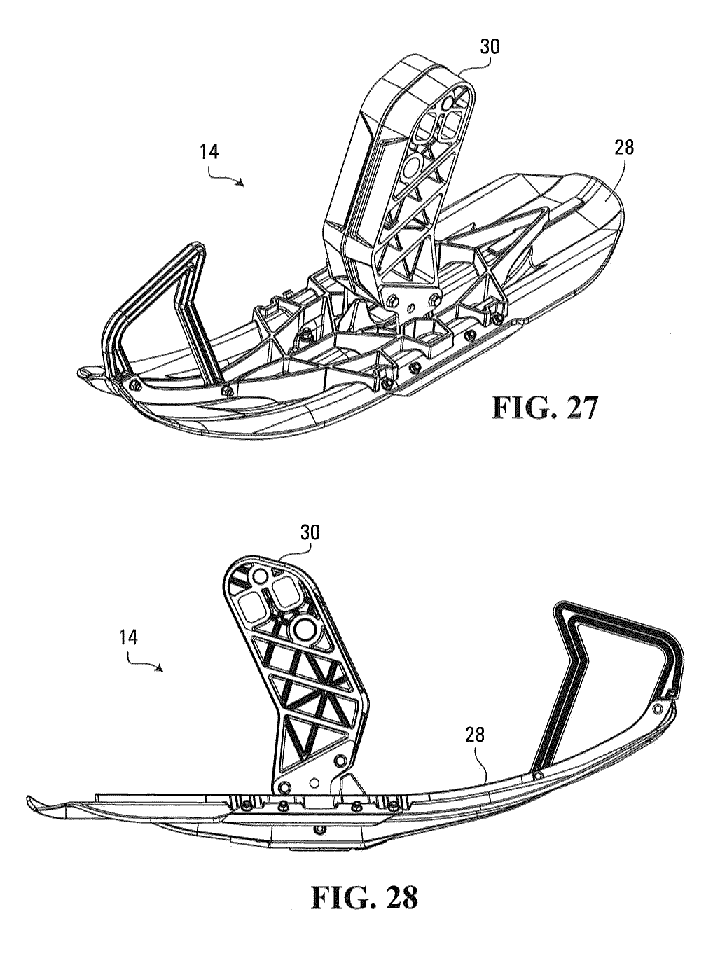

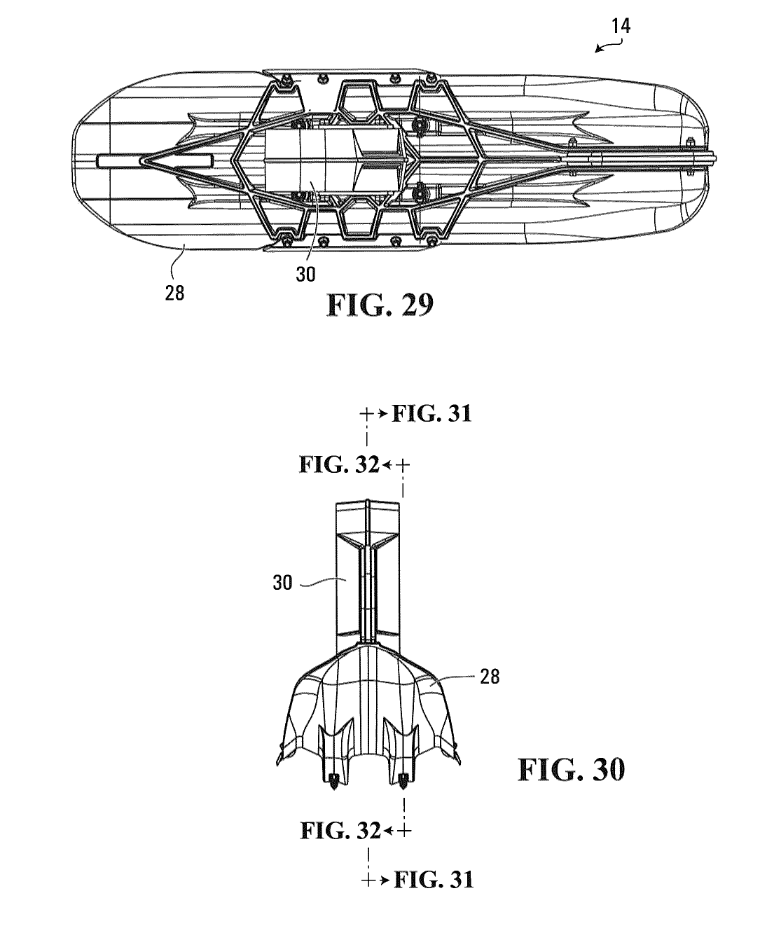

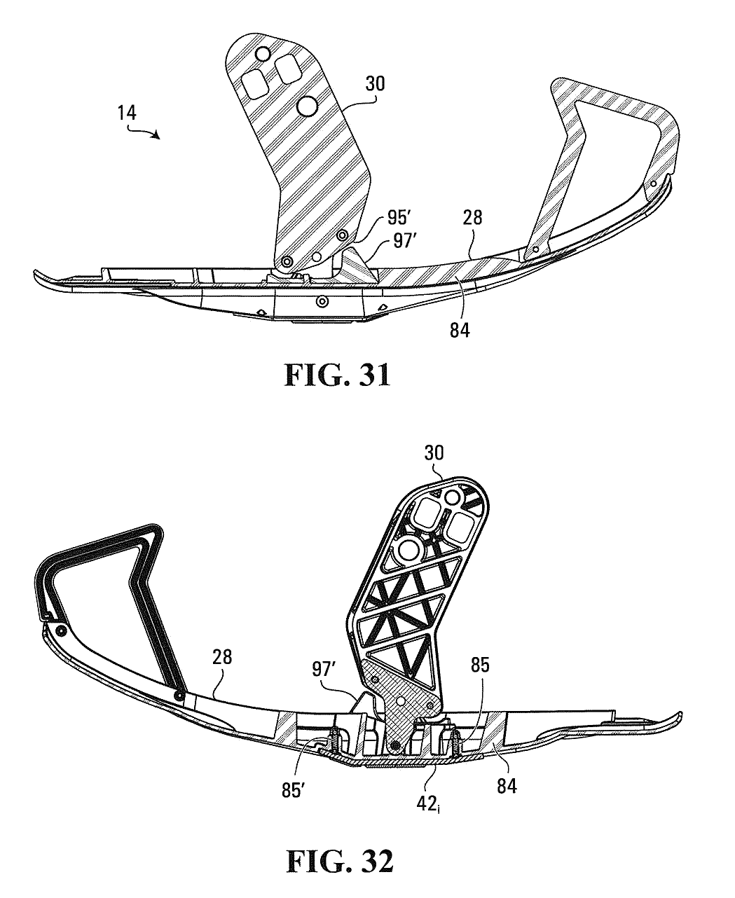

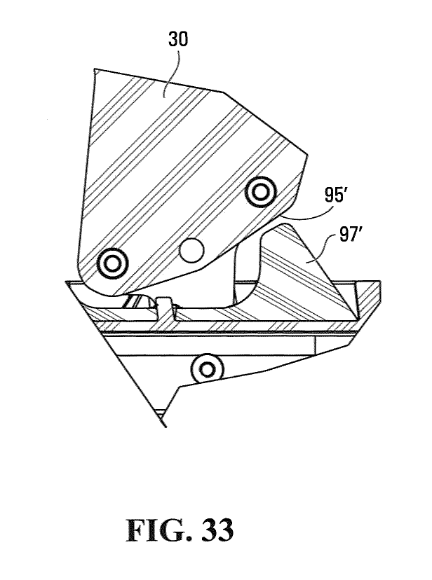

FIGS. 27 to 33 show a variant of the ski system 14. In this embodiment, as shown in FIGS. 31 to 33, the ski 28 comprises a limiter 97′ disposed on the upper side of the ski 28 and achieving a similar function to the limiter 97. More particularly, the limiter 97′ is configured to limit displacement (e.g., pivoting) of the ski 28 relative to the ski mount 30. A lower portion of a hollow structural member of the ski mount 30 comprises an engaging member 95′ for engaging the limiter 97′. In this embodiment, the engaging member 95′ comprises a surface (e.g., a flat surface) of the hollow structural member that engages the limiter 97′. Moreover, in this embodiment, the limiter 97′ comprises a member that is affixed to the body 84 of the ski 28 via a mating fit (e.g., by engaging a recess of the limiter 97′ with a protrusion of the body 84 of the ski 28). In other embodiments, the limiter 97′ may be integrally formed with the body 84 of the ski 28.

Furthermore, as shown in FIG. 32, in this embodiment, the tip portion 86 of the central keel 42ᵢ is affixed to the body 84 of the ski 28 via a pair of fasteners 85′ that engage the tip portion 86 of the central keel 42ᵢ and are threadedly engaged by fastener-receiving openings of the body 84 of the ski 28 such as to retain the tip portion 86 of the central keel 42ᵢ thereto.

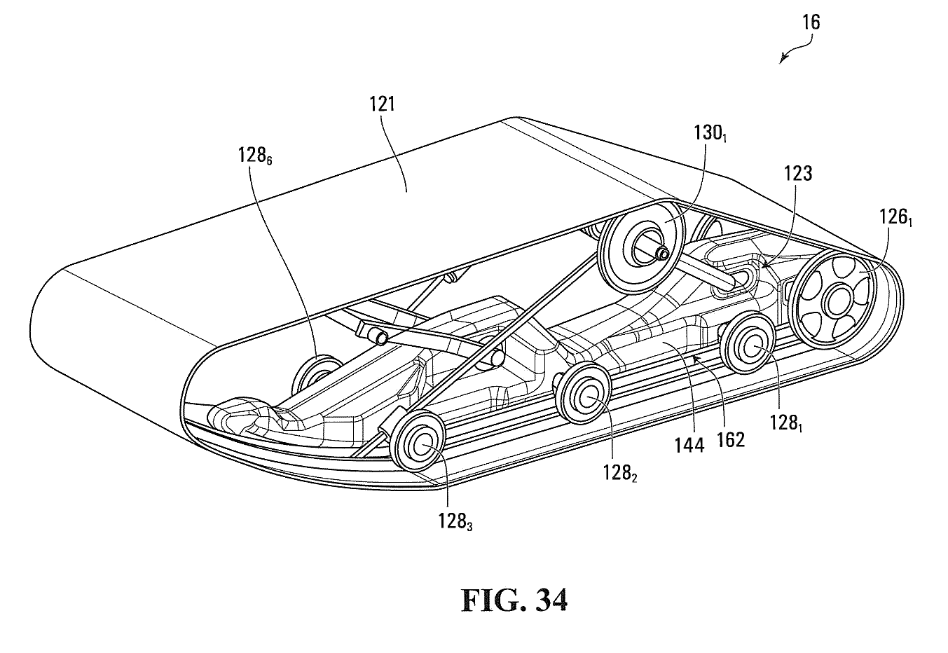

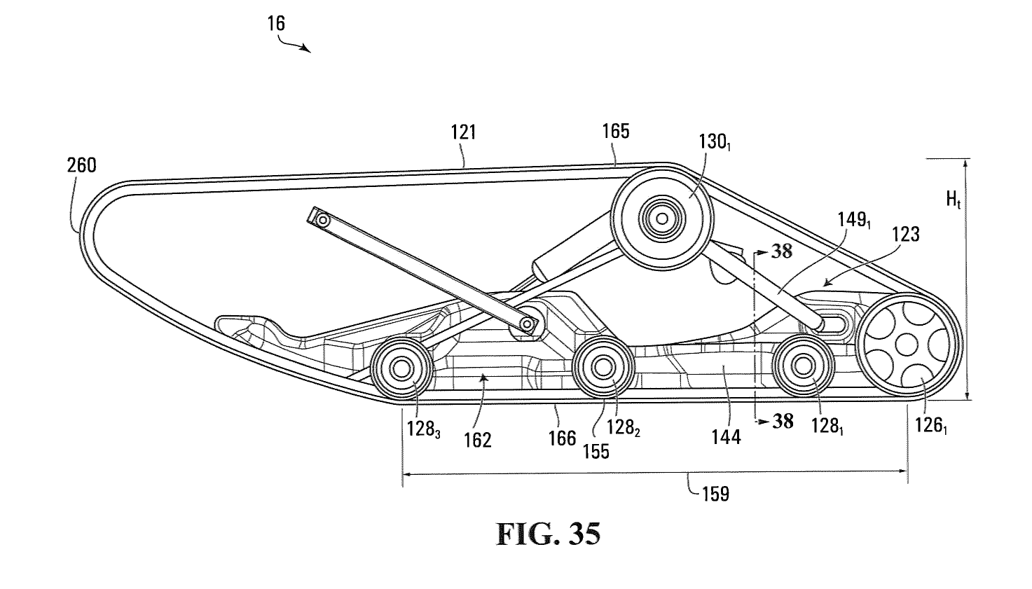

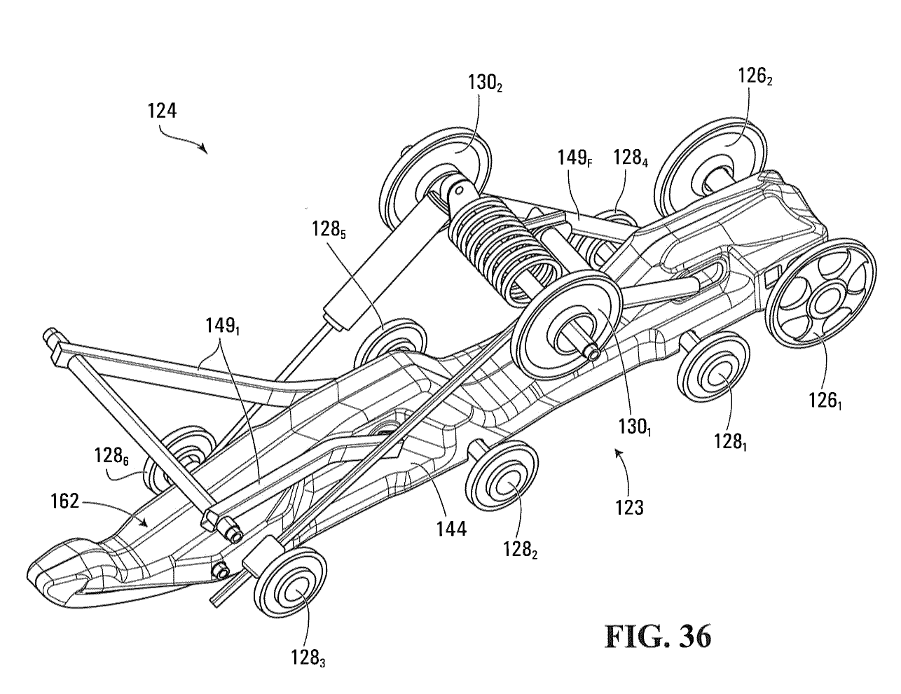

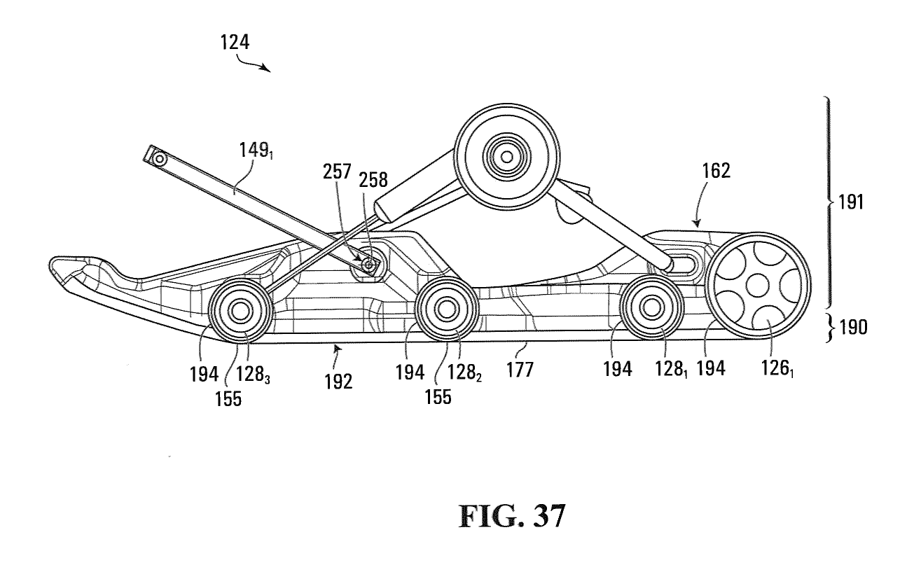

The track system 16 engages the ground to generate traction for the snow bike 10. With additional reference to FIGS. 34 to 37, the track system 16 comprises a track-engaging assembly 124 and a track 121 disposed around the track-engaging assembly 124. More particularly, in this embodiment, the track-engaging assembly 124 comprises a frame 123 and a plurality of track-contacting wheels which includes a plurality of drive wheels 122₁, 122₂ and a plurality of idler wheels that includes rear idler wheels 126₁, 126₂, lower roller wheels 128₁-128₆, and upper roller wheels 130₁, 130₂. As it is disposed between the track 121 and the frame 11 of the snow bike 10, the track-engaging assembly 124 can be viewed as implementing a suspension for the snow bike 10. The track system 16 has a longitudinal direction and a first longitudinal end and a second longitudinal end that define a length of the track system 16, a widthwise direction and a width that is defined by a width Wₜ of the track 121, and a heightwise direction that is normal to its longitudinal direction and its widthwise direction.

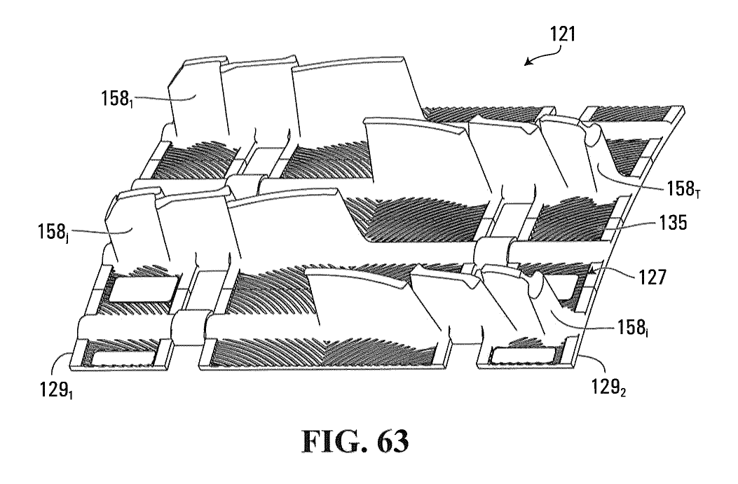

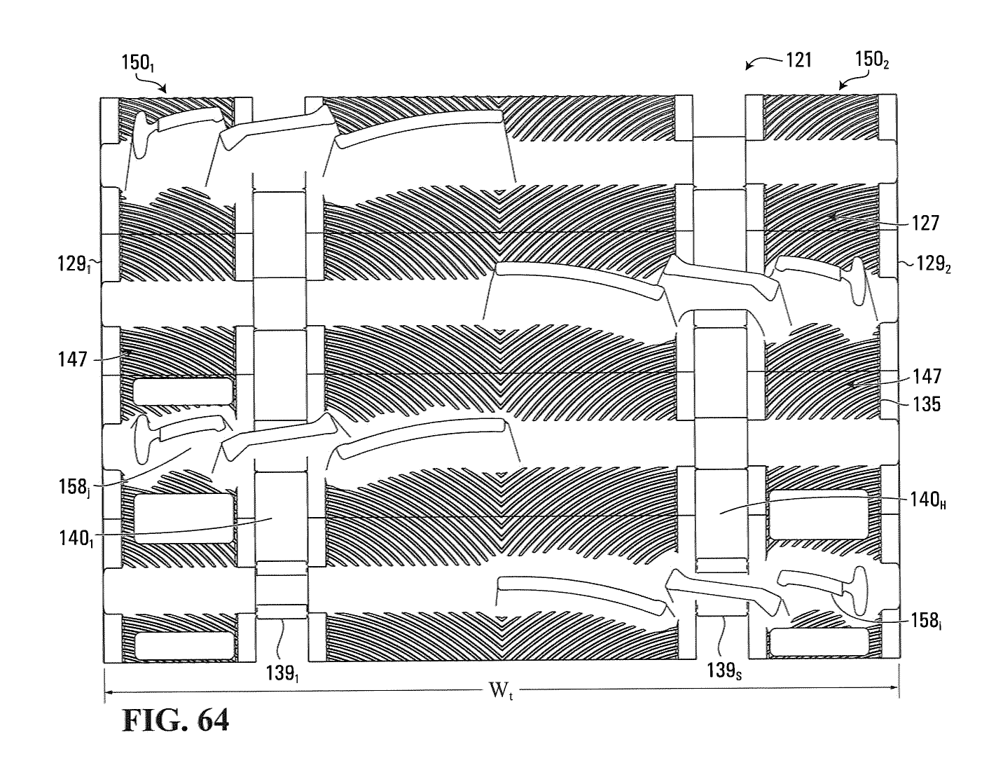

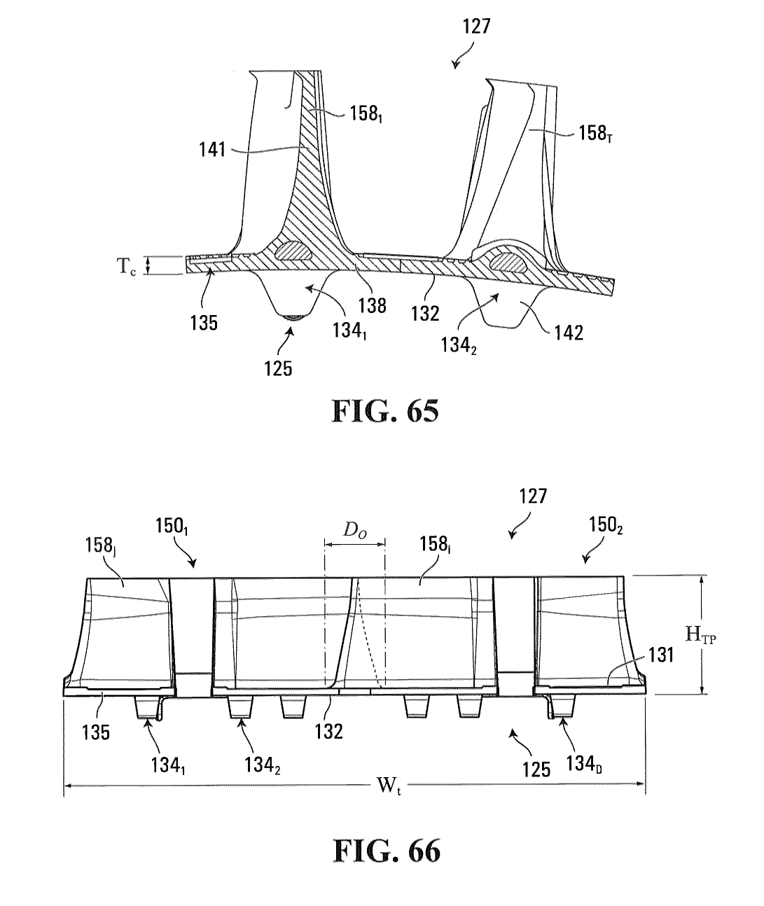

The track 121 engages the ground to provide traction to the snow bike 10. A length of the track 121 allows the track 121 to be mounted around the track-engaging assembly 124. In view of its closed configuration without ends that allows it to be disposed and moved around the track-engaging assembly 124, the track 121 can be referred to as an “endless” track. With additional reference to FIGS. 63 to 68, the track 121 comprises an inner side 125 for facing the track-engaging assembly 124, a ground-engaging outer side 127 for engaging the ground, and lateral edges 129₁, 129₂. A top run 165 of the track 121 extends between the longitudinal ends of the track system 16 and over the track-engaging assembly 124 (including over the wheels 122₁, 122₂, 126₁, 126₂, 128₁-128₆, 130₁, 130₂), and a bottom run 166 of the track 121 extends between the longitudinal ends of the track system 16 and under the track-engaging assembly 124 (including under the wheels 122₁, 122₂, 126₁, 126₂, 128₁-128₆, 130₁, 130₂). The bottom run 166 of the track 121 defines an area of contact 159 of the track 121 with the ground which generates traction and bears a majority of a load on the track system 16, and which will be referred to as a “contact patch” of the track 121 with the ground. The track 121 has a longitudinal axis which defines a longitudinal direction of the track 121 (i.e., a direction generally parallel to its longitudinal axis) and transversal directions of the track (i.e., directions transverse to its longitudinal axis), including a widthwise direction of the track (i.e., a lateral direction generally perpendicular to its longitudinal axis). The track 121 has a thickness direction normal to its longitudinal and widthwise directions.

The track 121 is elastomeric, i.e., comprises elastomeric material, to be flexible around the track-engaging assembly 124. The elastomeric material of the track 121 can include any polymeric material with suitable elasticity. In this embodiment, the elastomeric material of the track 121 includes rubber. Various rubber compounds may be used and, in some cases, different rubber compounds may be present in different areas of the track 121. In other embodiments, the elastomeric material of the track 121 may include another elastomer in addition to or instead of rubber (e.g., polyurethane elastomer).

More particularly, the track 121 comprises an endless body 135 underlying its inner side 125 and ground-engaging outer side 127. In view of its underlying nature, the body 135 will be referred to as a “carcass”. The carcass 135 is elastomeric in that it comprises elastomeric material 138 which allows the carcass 135 to elastically change in shape and thus the track 121 to flex as it is in motion around the track-engaging assembly 124. The elastomeric material 138 can be any polymeric material with suitable elasticity. In this embodiment, the elastomeric material 138 includes rubber. Various rubber compounds may be used and, in some cases, different rubber compounds may be present in different areas of the carcass 135. In other embodiments, the elastomeric material 138 may include another elastomer in addition to or instead of rubber (e.g., polyurethane elastomer).

In this embodiment, the carcass 135 comprises a plurality of reinforcements 145₁-145_{P} embedded in its rubber 138. These reinforcements 145₁-145_{P} can take on various forms.

For example, in this embodiment, a subset of the reinforcements 145₁-145_{P} is a plurality of transversal stiffening rods 136₁-136_{N} that extend transversally to the longitudinal direction of the track 121 to provide transversal rigidity to the track 121. More particularly, in this embodiment, the transversal stiffening rods 136₁-136_{N} extend in the widthwise direction of the track 121. Each of the transversal stiffening rods 136₁-136_{N} may have various shapes and be made of any suitably rigid material (e.g., metal, polymer or composite material).

As another example, in this embodiment, the reinforcement 145ᵢ is a layer of reinforcing cables 137₁-137_{M} that are adjacent to one another and extend generally in the longitudinal direction of the track 121 to enhance strength in tension of the track 121 along its longitudinal direction. In this case, each of the reinforcing cables 137₁-137_{M} is a cord including a plurality of strands (e.g., textile fibers or metallic wires). In other cases, each of the reinforcing cables 137₁-137_{M} may be another type of cable and may be made of any material suitably flexible longitudinally (e.g., fibers or wires of metal, plastic or composite material). In some examples of implementation, respective ones of the reinforcing cables 137₁-137_{M} may be constituted by a single continuous cable length wound helically around the track 121. In other examples of implementation, respective ones of the transversal cables 137₁-137_{M} may be separate and independent from one another (i.e., unconnected other than by rubber of the track 121).

As yet another example, in this embodiment, the reinforcement 145ⱼ is a layer of reinforcing fabric 143. The reinforcing fabric 143 comprises thin pliable material made usually by weaving, felting, knitting, interlacing, or otherwise crossing natural or synthetic elongated fabric elements, such as fibers, filaments, strands and/or others, such that some elongated fabric elements extend transversally to the longitudinal direction of the track 121 to have a reinforcing effect in a transversal direction of the track 121. For instance, the reinforcing fabric 143 may comprise a ply of reinforcing woven fibers (e.g., nylon fibers or other synthetic fibers). For example, the reinforcing fabric 143 may protect the transversal stiffening rods 136₁-136_{N}, improve cohesion of the track 121, and counter its elongation.

The carcass 135 may be molded into shape in a molding process during which the rubber 138 is cured. For example, in this embodiment, a mold may be used to consolidate layers of rubber providing the rubber 138 of the carcass 135, the reinforcing cables 137₁-137_{M} and the layer of reinforcing fabric 143.

The ground-engaging outer side 127 of the track 121 comprises a ground-engaging outer surface 131 of the carcass 135 and a plurality of traction projections 158₁-158_{T} that project from the ground-engaging outer surface 131 to enhance traction on the ground. The traction projections 158₁-158_{T}, which can be referred to as “traction lugs” or “traction profiles”, may have any suitable shape (e.g., straight shapes, curved shapes, shapes with straight parts and curved parts, etc.).

In this embodiment, each of the traction projections 158₁-158_{T} is an elastomeric traction projection in that it comprises elastomeric material 141. The elastomeric material 141 can be any polymeric material with suitable elasticity. More particularly, in this embodiment, the elastomeric material 141 includes rubber. Various rubber compounds may be used and, in some cases, different rubber compounds may be present in different areas of each of the traction projections 158₁-158_{T}. In other embodiments, the elastomeric material 141 may include another elastomer in addition to or instead of rubber (e.g., polyurethane elastomer).

The traction projections 158₁-158_{T} may be provided on the ground-engaging outer side 127 in various ways. For example, in this embodiment, the traction projections 158₁-158_{T} are provided on the ground-engaging outer side 127 by being molded with the carcass 135.

In this embodiment, the traction projections 158₁-158_{T} are configured to enhance traction even when the snow bike 10 is not upright but rather leaning, such as on a side hill or in other situations where it is leaning. This may be particularly useful given that the snow bike 10 may be used to frequently move on side hills or otherwise lean.

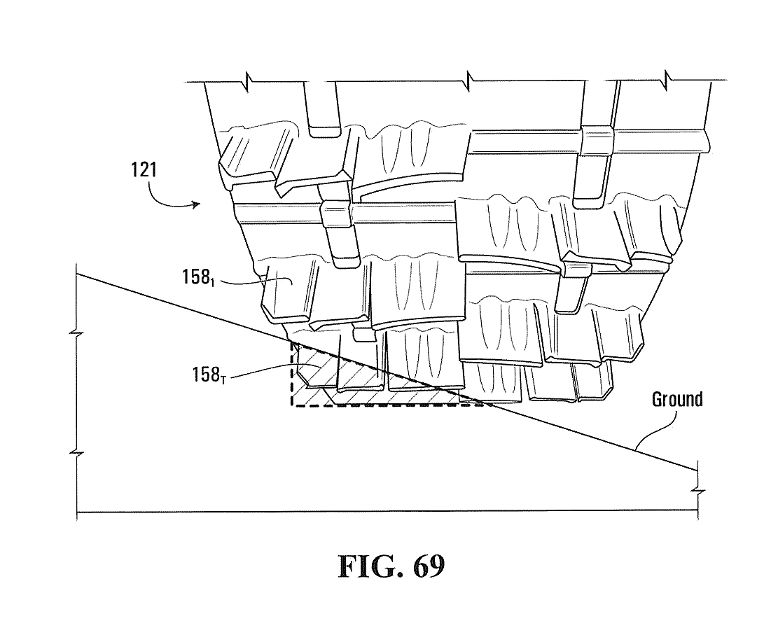

More particularly, in this embodiment, the traction projections 158₁-158_{T} are configured to occupy and be high along at least a substantial part of the width Wₜ of the track 121, including adjacent the lateral edges 129₁, 129₂ of the track 121. As shown in FIG. 69, this may allow the traction projections 158₁-158_{T} that engage the snow when the snow bike 10 is leaned, such as when driven on a side hill, to engage the snow along a significant part (e.g., a majority or an entirety) of their extent in the widthwise direction of the track 121, thereby enhancing their tractive effect.

For example, in this embodiment, each traction projection 158ᵢ is at least as high (i.e., as high or higher) in a lateral edge portion 147 of the track 121 than outside of the lateral edge portion 147 of the track 121. The lateral edge portion 147 of the track 121 extends from a given one of the lateral edges 129₁, 129₂ of the track 121 in the widthwise direction of the track 121 for no more than 20% of the width Wₜ of the track 121, in some cases no more than 15% of the width Wₜ of the track 121, in some cases no more than 10% of the width Wₜ of the track 121, and in some cases no more than 5% of the width Wₜ of the track 121. That is, a height H_{TP} of the traction projection 158ᵢ in the lateral edge portion 147 of the track 121 is at least as great as (i.e., as great as or greater than) the height H_{TP} of the traction projection 158ᵢ outside of the lateral edge portion 147 of the track 121.

In this example, each traction projection 158ᵢ remains substantially level in the widthwise direction of the track 121. For instance, in some embodiments, the height H_{TP} of the traction projection 158ᵢ may not vary significantly (e.g., may remain substantially constant) over an extent of the traction projection 158ᵢ in the widthwise direction of the track 121. For example, in some embodiments, the height H_{TP} of the traction projection 158ᵢ may not vary by more than 10%, in some cases may not vary by more than 5%, and in some cases may not vary by more 2%, and in some cases may remain substantially constant (i.e., substantially may not vary) over the extent of the traction projection 158ᵢ in the widthwise direction of the track 121. Thus, in this example, the traction projection 158ᵢ thus does not have a convex shape that tapers towards the lateral edges 129₁, 129₂ of the track 121 in the widthwise direction of the track 121.

In this embodiment, the track 121 has lateral halves 150₁, 150₂ (i.e., defined by bisecting the width of the track 121) and each traction projection 158ᵢ occupies at least a majority (i.e., a majority or an entirety) of at least one of the lateral halves 150₁, 150₂ of the track 121 in the widthwise direction of the track 121. For instance, in some embodiments, the traction projection 158ᵢ may occupy at least two-thirds, in some cases at least three-quarters, in some cases at least nine-tenths, and in some cases even more, including the entirety, of at least one of the lateral halves 150₁, 150₂ of the track 121 in the widthwise direction of the track 121. In this embodiment, the traction projection 158ᵢ occupies the entirety of a given one of the lateral halves 150₁, 150₂ of the track 121 in the widthwise direction of the track 121.

In this example of implementation, the traction projections 158₁-158_{T} are staggered relative to one another in the longitudinal direction of the track 121. More particularly, in this example of implementation, a traction projection 158ⱼ that succeeds a traction projection 158ᵢ in the longitudinal direction of the track 121 is offset relative to the traction projection 158ᵢ in the widthwise direction of the track 121. For instance, as shown in FIG. 66, in this example of implementation, the traction projection 158ᵢ overlaps the succeeding traction projection 158ⱼ over a distance D_{O} in the widthwise direction of the track 121. The distance D_{O} over which the traction projection 158ᵢ overlaps the succeeding traction projection 158ⱼ may be relatively small. For example, in some cases, a ratio of the distance D_{O} over the width Wₜ of the track 121 may be no more than 0.3, in some cases no more than 0.2, in some cases no more than 0.1, and in some cases even less.

In a variant, the traction projections 158₁-158_{T} may be configured such that a traction projection 158ᵢ does not overlap a succeeding traction projection 158ⱼ. That is, the traction projection 158ᵢ may be offset from the succeeding traction projection 158ⱼ such that the traction projection 158ᵢ does not overlap with the succeeding traction projection 158ⱼ in the widthwise direction of the track 121.

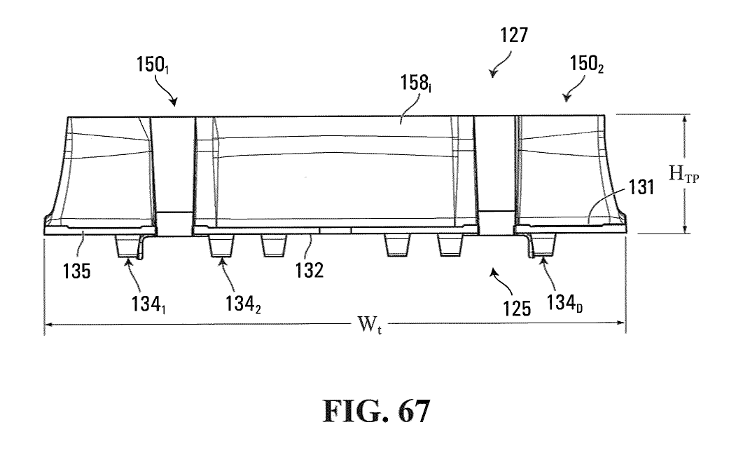

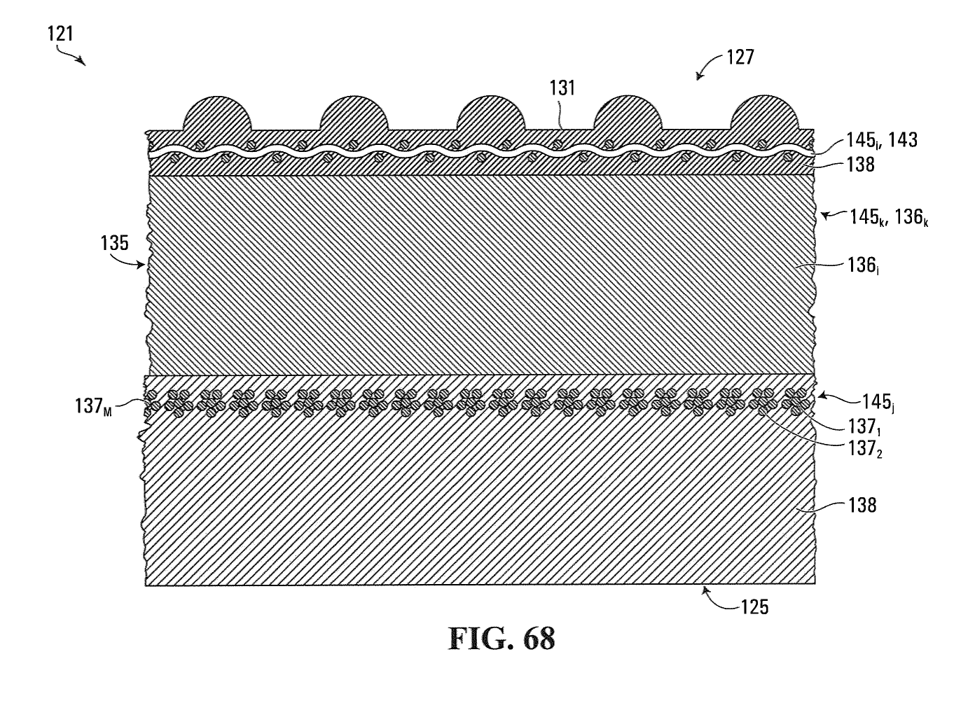

In other embodiments, as shown in FIG. 67, a traction projection 158ᵢ may occupy at least a majority (i.e., a majority or an entirety) of the width of the track 121 in the widthwise direction of the track 121. For instance, in some embodiments, the height H_{TP} of the traction projection 158ᵢ may not vary significantly (e.g., may remain substantially constant) over at least the majority of the width of the track 121. For example, in some cases, the traction projection 158ᵢ may occupy substantially the entirety of the width Wₜ of the track 121 and the height H_{TP} of the traction projection 158ᵢ may not vary significantly (e.g., may remain substantially constant) over that extent of the traction projection 158ᵢ.

The inner side 125 of the track 121 comprises an inner surface 132 of the carcass 135 and a plurality of inner projections 134₁-134_{D} that project from the inner surface 132 and are positioned to contact the track-engaging assembly 124 (e.g., at least some of the wheels 122₁, 122₂, 126₁, 126₂, 128₁-128₆, 130₁, 130₂) to do at least one of driving (i.e., imparting motion to) the track 121 and guiding the track 121. Since each of them is used to do at least one of driving the track 121 and guiding the track 121, the inner projections 134₁-134_{D} can be referred to as “drive/guide projections” or “drive/guide lugs”. In some cases, a drive/guide lug 134ᵢ may interact with a given one of the drive wheels 122₁, 122₂ to drive the track 121, in which case the drive/guide lug 134ᵢ is a drive lug. In other cases, a drive/guide lug 134ᵢ may interact with a given one of the idler wheels 126₁, 126₂, 128₁-128₂, 130₁, 130₂ and/or another part of the track-engaging assembly 124 to guide the track 121 to maintain proper track alignment and prevent de-tracking without being used to drive the track 121, in which case the drive/guide lug 134ᵢ is a guide lug. In yet other cases, a drive/guide lug 134ᵢ may both (i) interact with a given one of the drive wheels 122₁, 122₃ to drive the track 121 and (ii) interact with a given one of the idler wheels 126₁, 126₂, 128₁-128₆, 130₁, 130₂ and/or another part of the track-engaging assembly 124 to guide the track 121, in which case the drive/guide lug 134ᵢ is both a drive lug and a guide lug.

In this embodiment, each of the drive/guide lugs 134₁-134_{D} is an elastomeric drive/guide lug in that it comprises elastomeric material 142. The elastomeric material 142 can be any polymeric material with suitable elasticity. More particularly, in this embodiment, the elastomeric material 142 includes rubber. Various rubber compounds may be used and, in some cases, different rubber compounds may be present in different areas of each of the drive/guide lugs 134₁-134_{D}. In other embodiments, the elastomeric material 142 may include another elastomer in addition to or instead of rubber (e.g., polyurethane elastomer).

The drive/guide lugs 134₁-134_{D} may be provided on the inner side 125 in various ways. For example, in this embodiment, the drive/guide lugs 134₁-134_{D} are provided on the inner side 125 by being molded with the carcass 135.

In this embodiment, the carcass 135 has a thickness T_{c} which is relatively small. The thickness T_{c} of the carcass 135 is measured from the inner surface 132 to the ground-engaging outer surface 131 of the carcass 135 between longitudinally-adjacent ones of the traction projections 158₁-158_{T}. For example, in some embodiments, the thickness T_{c} of the carcass 135 may be no more than 0.25 inches, in some cases no more than 0.22 inches, in some cases no more than 0.20 inches, and in some cases even less (e.g., no more than 0.18 or 0.16 inches). The thickness T_{c} of the carcass 135 may have any other suitable value in other embodiments.

The track 121 may be relatively wide. For instance, this may provide enhanced floatation in deep snow and/or enhance traction in wet snow. This may allow the track system 16 to be mounted to larger or heavier motorcycles. Also, in this example, the track 121 may be relatively wide because the track system 16 does not rely on the motorcycle's rear suspension unit and is therefore less constrained. For example, in some embodiments, a ratio of the width Wₜ of the track 121 over a width W_{w} of a tire 27 of the rear wheel 19 of the motorcycle that is replaced by the track system 16 may be greater than two, in some cases at least 2.1, in some cases at least 2.2, in some cases at least 2.3, in some cases at least 2.4, and in some cases even more (e.g., at least 2.5) This ratio may have any other value in other embodiments. As another example, in some embodiments, a ratio of the width Wₜ of the track 121 over a width W_{d} of a sliding surface 177 of an elongate support 162 of the frame 123 of the track-engaging assembly 124 may be greater than 4.5, in some cases at least 5, in some cases at least 5.5, in some cases at least 6, in some cases at least 6.5 and in some cases even more. This ratio may have any other value in other embodiments. For instance, in some embodiments, the width Wₜ of the track 121 may be greater than 10 inches, in some cases at least 11 inches, in some cases at least 12 inches, and in some cases even more (e.g., at least 12.5 inches).

The track-engaging assembly 124 is configured to drive and guide the track 121 around the track-engaging assembly 124.

Each of the drive wheels 122₁, 122₂ is rotatable by an axle for driving the track 121. That is, power generated by the prime mover 15 and delivered over the powertrain 12 of the snow bike 10 rotates the axle, which rotates the drive wheels 122₁, 122₂, which impart motion of the track 121. In this embodiment, each drive wheel 122ᵢ comprises a drive sprocket engaging some of the drive/guide lugs 134₁-134_{D} of the inner side 125 of the track 121 in order to drive the track 121. In other embodiments, the drive wheel 122ᵢ may be configured in various other ways. For example, in embodiments where the track 121 comprises drive holes, the drive wheel 122ᵢ may have teeth that enter these holes in order to drive the track 121. As yet another example, in some embodiments, the drive wheel 122ᵢ may frictionally engage the inner side 125 of the track 121 in order to frictionally drive the track 121. The drive wheels 122₁, 122₂ may be arranged in other configurations and/or the track system 16 may comprise more or less drive wheels (e.g., a single drive wheel, more than two drive wheels, etc.) in other embodiments.

The idler wheels 126₁, 126₂, 128₁-128₆, 130₁, 130₂ are not driven by power supplied by the prime mover 15, but are rather used to do at least one of guiding the track 121 as it is driven by the drive wheels 122₁, 122₂, tensioning the track 121, and supporting part of the weight of the snow bike 10 on the ground via the track 121. More particularly, in this embodiment, the rear idler wheels 126₁, 126₂ are trailing idler wheels that maintain the track 121 in tension, guide the track 121 as it wraps around them, and can help to support part of the weight of the snow bike 10 on the ground via the track 121. The lower roller wheels 128₁-128₆ roll on the inner side 125 of the track 121 along the bottom run 166 of the track 121 to apply the bottom run 166 on the ground. The upper roller wheels 130₁, 130₂ roll on the inner side 125 of the track 121 along the top run 165 of the track 121 to support and guide the top run 165 as the track 121 moves. The idler wheels 126₁, 126₂, 128₁-128₆, 130₁, 130₂ may be arranged in other configurations and/or the track assembly 16 may comprise more or less idler wheels in other embodiments.

The frame 123 of the track system 16 supports various components of the track-engaging assembly 124, including, in this embodiment, the idler wheels 126₁, 126₂, 128₁-128₆, 130₁, 130₂. More particularly, in this embodiment, the frame 123 comprises the elongate support 162 extending in the longitudinal direction of the track system 16 along the bottom run 166 of the track 121 and frame members 149₁-149_{F} extending upwardly from the elongate support 162.

The elongate support 162 comprises a rail 144 extending in the longitudinal direction of the track system 14 along the bottom run 166 of the track 121. In this example, the idler wheels 126₁, 126₂, 128₁-128₆ are mounted to the rail 144. In this embodiment, the elongate support 62 comprises the sliding surface 177 for sliding on the inner side 125 of the track 121 along the bottom run 166 of the track 121. Thus, in this embodiment, the idler wheels 126₁, 126₂, 128₁-128₆ and the sliding surface 177 of the elongate support 162 can contact the bottom run 166 of the track 121 to guide the track 121 and apply it onto the ground for traction.

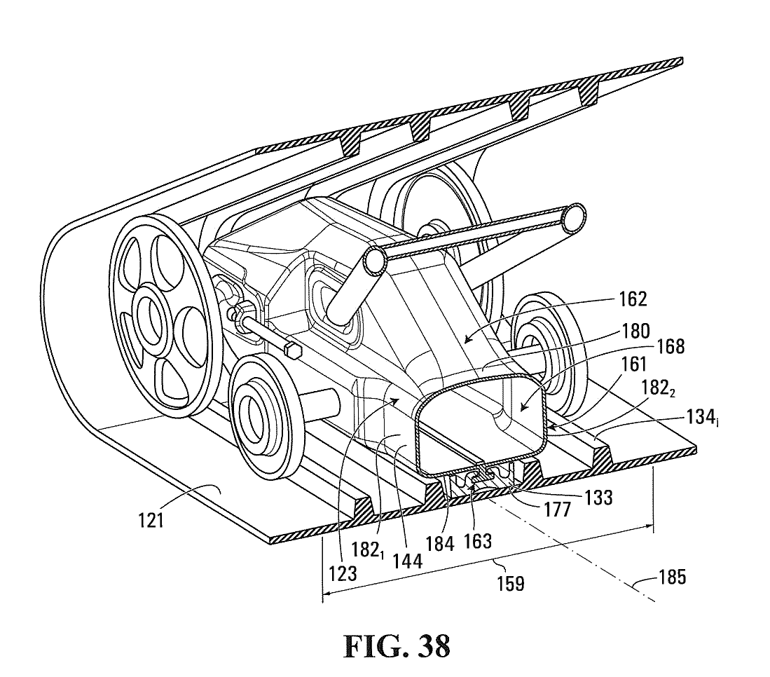

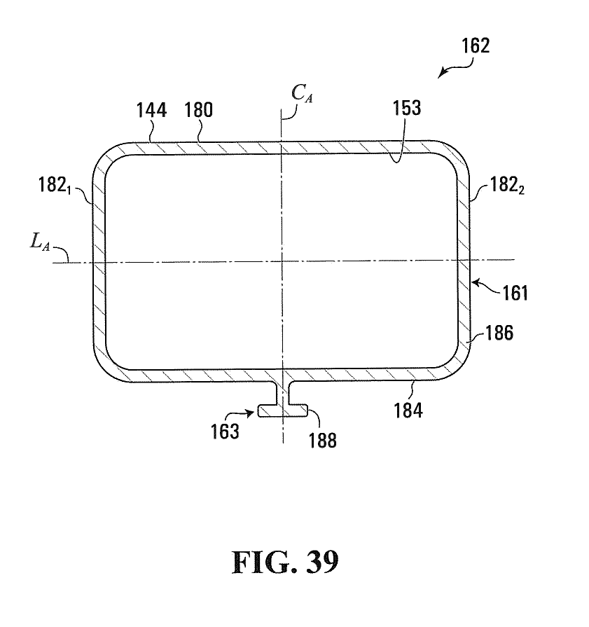

The rail 144 is an elongate structure that is elongated in the longitudinal direction of the track system 16 and comprises an upper portion 161 and a lower portion 163 between the upper portion 161 and the sliding surface 177, as shown in FIG. 38. More particularly, the rail 144 comprises a top 180, lateral surfaces 182₁, 182₂ opposite one another, and a bottom 184. Axles of the idler wheels 126₁, 126₂, 128₁-128₆ are carried by the rail 144 such that the idler wheels 126₁, 126₂, 128₁-128₆ are adjacent to respective ones of the lateral surfaces 182₁, 182₂ of the rail 144.

In this example, the rail 144 is a sole rail of the track-engaging assembly 124, which may thus be viewed as implementing a “single-rail suspension”. In other words, the track-engaging assembly 124 has a single rail (i.e., it is free of any other rail). The rail 144 is disposed in a central region of the track-engaging assembly 124. More particularly, in this embodiment, the rail 144 overlaps a centerline 185 of the track 121 (i.e., a line that bisects the width Wₜ of the track 121) in the widthwise direction of the track system 16. In this example, the sliding surface 177 overlaps the centerline 185 of the track 121. Also, the rail 144, including the sliding surface 177, is aligned (i.e., overlaps) with the ski 28 of the ski system 14 in the widthwise direction of the snow bike 10. This is in contrast to a snowmobile's conventional track system which comprises a plurality of rails that are spaced apart from one another in the track system's widthwise direction such that they do not overlap a centerline of a track of the track system.

In some embodiments, as shown in FIGS. 34 to 38, in a cross-section of the track system 16 in the widthwise direction of the track system 16, the sliding surface 177 of the rail 144 and a bottom 155 of each of the roller wheels 128₁-128₆ between which the rail 144 is disposed may be aligned in the heightwise direction of the track system 16. The inner surface 132 of the track 121 in contact with the sliding surface 177 of the rail 144 and the bottom 155 of each of the roller wheels 128₁-128₆ is thus substantially even (i.e., flat) in the widthwise direction of the track 121.

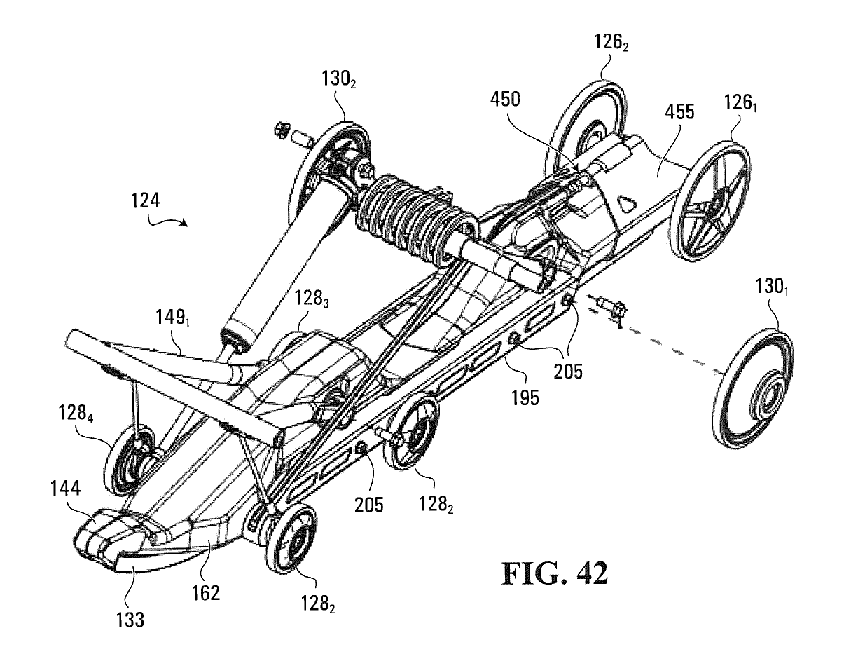

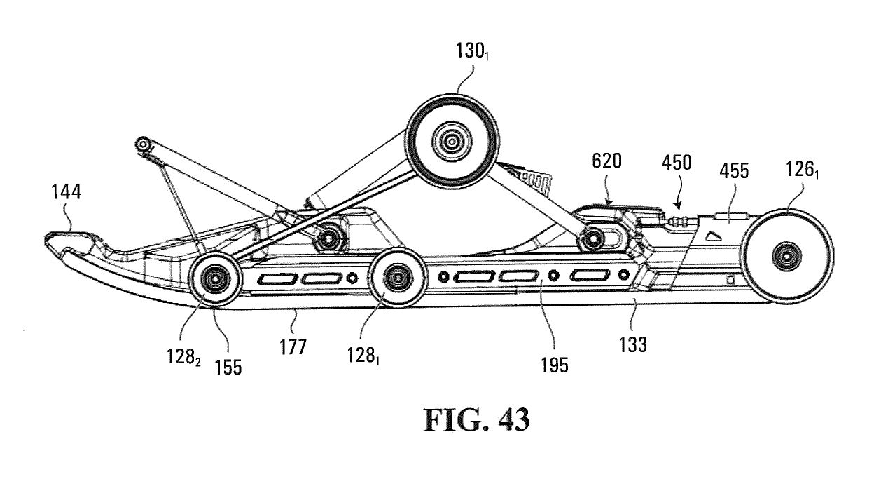

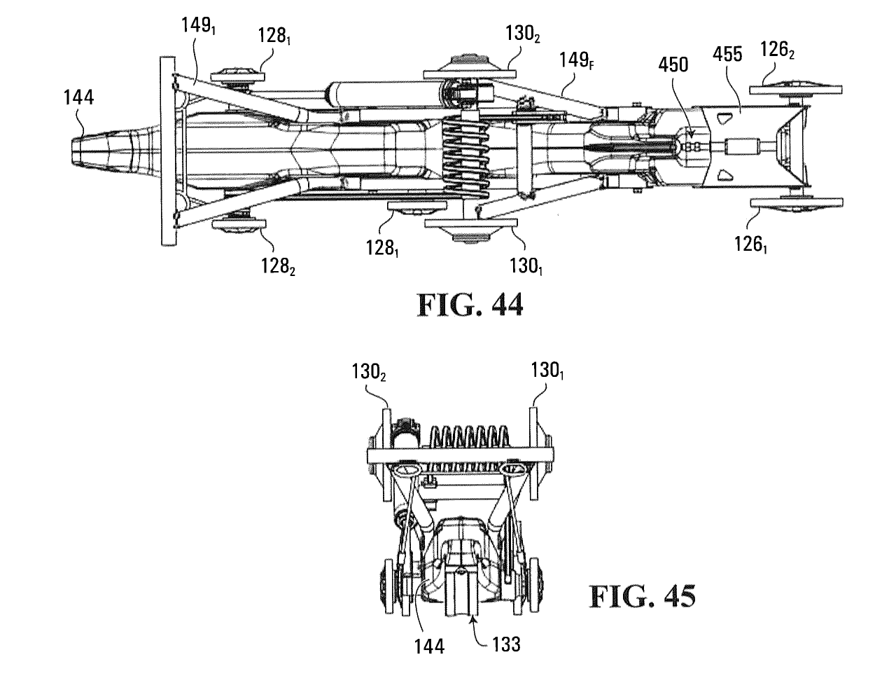

In other embodiments, as shown in FIGS. 42 to 47, in a cross-section of the track system 16 in the widthwise direction of the track system 16, the sliding surface 177 of the rail 144 and the bottom 155 of at least some of the roller wheels 128₁-128₄ between which the rail 144 is disposed may be offset in the heightwise direction of the track system 16 (in this example, the track-engaging assembly 124 comprises four roller wheels 128₁-128₄, but could comprise more or less such roller wheels in other examples). There is thus an offset Vᵣ between the sliding surface 177 of the rail 144 and the bottom 155 of some of the roller wheels 128₁-128₄ in the heightwise direction of the track system 16. The inner surface 132 of the track 121 in contact with the sliding surface 177 of the rail 144 and the bottom 155 of each of the roller wheels 128₁-128₄ is therefore uneven (i.e., not flat) in the widthwise direction of the track 121. This may help to facilitate transitioning of the snow bike 10 from its upright position towards its leaning position.

More particularly, in this embodiment, the bottom 155 of at least some of the roller wheels 128₁-128₄ is located higher than the sliding surface 177 of the rail 144 in the heightwise direction of the track system 16. The inner surface 132 of the track 121 in contact with the sliding surface 177 of the rail 144 and the bottom 155 of each of the roller wheels 128₁-128₄ is thus generally concave, curving or otherwise extending upwardly from the sliding surface 177 of the rail 144 towards the bottom 155 of each of the roller wheels 128₁-128₄.

The offset Vᵣ between the sliding surface 177 of the rail 144 and the bottom 155 of at least some of the roller wheels 128₁-128₄ may have any suitable value. For example, in some embodiments, a ratio Vᵣ/Hₜ of the offset Vᵣ between the sliding surface 177 of the rail 144 and the bottom 155 of at least some of the roller wheels 128₁-128₄ over a height Hₜ of the track system 16 may be at least 0.01, in some cases at least 0.02, in some cases at least 0.03, and in some cases even more. As another example, in some embodiments, a ratio Vᵣ/Dᵣ of the offset Vᵣ between the sliding surface 177 of the rail 144 and the bottom 155 of at least some of the roller wheels 128₁-128₄ over a diameter Dᵣ of a roller wheel 128; may be at least 0.05, in some cases at least 0.07, in some cases at least 0.09, in some cases at least 0.1 and in some cases even more.

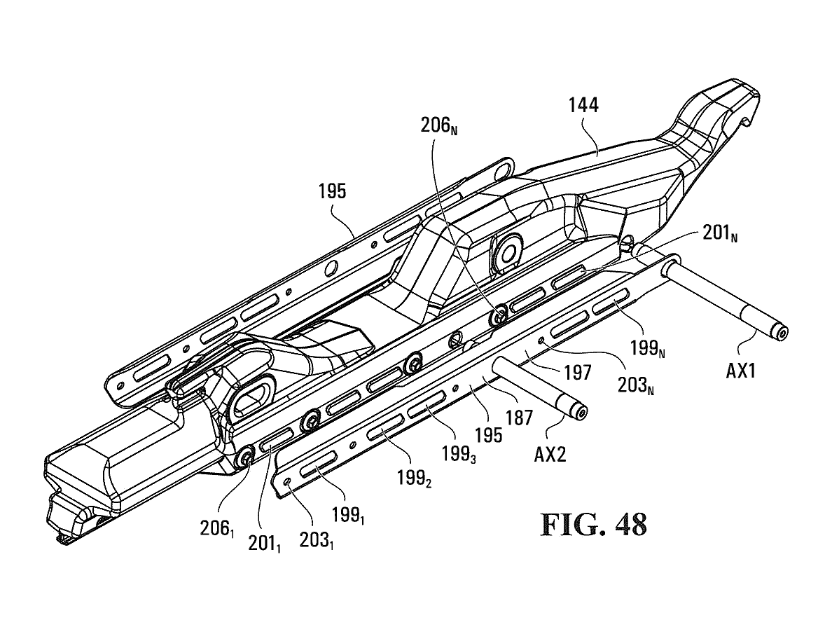

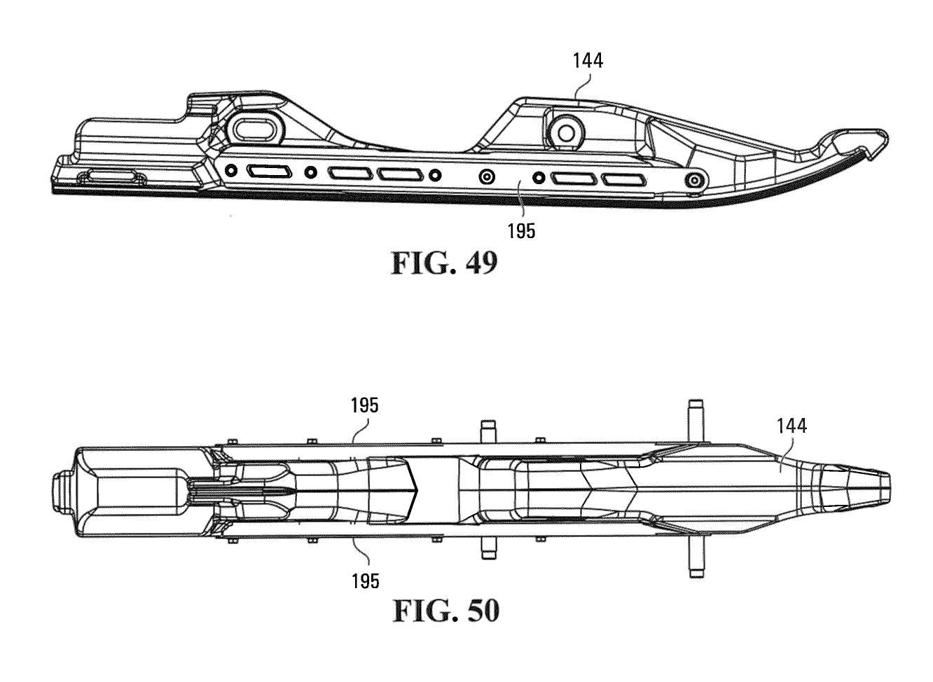

Furthermore, in the embodiment of FIGS. 42 to 50, the offset Vᵣ between the sliding surface 177 of the rail 144 and the bottom 155 of at least some of the roller wheels 128₁-128₄ is implemented by a selected pair of laterally-adjacent ones of the roller wheels 128₁-128₄ (roller wheels which are adjacent to one another in the widthwise direction of the track system 16). This selected pair of laterally-adjacent ones of the roller wheels roller wheels 128₁-128₄ may therefore not be used for relieving pressure on the sliding surface 177 of the rail 144, but rather to provide a limit to the leaning position of the vehicle 10 (e.g., when the vehicle 10 is turning). In this example, the selected pair of laterally-adjacent ones of the roller wheels 128₁-128₄ which implements the offset Vᵣ is the roller wheels 128₂, 128₄ which constitute a frontmost pair of the roller wheels 128₁-128₄ (i.e., a pair of the roller wheels which is closest to a frontmost point of the track system 16 in its longitudinal direction). The other roller wheels 128₁, 128₃ do no implement the offset Vᵣ such that the sliding surface 177 of the rail 144 and the bottom 155 of each of the roller wheels 128₁, 128₃ is generally aligned in the heightwise direction of the track system 16. Moreover, as shown in FIGS. 42, 44 and 45, in this embodiment, the roller wheels 128₂, 128₄ which implement the offset Vᵣ are spaced laterally from the rail 144 more than the remainder of the roller wheels 128₁-128₄ (i.e., more than the roller wheels 128₁, 128₃).

In other examples, more than a single pair of the roller wheels 128₁-128₄ may implement the offset Vᵣ. For instance, in cases where the track system 16 comprises more than four roller wheels (such as in the embodiment of FIGS. 34 to 38), two pairs of the roller wheels 128₁-128₆ may implement the offset Vᵣ.

Furthermore, in this embodiment, the offset Vᵣ between the sliding surface 177 of the rail 144 and the bottom 155 of at least some of the roller wheels 128₁-128₄ (i.e., the roller wheels 128₂, 128₄) is implemented by making the diameter Dᵣ of the at least some of the roller wheels 128₁-128₄ smaller than the diameter of the other roller wheels 128₁-128₄. More particularly, since an axle AX1 of the roller wheels 128₂, 128₄ is aligned with an axle AX2 of the roller wheels 128₁, 128₃ in the heightwise direction of the track system 16, making the diameter Dᵣ of the roller wheels 128₂, 128₄ smaller than the diameter of the roller wheels 128₁, 128₃, implements the offset Vᵣ between the sliding surface 177 of the rail 144 and the bottom 155 of the roller wheels 128₂, 128₄.

The offset Vᵣ between the sliding surface 177 of the rail 144 and the bottom 155 of the roller wheels 128₂, 128₄ may be implemented differently in other embodiments. For instance, in some embodiments, rather than making the diameter Dᵣ of the roller wheels 128₂, 128₄ smaller, the axle AX1 of the roller wheels 128₂, 128₄ may be supported at a point higher in the heightwise direction of the track system 16 than the axle AX2 of the roller wheels 128₁, 128₃, such that the axle AX1 of the roller wheels 128₂, 128₄ is not aligned with the axle AX2 in the heightwise direction of the track system 16.

The frame members 149₁-149_{F} extend upwardly from the elongate support 162 to hold the upper roller wheels 130₁, 130₂ such that the upper roller wheels 130₁, 130₂ roll on the inner side 125 of the track 121 along the top run 165 of the track 121.

The frame 123 of the track system 16, including the rail 144, may comprise any suitable material imparting strength to the frame 123. In some cases, a single material may make up an entirety of the frame 123. In other cases, different materials may make up different portions of the frame 123 (e.g., one material making up the rail 144, another material making up another part of the frame 123 above the rail 144).

In this embodiment, the frame 123 comprises a nonmetallic material 186 making up at least a significant part (e.g., at least a majority) of the frame 123, including the rail 144. More particularly, in this embodiment, the nonmetallic material 186 is a polymeric material. In some cases, the polymeric material 186 may include a single polymer. In other cases, the polymeric material 186 may include a combination of polymers. In yet other cases, the polymeric material 186 may include a polymer-matrix composite comprising a polymer matrix in which reinforcements are embedded (e.g., a fiber-reinforced polymer such as a carbon-fiber-reinforced polymer or glass-fiber-reinforced polymer). In this example of implementation, the polymeric material 186 includes high-density polyethylene (e.g., high molecular weight high-density polyethylene). Any other suitable polymer may be used in other examples of implementation (e.g., polypropylene, polyurethane, polycarbonate, low-density polyethylene, nylon, etc.).

In other embodiments, the frame 123 may comprise a metallic material (e.g., aluminum, steel, etc.) or any other suitable material making up at least a significant part (e.g., at least a majority) of the frame 123, including the rail 144.

The sliding surface 177 of the elongate support 162 is configured to slide on the inner side 125 of the track 121 along the bottom run 166 of the track 121 to guide the track 121 and apply it onto the ground. In this embodiment, the sliding surface 177 can slide against the inner surface 132 of the carcass 135 and can contact respective ones of the drive/guide lugs 134₁-134_{D} to guide the track 121 in motion. Also, in this embodiment, the sliding surface 177 is curved upwardly in a front region of the track system 16 to guide the track 121 towards the drive wheels 122₁, 122₂. In some cases, the track 121 may comprise slide members 139₁-139_{S} that slide against the sliding surface 177 to reduce friction. The slide members 139₁-139_{S}, which can sometimes be referred to as “clips”, may be mounted via holes 140₁-140_{H} of the track 121. In other cases, the track 121 may be free of such slide members. The sliding surface 177 may be arranged in other configurations in other embodiments.

In this embodiment, the elongate support 162 comprises a slider 133 mounted to the rail 144 and comprising the sliding surface 177. More particularly, in this embodiment, the slider 133 is mechanically interlocked with the rail 144. The slider 133 comprises an interlocking portion 178 that is interlockable with an interlocking portion 188 of the rail 144 in order to mechanically interlock the slider 133 and the rail 144. The interlocking portion 188 of the rail 144 and the interlocking portion 178 of the slider 133 are mechanically interlocked by a given one of the interlocking portion 188 of the rail 144 and the interlocking portion 178 of the slider 133 comprising an interlocking space (e.g., one or more holes, one or more recesses, and/or one or more other hollow areas) into which extends an interlocking part of the other one of the interlocking portion 188 of the rail 144 and the interlocking portion 178 of the slider 133.

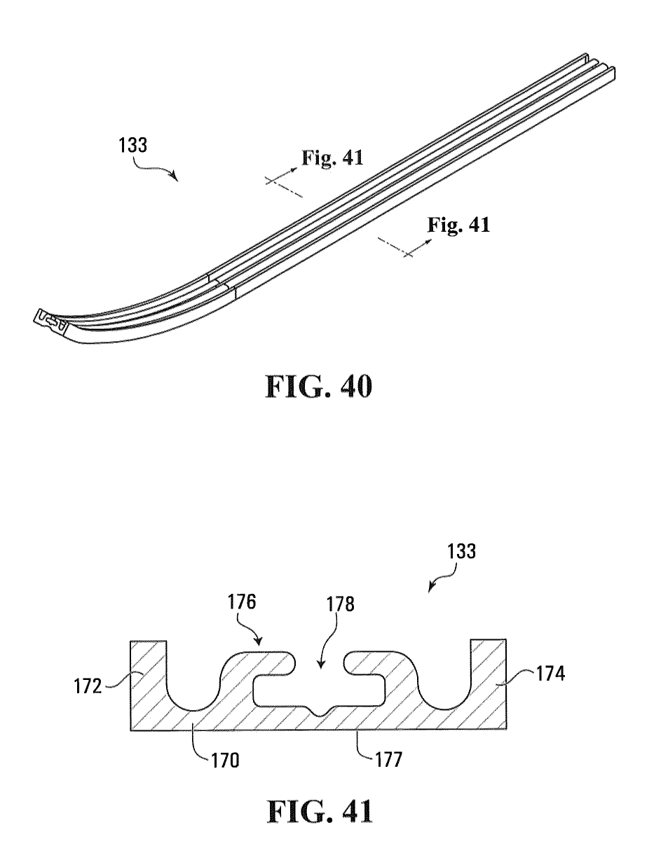

More particularly, with additional reference to FIGS. 40 and 41, in this embodiment, the slider 133 comprises a base 170 extending in the widthwise direction of the track system 16, a pair of projections 172, 174 that project upwardly from the base 170, and a mating portion 176 that is configured to mate with the rail 44 and defines the interlocking portion 178 of the slider 133. In this example, the interlocking portion 178 of the slider 133 comprises an aperture for receiving the interlocking portion 188 of the rail 144.

In other embodiments, instead of or in addition to being mechanically interlocked with the rail 144, the slider 133 may be fastened to the rail 144. For example, in some embodiments, the slider 133 may be fastened to the rail 144 by one or more mechanical fasteners (e.g., bolts, screws, etc.), by an adhesive, and/or by any other suitable fastener.

In some examples, the slider 133 may comprise a low-friction material which may reduce friction between its sliding surface 177 and the inner side 125 of the track 121. For instance, the slider 133 may comprise a polymeric material having a low coefficient of friction with the rubber of the track 121. For example, in some embodiments, the slider 133 may comprise a thermoplastic material (e.g., a Hifax® polypropylene). The slider 133 may comprise any other suitable material in other embodiments. For instance, in some embodiments, the sliding surface 177 of the slider 133 may comprise a coating (e.g., a polytetrafluoroethylene (PTFE) coating) that reduces friction between it and the inner side 125 of the track 121, while a remainder of the slider 133 may comprise any suitable material (e.g., a metallic material, another polymeric material, etc.).

While in embodiments considered above the sliding surface 177 is part of the slider 133 which is separate from and mounted to the rail 144, in other embodiments, the sliding surface 177 may be part of the rail 144. That is, the sliding surface 177 may be integrally formed (e.g., molded, cast, or machined) as part of the rail 144. For example, the sliding surface 177 may be part of the lower portion 163 of the rail 144.

In some embodiments, as shown in FIGS. 42, 43 and 48 to 50, the frame 123 may comprise an elongate reinforcement 195 that extends along at least part of the rail 144 and includes a reinforcing material 197 that is stiffer (i.e., more rigid) than the material 186 of the rail 144. This may lend reinforcement (e.g., rigidity) to the material 186 of the rail 144 such as to avoid overstressing the material 186 of the rail 144.

The material 197 of the elongate reinforcement 195 may be significantly stiffer than the material 186 of the rail 144. For instance, a ratio of a modulus of elasticity (i.e., Young's modulus) of the material 197 of the elongate reinforcement 195 over a modulus of elasticity of the material 186 of the rail 44 may be at least 1.5, in some cases at least 2, in some cases at least 5, in some cases at least 10, and in some cases even more.

In this embodiment, the material 197 of the elongate reinforcement 195 is metallic material. For instance, the metallic material 197 may be an alloy steel. Any other suitable metal may be used (e.g., a titanium alloy). In other embodiments, the material 197 of the elongate reinforcement 195 may be a polymeric material that is more rigid than the material 186 of the rail 44 (e.g., polyvinylchloride (PVC), polyethylene terephthalate (PET), a fiber-reinforced polymer).

In this embodiment, the elongate reinforcement 195 comprises a body 187 extending along the longitudinal direction of the vehicle 10 and a plurality of locating openings 199₁-199_{N} disposed in the body 187. The elongate reinforcement 195 extends along a substantial portion of a length of the rail 144. For instance, the elongate reinforcement 195 may extend along at least a majority (i.e., a majority or an entirety) of the length of the rail 144. The locating openings 199₁-199_{N} are configured to reduce a weight of the elongate reinforcement 195 since the material 197 may be denser than the material 186 of the rail 144. Moreover, the locating openings 199₁-199_{N} may allow to more easily locate the elongate reinforcement 195 relative to the rail 144 upon installing the elongate reinforcement 195. For instance, in this example of implementation, the rail 144 comprises a plurality of protrusions 201₁-201_{N} that have a shape (e.g., rounded rectangular) that matches a shape of the locating openings 199₁-199_{N} of the elongate reinforcement 195 such that a protrusion 201ᵢ of the plurality of protrusions 201₁-201_{N} can be inserted in a respective opening 199ᵢ of the elongate reinforcement 195.

The elongate reinforcement 195 also comprises axle-receiving openings for receiving respective axles of the lower roller wheels 128₁-128₄. The axle-receiving openings of the elongate reinforcement 195 are aligned with axle-receiving openings of the rail 144 such that the axles of the roller wheels (i.e., one axle for each pair of the lower roller wheels 128₁-128₄ that is aligned in the longitudinal direction of the track system 16) are received in the axle-receiving openings of the elongate reinforcement 195 and the axle-receiving openings of the rails 144. In this example, as there are two pairs of the lower roller wheels 128₁-128₄ that are aligned in the longitudinal direction of the track system 16, the elongate reinforcement 195 comprises two axle-receiving openings.

In order to secure the elongate reinforcement 195 to the rail 144, the elongate reinforcement also comprises a plurality of fastener-receiving openings 203₁-203_{N} for receiving a respective fastener 205 therein. More particularly, the fastener-receiving openings 203₁-203_{N} are through holes such that the fasteners 205 extend through the fastener-receiving openings 203₁-203_{N}. In such embodiments, the rail 144 comprises a plurality of fastener-engaging mounts 206₁-206_{N} for securedly engaging the fasteners 205. In this example, each of the fastener-engaging mounts 206₁-206_{N} comprises a threaded insert to threadedly engage a corresponding one of the fasteners 205.

In this embodiment, the frame 123 comprises two elongate reinforcements 195, one disposed on each lateral side of the rail 144. However, in some embodiments, the frame 123 may comprise a single elongate reinforcement 195.

Moreover, as shown in FIGS. 42 to 44, in this example of implementation, the track system 16 comprises a tensioner 450 for tensioning the track 121. For instance, in this embodiment, the tensioner 450 comprises an actuator mounted at one end of the frame 123 of the track system 16 and at another end to a member 455 which supports an axle of the rear idler wheels 126₁, 126₂. This allows the tensioner 450 to modify a distance between the rear idler wheels 126₁, 126₂ and the roller wheels 128₁-128₄ in the longitudinal direction of the track system 16. A similar tensioner could be implemented in the embodiment of the track system 16 depicted in FIGS. 34 to 38.

The track system 16 facilitates transitioning of the vehicle 10 from its upright position to its leaning position when banked.

For example, in this embodiment, the single-rail suspension implemented by the rail 144 makes it easier to transition to the leaning position of the vehicle 10.

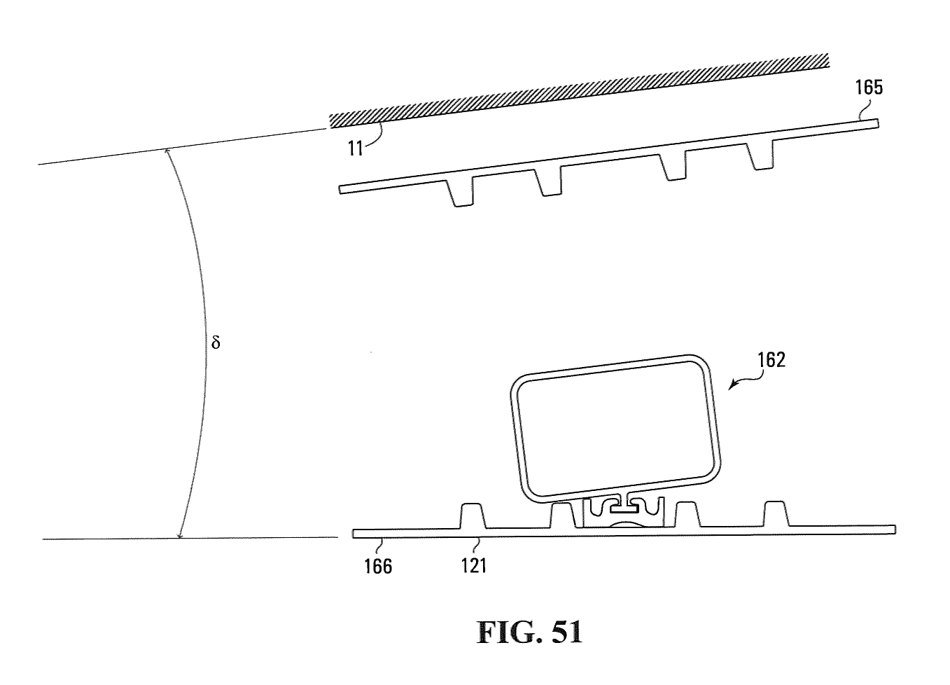

Also, in this embodiment, as shown in FIG. 51, the bottom run 166 of the track 121 is movable relative to the frame 11 of the vehicle 10 in the heightwise direction of the vehicle 10 to facilitate transitioning to the leaning position of the vehicle 10. An orientation of part of the bottom run 166 of the track 121 is changeable relative to the frame 11 of the vehicle 10. The track system 16 may allow a leaning angle δ of the bottom run 166 of the track 121 that may be relatively significant. For example, in some embodiments, the leaning angle δ may be at least 10°, in some cases at least 20°, in some cases at least 25°, in some cases at least 30°, and in some cases even more (e.g., 40°).

Movement of the bottom run 166 of the track 121 relative to the frame 11 of the vehicle 10 when the vehicle 10 is leaning may be implemented by a lower part 190 of the track-engaging assembly 124 which comprises an interface 192 of the track-engaging assembly 124 with the bottom run 166 of the track 121. The interface 192 of the track-engaging assembly 124 with the bottom run 166 of the track 121 comprises surfaces of the track-engaging assembly 124 that are in contact with the bottom run 166 of the track 121, including, in this embodiment, a circumferential surface 194 of each of the idler wheels 126₁, 126₂, 128₁-28₆ and the sliding surface 177 of the elongate support 162.

The track system 16 is configured such that, when the snow bike 10 travels on the ground, at least part of the interface 192 of the track-engaging assembly 124 with the bottom run 166 of the track 121 is movable relative to the frame 11 of the snow bike 10 to change an orientation of one or more of the surfaces of the track-engaging assembly 124 that are in contact with the bottom run 166 of the track 121 (i.e., the circumferential surface 194 of each of the idler wheels 126₁, 126₂, 128₁-128₆ and the sliding surface 177 of the elongate support 162) relative to the frame 11 of the snow bike 10.

More particularly, in this embodiment, the track system 16 is configured such that, when the snow bike 10 travels on the ground, one or more of the surfaces of the track-engaging assembly 124 that are in contact with the bottom run 166 of the track 121 (i.e., the circumferential surface 194 of each of the idler wheels 126₁, 126₂, 128₁-128₆ and the sliding surface 177 of the elongate support 162) are rotatable relative to the frame 11 of the snow bike 10 about a roll axis R_{A} substantially parallel to the longitudinal direction of the track system 16. That is, a surface of the track-engaging assembly 124 that is in contact with the bottom run 166 of the track 121 is movable relative to the frame 11 of the snow bike 10 such that movement of that surface of the track-engaging assembly 124 relative to the frame 11 of the snow bike 10 includes a rotation of that surface of the track-engaging assembly 124 relative to the frame 11 of the snow bike 10 about the roll axis R_{A}.

This is achieved, in this embodiment, by the track system 16 being configured such that, when the snow bike 10 travels on the ground, an upper part 191 of the track-engaging assembly 124 is movable relative to the lower part 190 of the track-engaging assembly 124 to change an orientation of the upper part 191 of the track-engaging assembly 124 relative to the lower part 190 of the track engaging assembly 124. In this example, the upper part 191 of the track-engaging assembly 124 is rotatable relative to the lower part 190 of the track-engaging assembly 124 about the roll axis R_{A}. That is, the upper part 191 of the track-engaging assembly 124 is movable relative to the lower part 190 of the track-engaging assembly 124 such that movement of the upper part 191 of the track-engaging assembly 124 relative to the lower part 190 of the track-engaging assembly 124 includes a rotation of the upper part 191 of the track-engaging assembly 124 relative to the lower part 190 of the track-engaging assembly 124 about the roll axis R_{A}.

Notably, in this embodiment, the track system 16 is configured such that, when the snow vehicle 10 travels on the ground, the sliding surface 177 of the elongate support 162 is movable relative to the frame 11 of the snow vehicle 10 to change an orientation of the sliding surface 177 relative to the frame 11 of the snow vehicle 10. Thus, in this example, the sliding surface 177 is rotatable relative to the frame 11 of the snow vehicle 10 about the roll axis R_{A}. That is, the sliding surface 177 is movable relative to the frame 11 of the snow vehicle 10 such that movement of the sliding surface 177 relative to the frame 11 of the snow vehicle 10 includes a rotation of the sliding surface 177 relative to the frame 11 of the snow vehicle 10 about the roll axis R_{A}.

In this embodiment, the track system 16 is configured such that, when the snow vehicle 10 travels on the ground, the upper portion 161 of the rail 144 is movable relative to the sliding surface 177 to change an orientation of the upper portion 161 of the rail 144 relative to the sliding surface 177. Thus, in this example, the upper portion 161 of the rail 144 is rotatable relative to the sliding surface 177 about the roll axis R_{A}. That is, the upper portion 161 of the rail 144 is movable relative to the sliding surface 177 such that movement of the upper portion 161 of the rail 144 relative to the sliding surface 177 includes a rotation of the upper portion 161 of the rail 144 relative to the sliding surface 177 about the roll axis R_{A}.

Movement of the upper portion 161 of the rail 144 relative to the sliding surface 177 may be implemented in any suitable way.

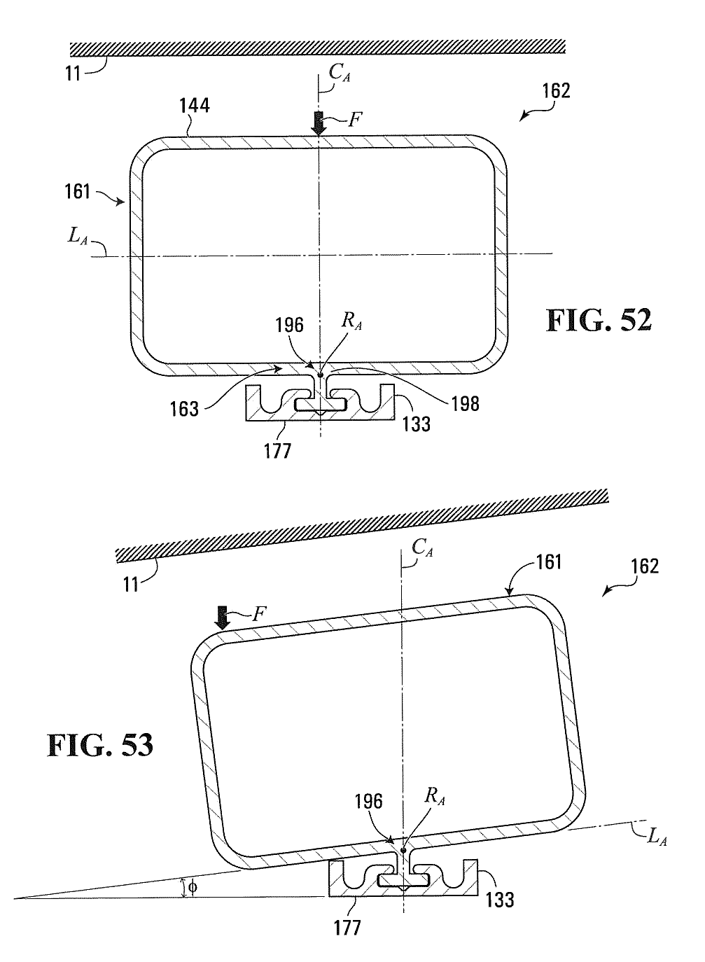

For example, in some embodiments, as shown in FIGS. 52 and 53, the track-engaging assembly 124 comprises a resiliently deformable area 196 that is resiliently deformable to allow movement of the upper part 191 of the track-engaging assembly 124 relative to the lower part 190 of the track-engaging assembly 124.

More particularly, in this embodiment, the lower portion 163 of the rail 144 is resiliently deformable to allow movement of the upper portion 161 of the rail 144 relative to the sliding surface 177. The resiliently deformable area 196 is thus part of the lower portion 163 of the rail 144 in this example.

The resiliently deformable area 196 may be implemented in various ways. For instance, the resiliently deformable area 196 may have a relatively low stiffness. More specifically, in this embodiment, the stiffness of the lower portion 163 of the rail 144 may be less than a stiffness of the upper portion 161 of the rail 144 (i.e., the lower portion 163 of the rail 144 is more flexible than the upper portion 161 of the rail 144).

In this embodiment, the lower portion 163 of the rail 144 comprises a resilient material 198 which provides compliance to the lower portion 163 of the rail 144. In this case, the resilient material 198 is the polymeric material 186 making up the rail 144, including the lower portion 63 of the rail 44. More specifically, the resilient material 198 of the lower portion 163 of the rail 144 is operable to deform from a first configuration to a second configuration in response to a load and recover the first configuration in response to removal of the load.

More particularly, in this embodiment, a modulus of elasticity (i.e., Young's modulus) of the resilient material 198 may be no more than 10 GPa, in some cases no more than 5 GPa, in some cases no more than 1 GPa, and in some cases even less (e.g., no more than 0.5 GPa). The modulus of elasticity of the resilient material 198 may have any other suitable value in other embodiments.

For instance, in some examples, the stiffness of the lower portion 163 of the rail 144 may be calculated, based on a minimal cross-section of the lower portion 163 of the rail 144 taken parallel to the longitudinal direction of the track system, as a product of (i) the modulus of elasticity of the material 198 of the lower portion 163 of the rail 144 at that minimal cross-section and (i) an area moment of inertia (i.e., a second moment of area) of the minimal cross-section of the lower portion 163 of the rail 144 with respect to an axis parallel to the longitudinal direction of the track system. For example, in some embodiments, the stiffness of the lower portion 163 of the rail 144 may be no more than 1.0E4 GPa/mm⁴, in some cases no more than 5.0E3 GPa/mm⁴, in some cases no more than 1.0E3 GPa/mm⁴, and in some cases even less (e.g., no more than 5.0E2 GPa/mm⁴). The stiffness of the lower portion 163 of the rail 144 may have any other suitable value in other embodiments.

In this embodiment, the rail 144 is a hollow structure. That is, the rail 144 comprises a hollow interior 168. More particularly, in this embodiment, the hollow interior 168 occupies a majority of a volume of the rail 144. The hollow interior 168 therefore occupies at least 50%, in some cases at least 65%, in some cases at least 80%, and in some cases an even greater proportion (e.g., at least 90% or 95%) of the volume of the rail 144. In other embodiments, the hollow interior 168 may occupy a smaller proportion of the volume of the rail 144. This hollowness of the rail 144 may help to facilitate resilient deformation of the rail 144 for movement of the upper portion 161 of the rail 144 relative to the sliding surface 177 as well as to reduce a weight of the track system 16. In this case, as further discussed later, the hollowness of the rail 144 is created during molding of the rail 144.

The hollow interior 168 is defined by a wall 153 of the rail 144. In this embodiment, the wall 153 encloses the hollow interior 168 such that the hollow interior 168 is closed. This prevents mud, rocks, debris and/or other undesirable ground matter from entering into the hollow interior 168 of the rail 144.

The wall 153 has a thickness suitable for providing sufficient rigidity to the rail 144. This depends on the material 186 making up the rail 144 and on loads to which the rail 144 is expected to be subjected to. For example, in some embodiments, the thickness of the wall 153 may be at least 1 mm, in some cases at least 3 mm, in some cases at least 5 mm, and in some cases at least 8 mm. For instance, in this example of implementation in which the wall 153 includes high-density polyethylene, the thickness of the wall 153 may be between 2 mm and 8 mm. In cases in which the thickness of the wall 153 varies such that it takes on different values in different regions of the rail 144, the thickness of the wall 153 may be taken as its minimum thickness. In other cases, the thickness of the wall 153 may be generally constant over an entirety of the rail 144.

The rail 144 may be manufactured in any suitable manner. In this embodiment, the rail 144 is molded into shape in a mold such that it is a molded structure. In particular, in this case, the hollowness and the upper and lower portions 161, 163 of the rail 144 are realized during molding of the rail 144.

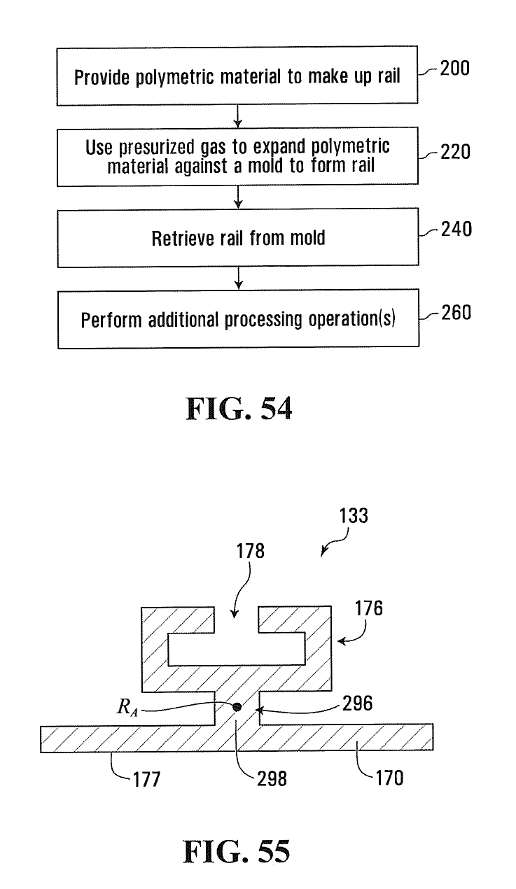

More specifically, in this embodiment, the rail 144 is blow-molded into shape such that it is a blow-molded structure. For instance, FIG. 54 is a flowchart illustrating an example of a blow-molding process used to mold the rail 144.

At step 200, the polymeric material 186 that will make up the rail 144 is provided. For instance, in some cases, the polymeric material 186 may be provided as a preform (also sometimes called “parison”), which is essentially a hot hollow tube of polymeric material. In other cases, the polymeric material 186 may be provided as one or more hot sheets.

At step 220, pressurized gas (e.g., compressed air) is used to expand the polymeric material 186 against a mold. The mold has an internal shape generally corresponding to the shape of the rail 144 such that, as it is expanded against the mold, the polymeric material 186 is shaped into the rail 144. In this embodiment, this creates a shape of the rail 144, including its hollow interior space 168. Pressure is held until the polymeric material 186 cools and hardens.

At step 240, once the polymeric material 186 has cooled and hardened, the rail 144 is retrieved from the mold.

At optional step 260, one or more additional operations (e.g., trimming) may be performed on the rail 144 which has been molded.

The rail 144 is thus constructed in this embodiment to enhance the performance of the track system 16. For example, owing to its polymeric material 186 that provides compliance and to its configuration, the resiliently deformable area 196 of the lower portion 163 of the rail 144 allows for movement of the upper portion 161 of the rail 144 relative to the sliding surface 177 when the snow bike 10 travels. Also, due to the hollowness of the rail 144, the frame 123 may be voluminous yet lightweight, thus helping to contain the weight of the track system 16. As another example, by being voluminous, the rail 144 occupies space within the track system 16 which would otherwise be available for unwanted ground matter (i.e., snow, ice and/or other debris) to accumulate in, and, therefore, helps to reduce a potential for unwanted ground matter accumulation in the track system 16.

Although it is configured in a certain manner in this embodiment, the rail 144 may be configured in various other manners in other embodiments.

For example, while the rail 144 has a certain shape in this embodiment, the rail 144 may have any other suitable shape in other embodiments.

As another example, although in this embodiment the rail 144 is blow-molded, in other embodiments, the rail 144 may be manufactured using other manufacturing processes. For example, in some embodiments, the rail 144 may be manufactured by a rotational molding (sometimes also referred to as “rotomolding”) process in which a heated mold is filled with material and then rotated (e.g., about two perpendicular axes) to cause the material to disperse and stick to a wall of the mold. As another example, in some embodiments, the rail 144 may be manufactured by individually forming two or more pieces and then assembling these pieces together (e.g., individually forming two halves of the rail 144 and then assembling these two halves together; individually forming the upper and lower portions 161, 163 of the rail 144 and then assembling these pieces together; etc.). Such individual forming of two or more pieces may be effected by individually molding (e.g., by an injection or other molding process), extruding, or otherwise forming these two or more pieces. Such assembling may be effected by welding (e.g., sonic welding), adhesive bonding, using one or more fasteners (e.g., bolts, screws, nails, etc.), or any other suitable technique.

In this embodiment, the resiliently deformable area 196 defines the roll axis R_{A} about which the upper portion 161 of the rail 144 is rotatable relative to the sliding surface 177 of the elongate support 162. In other words, the upper portion 161 of the rail 144 is rotatable about the resiliently deformable area 196 and more specifically about the roll axis R_{A} which is substantially parallel to the longitudinal direction of the track system 16. The weight of the track system 16 is generally balanced in its widthwise direction about a central axis C_{A} bisecting a width of the rail 144 and extending through the roll axis R_{A} such that the central axis C_{A} is normal to the sliding surface 177 of the elongate support 162.

More particularly, in this embodiment, the rail 144 is operable to resiliently deform from a neutral configuration to a biased configuration and vice-versa. More specifically, with additional reference to FIG. 52, the rail 144 adopts the neutral configuration when the track system 16 is unloaded (i.e., when the rail 144 is not subjected to any load external to the track system 16) or centrally-loaded (i.e., the rail 144 is subjected to a net load F external to the track system 16 that is generally aligned with the central axis C_{A}). For example, the rail 144 may adopt the neutral configuration when a center of gravity of the user of the snow bike 10 is generally aligned with respect to the central axis C_{A} (e.g., when the user is sitting up straight on the seat 18 of the snow bike 10).

In the neutral configuration of the rail 144, a lateral axis L_{A} of the upper portion 161 of the rail 144 (i.e., an axis extending in a widthwise direction of the upper portion 161 of the rail 144) is generally orthogonal to the central axis C_{A} of the rail 144. In other words, in the neutral configuration, the lateral axis L_{A} is substantially parallel to the sliding surface 177 of the elongate support 162.

As shown in FIG. 53, the rail 144 transitions to the biased configuration in response to the net load F being offset from the central axis C_{A} of the rail 144. More specifically, as the net load F is offset from the central axis C_{A}, a bending moment is generated at the roll axis R_{A} which causes the rail 144 to deform and adopt the biased configuration. For example, the rail 144 may adopt the biased configuration when the center of gravity of the user is offset from the central axis C_{A} (e.g., when the user is leaning towards a lateral side of the snow vehicle 10).

When the rail 144 transitions to the biased configuration, the orientation of the upper portion 161 of the rail 144 is changed relative to the sliding surface 177 of the elongate support 162. More specifically, the rail 144 transitions to the biased configuration through a rotation of the upper portion 161 of the rail 144 relative to the sliding surface 177 about the roll axis R_{A} by a roll angle ϕ (e.g., measured between the sliding surface 177 and the lateral axis L_{A} of the upper portion 161 of the rail 144). The roll angle ϕ may depend on the magnitude of the net load F and its distance from the central axis C_{A} of the rail 144 amongst other factors (e.g., elasticity of the resilient material 198 of the deformable area 196). For example, in some embodiments, the roll angle ϕ may be at least 5°, in some cases at least 10°, in some cases at least 15°, in some cases at least 20°, in some cases at least 25°, and in some cases even more.

The rotational motion of the upper portion 161 of the rail 144 about the roll axis R_{A} may enable the sliding surface 177 to substantially remain in contact with the inner side 125 of the track 121 to apply the bottom run 166 of the track 121 onto the ground on which the snow vehicle 10 travels. This may enhance traction between the track 121 and the ground.

Once the net load F is substantially aligned with the central axis C_{A} of the rail 144 (or the rail 144 is no longer subjected to the net load F), the rail 144 transitions from the biased configuration to the neutral configuration. That is, the upper portion 161 of the rail 144 rotates about the roll axis R_{A} such that the lateral axis L_{A} of the upper portion 161 of the rail 144 is substantially parallel with the sliding surface 177.

Although the rail 144 is illustrated as being biased towards one lateral side of the track system 16, it will be appreciated that the rail 144 may be biased towards an opposite lateral side of the track system 16 when the net load F is applied on an opposite side of the central axis C_{A}. Moreover, although the net load F is depicted in the drawings as being applied at a location within a widthwise extent of the rail 144, this is merely to simplify the illustrations. In many cases, the net load F may be applied at a location in the widthwise direction of the track system 16 beyond the widthwise extent of the rail 144.

The upper portion 161 of the rail 144 may be configured to move relative to the sliding surface 177 of the elongate support 162 in any other suitable way in other embodiments.

For instance, in some embodiments, the slider 133 of the elongate support 162 may be configured to resiliently deform rather than the rail 144. More specifically, with additional reference to FIGS. 55 to 57, the slider 133 of the elongate support 162 may comprise a resiliently deformable area 296 that is resiliently deformable to allow movement of the mating portion 176 of the slider 133 relative to the base 170 of the slider 133. In view of its mating engagement with the rail 144, the resiliently deformable slider 133 allows movement of the rail 144, including the upper portion 161 of the rail 144, relative to the sliding surface 177 of the slider 133.

The resiliently deformable area 296 of the slider 133 may be implemented in any suitable way, including in a manner similar to that described above in respect of the resiliently deformable area 296 of the rail 144. For instance, the resiliently deformable area 296 may have a relatively low stiffness. More specifically, in some embodiments, the stiffness of the slider 133 may be less than the stiffness of the upper portion 161 of the rail 144 (i.e., the slider 133 may be more flexible than the upper portion 161 of the rail 144). For example, in some embodiments, the stiffness of the slider 133 may be no more than 1.0E4 GPa/mm⁴, in some cases no more than 5.0E3 GPa/mm⁴, in some cases no more than 1.0E3 GPa/mm⁴, and in some cases even less (e.g., no more than 5.0E2 GPa/mm⁴). The stiffness of the slider 133 may have any other suitable value in other embodiments.

More particularly, in this embodiment, the slider 133 comprises a resilient material 298 which provides compliance to the slider 133. More specifically, the resilient material 298 of the slider 133 is operable to deform from a first configuration to a second configuration in response to a load and recover the first configuration in response to removal of the load. For instance, in some embodiments, a modulus of elasticity of the resilient material 298 may be smaller than the modulus of elasticity of the polymeric material 186 of the rail 144. For example, in some embodiments, a modulus of elasticity of the resilient material 298 may no more than 10 GPa, in some cases no more than 5 GPa, in some cases no more than 1 GPa, and in some cases even less (e.g., no more than 0.5 GPa). The modulus of elasticity of the resilient material 298 may have any other suitable value in other embodiments.

In this example of implementation, the resilient material 298 of the slider 133 comprises a polymeric material. For instance, the resilient material 298 of the slider 133 may be a thermoplastic material (e.g., a Hifax® polypropylene). The resilient material 298 of the slider 133 may be any other suitable material in other examples of implementation.

In this embodiment, the resiliently deformable area 296 of the slider 133 defines the roll axis R_{A} about which the mating portion 176 of the slider 133, and consequently the upper portion 161 of the rail 144, is rotatable. In other words, the upper portion 161 of the rail 144 is rotatable about the resiliently deformable area 296 and more specifically about the roll axis R_{A} which is substantially parallel to the longitudinal direction of the track system 16. The weight of the track system 16 is generally balanced in its widthwise direction about the central axis C_{A} bisecting the width of the rail 144 and extending through the roll axis R_{A} such that the central axis C_{A} is normal to the sliding surface 177 of elongate support 162.

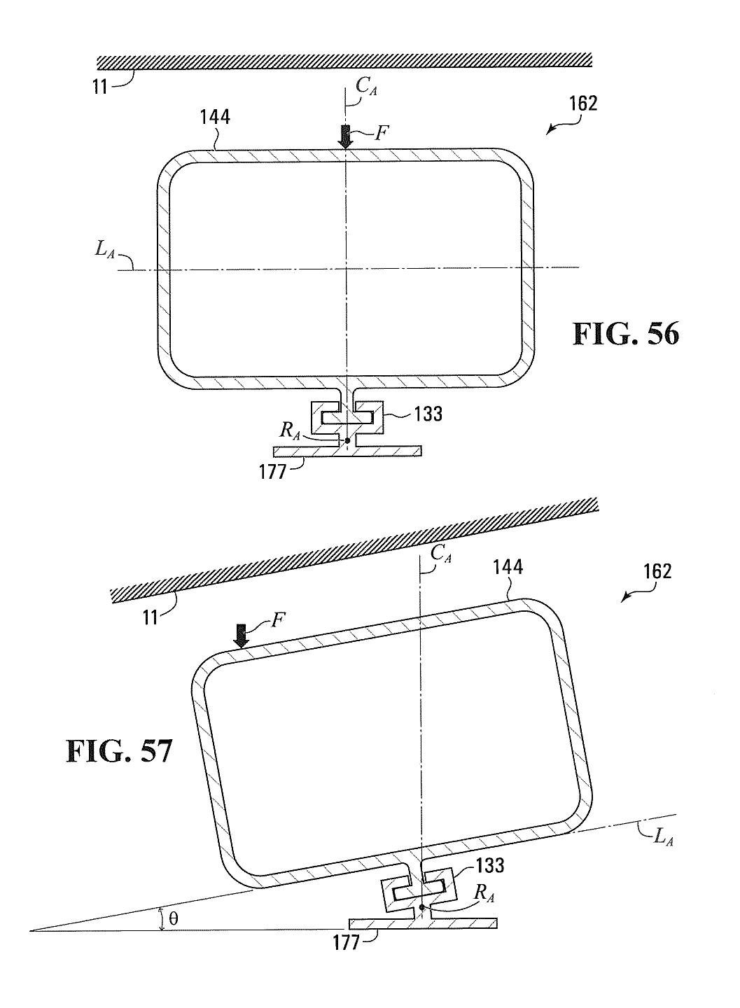

In this embodiment, the slider 133 is operable to resiliently deform from a neutral configuration to a biased configuration and vice-versa. As shown in FIG. 56, the slider 133 adopts the neutral configuration when the track system 16 is unloaded (i.e., the slider 133 is not subjected to any load external to the track system 16) or centrally-loaded (i.e., the slider 133 is subjected to the net load F that is generally aligned with the central axis C_{A} of the rail 144). In the neutral configuration of the slider 133, the rail 144 is in a first position in which the lateral axis L_{A} of its upper portion 161 is substantially parallel with the sliding surface 177 of the slider 133.

With additional reference to FIG. 57, the slider 133 transitions to the biased configuration in response to the net load F being offset from the central axis C_{A} of the rail 144. More specifically, as the net load F is offset from the central axis C_{A}, a bending moment is generated at the roll axis R_{A} which causes the slider 133 to deform and adopt the biased configuration.

When the slider 133 transitions to the biased configuration, the rail 144 (which is mateably engaged with the slider 133) is moved to a second position. More specifically, the rail 144, including the upper portion 161 of the rail 144, is rotated about the roll axis R_{A} relative to the sliding surface 177 by a roll angle θ (e.g., measured from the sliding surface 177 of the slider 133 to the lateral axis L_{A} of the rail 144). For example, in some embodiments, the roll angle θ may be at least 5°, in some cases at least 10°, in some cases at least 15°, in some cases at least 20°, in some cases at least 25°, and in some cases even more.

The rotational motion of the upper portion 161 of the rail 144 about the roll axis R_{A} may allow the slider 133 and its sliding surface 177 to substantially remain in place to apply the bottom run 166 of the track 121 onto the ground on which the snow vehicle 10 travels. This may enhance traction between the track 121 and the ground.

Once the net load F is aligned with the central axis C_{A} of the slider 133 (or the slider 133 is no longer subjected to the net load F), the slider 133 again transitions from the biased configuration to the neutral configuration which causes the rail 144 to transition from the second position back to the first position. Although the slider 133 is illustrated as being biased towards one lateral side of the track system 16, it will be appreciated that the slider 133 may be biased towards an opposite lateral side of the track system 16 when the net load F is applied on an opposite side of the central axis C_{A}.

In some embodiments, the rail 144 may not be resiliently deformable since, through its compliance, the slider 133 causes the rail 144 to rotate about the roll axis R_{A}. Thus, in this embodiment, the rail 144 may comprise a non-resilient material, including metallic material, polymeric material, or any other suitable material. Moreover, the rail 144 may be manufactured in any suitable way.

In other embodiments, both the rail 144 and the slider 133 may be resiliently deformable (i.e., both the resiliently deformable area 196 of the rail 144 and the resiliently deformable area 296 of the slider 133 may be provided) so that the movement of the upper portion 161 of the rail 144 relative to the sliding surface 177 involves resilient deformations of the rail 144 and the slider 133.

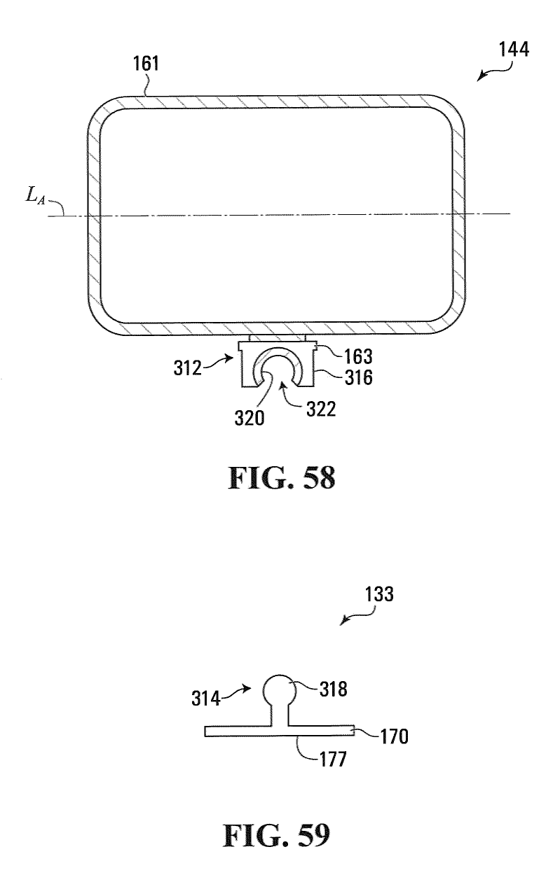

In other embodiments, as shown in FIGS. 58 to 61, the track-engaging assembly 124 comprises a movable mechanical joint 300 between the upper part 191 of the track-engaging assembly 124 and the lower part 190 of the track-engaging assembly 124 to allow movement of the upper part 191 of the track-engaging assembly 124 relative to the lower part 190 of the track-engaging assembly 124.

More particularly, in this embodiment, the movable mechanical joint 300 is between the upper portion 161 of the rail 144 and the sliding surface 177 to allow movement of the upper portion 161 of the rail 144 relative to the sliding surface 177. In this example, the movable mechanical joint 300 is between the rail 144 and the slider 133.

In this embodiment, the movable mechanical joint 300 comprises a pivot 310 to allow pivoting of the upper portion 161 of the rail 144 relative to the sliding surface 177.

The pivot 310 may be implemented in any suitable way. For instance, in this embodiment, the pivot 310 comprises a connection between the lower portion 163 of the rail 144 and the slider 133. More particularly, in this embodiment, the lower portion 163 of the rail 144 comprises a first engaging member 312 that is configured to engage a second engaging member 314 of the slider 133 such that the first engaging member 312 is movable relative to the second engaging member 314. The connection between the first and second engaging members 312, 314 defines the roll axis R_{A} about which the upper portion 161 of the rail 144 is pivotable.

As shown in FIGS. 58 and 59, in this embodiment, the first engaging member 312 comprises a housing 316 and the second engaging member 314 comprises a circular stud 318, the housing 316 being configured to receive the circular stud 318. The housing 316 of the first engaging member 312 comprises a bearing 320 (e.g., a polymer bearing) defining a cavity 322 configured to securely receive the circular stud 318. The circular stud 318 is thus rotatable within the cavity 322 against the bearing 320.

In this embodiment, the roll axis R_{A} is located at a center of the circular stud 318 and is substantially parallel to the longitudinal direction of the track system 16. A central axis C_{A}′ of the pivot 310 extends through the roll axis R_{A} and is normal to the sliding surface 177 of the slider 133.

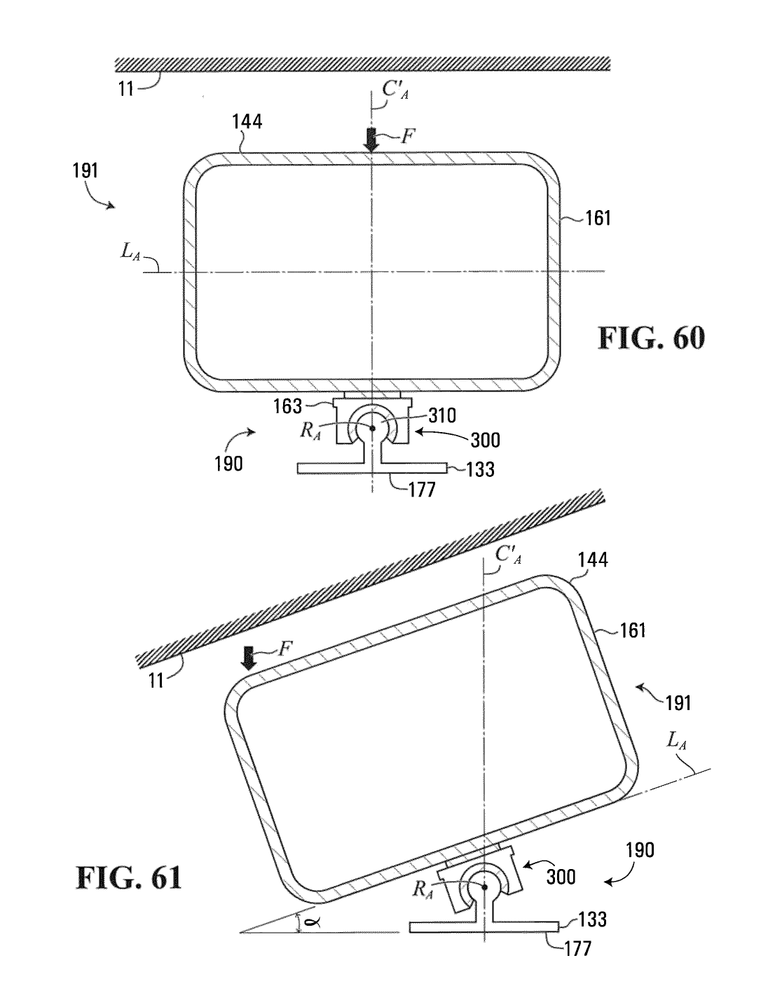

The upper portion 161 of the rail 144 is rotatable from a neutral position to an inclined position and vice-versa. More specifically, with additional reference to FIG. 60, the upper portion 161 of the rail 144 adopts the neutral position when the track system 16 is centrally-loaded (i.e., the rail 144 is subjected to a net load F external to the track system 16 that is generally aligned with the central axis C_{A}′). For example, the upper portion 161 of the rail 144 is in the neutral position when a center of gravity of the user of the snow vehicle 10 is generally aligned with respect to the central axis C_{A}′ (e.g., when the user is sitting up straight on the seat 18 of the snow vehicle 10).

In the neutral position, the lateral axis L_{A} of the upper portion 161 of the rail 144 is generally orthogonal to the central axis C_{A}′. In other words, in the neutral position, the lateral axis L_{A} is substantially parallel to the sliding surface 177 of the slider 133.

As shown in FIG. 61, the upper portion 161 of the rail 144 transitions to the inclined position in response to the net load F being offset from the central axis C_{A}′. More specifically, as the net load F is offset from the central axis C_{A}′, a moment is generated at the roll axis R_{A} which causes the upper portion 161 of the rail 144 to move to the inclined position. For example, the upper portion 161 of the rail 144 may adopt the inclined position when the center of gravity of the user is offset from the central axis C_{A}′ (e.g., when the user is leaning towards the side of the snow vehicle 10).

When the upper portion 161 of the rail 144 moves to the inclined position, the orientation of the upper portion 161 of the rail 144 is changed relative to the sliding surface 177 of the elongate support 162. More specifically, the upper portion 161 of the rail 144 transitions to the inclined position through a rotation of the upper portion 161 of the rail 144 relative to the sliding surface 177 about the roll axis R_{A} by a roll angle α (e.g., measured from the sliding surface 177 of the slider 133 to the lateral axis L_{A} of the upper portion 161 of the rail 144). The roll angle α may depend on the magnitude of the net load F and its distance from the central axis C_{A}′ amongst other factors. For example, in some embodiments, the roll angle α may be at least 5°, in some cases at least 10°, in some cases at least 15°, in some cases at least 20°, in some cases at least 25°, and in some cases even more.

The rotational motion of the upper portion 161 of the rail 144 about the roll axis R_{A} may enable the slider 133 and its sliding surface 177 to substantially remain in contact with the inner side 125 of the track 121 to apply the bottom run 166 of the track 121 onto the ground matter on which the snow vehicle 10 travels. This may enhance traction between the track 121 and the ground.

Once the net load F is substantially aligned with the central axis C_{A}′, the upper portion 161 of the rail 144 moves from the inclined position to the neutral position. That is, the upper portion 161 of the rail 144 rotates about the roll axis R_{A} such that the lateral axis L_{A} of the rail 144 substantially parallel with the sliding surface 177 of the slider 133.

Although the upper portion 161 of the rail 144 is illustrated as being moved towards one lateral side of the track system 16, it will be appreciated that the upper portion 161 of the rail 144 may be moved towards an opposite lateral side of the track system 16 when the net load F is applied on an opposite side of the central axis C_{A}′. Moreover, although the net load F is depicted in the drawings as being applied at a location within a widthwise extent of the rail 144, this is merely to simplify the illustrations. In many cases, the net load F may be applied at a location in the widthwise direction of the track system 16 beyond the widthwise extent of the rail 144.

In this embodiment, the rail 144 and the slider 133 may comprise any suitable material (e.g., metallic material, polymeric material, etc.) since neither the rail 144 nor the slider 133 needs to be resiliently deformable. In some embodiments, the rail 144 and/or the slider 133 may comprise resilient material as discussed above to be resiliently deformable, in addition to motion allowed by the movable mechanical joint 300.

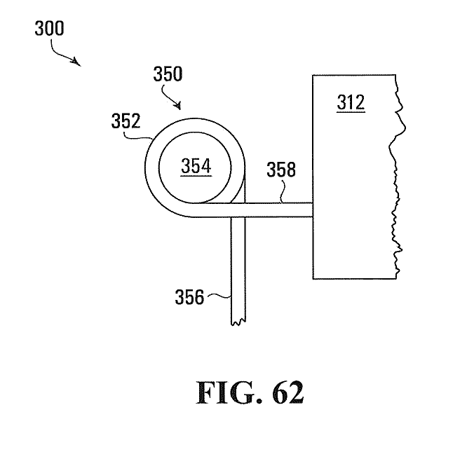

In some embodiments, with additional reference to FIG. 62, the movable mechanical joint 300 of the track-engaging assembly 124 may comprise a resilient device 350 for biasing the orientation of the upper portion 161 of the rail 144 relative to the sliding surface 177 towards a predetermined orientation. The resilient device 350 comprises a spring 352. The spring 352 may be a coil spring, a torsion spring, a leaf spring, an elastomeric spring (e.g., a rubber spring), a fluid spring (e.g., an air spring), or any other object that is operable to change in configuration from a first configuration to a second configuration in response to a load and recover the first configuration in response to removal of the load.

For example, in this embodiment, the spring 352 of the resilient device 350 may comprise a torsion spring mounted on a pin 354 which is connected to the slider 33 (not shown in FIG. 62). The spring 352 comprises first and second ends 356, 358 which are respectively connected to the slider 133 and the rail 144. More specifically, the first end 356 of the spring 352 may be connected to the base 170 of the slider 133 while the second end 358 of the spring 352 may be connected to the first engaging member 312 of the lower portion 163 of the rail 144 (e.g., to the housing 316).

Thus, when the upper portion 161 of the rail 144 moves to its inclined position (as illustrated in FIG. 61), the first engaging member 312 of the rail 144 rotates about the roll axis R_{A} and moves the second end 358 of the spring 352 such as to cause a bending moment at the spring 352. The spring 352 resists this movement by applying a force proportional to a stiffness of the spring 352 on the first engaging member 312 via the second end 358. The force applied by the spring 352 on the first engaging member 312 tends to bias the orientation of the upper portion 161 of the rail 144 relative to the sliding surface 177 towards a predetermined orientation which in this case coincides with the neutral position of the upper portion 161 of the rail 144 (i.e., when the lateral axis L_{A} is substantially parallel to the sliding surface 177 of the slider 133).

The resilient device 350 may thus aid the user of the snow vehicle 10 in centering his/her body mass relative to the snow vehicle 10 such that his/her center of gravity is substantially aligned with the central axis C_{A}′. More specifically, the stiffness of the spring 352 may not be sufficient to stop the user from changing the orientation of the upper portion 161 of the rail 144 when he/she offsets his/her center of gravity from the central axis C_{A}′, but the spring 352 may facilitate the movement of the upper portion 161 of the rail 144 towards its neutral position (i.e., when the lateral axis L_{A} is substantially parallel to the sliding surface 177 of the slider 133) when the user wishes to reorient the upper portion 161 of the rail 144 towards the neutral position.

The resilient device 350 may comprise another spring similar to the spring 352 on an opposite lateral side of the rail 144 to have a similar effect on movement of the upper portion 161 of the rail 144 relative to the sliding surface 177 towards the opposite side of the track system 16.

Movement of the upper portion 161 of the rail 144 relative to the sliding surface 177 may be implemented in any other suitable way in other embodiments.

Although embodiments considered above relate to movement of the upper portion 61 of the rail 144 relative to the sliding surface 177, principles disclosed herein may be applied to other components of the interface 192 of the track-engaging assembly 124 with the bottom run 166 of the track 121 such that, when the snow vehicle 10 travels on the ground, an orientation of one or more other surfaces of the track-engaging assembly 124 that are in contact with the bottom run 166 of the track 121, such as the circumferential surface 194 of each of one or more of the idler wheels 126₁, 126₂, 128₁-128₆, relative to the frame 11 of the snow vehicle 10 is variable.

For example, in some embodiments, the circumferential surface 194 of each of one or more of the idler wheels 126₁, 126₂, 128₁-128₆ may be rotatable relative to the frame of the 11 of the snow vehicle 10 about the roll axis R_{A} due to compliance of the polymeric material 186 of the rail 144 (e.g., which has been blow-molded) that provides some “give” allowing a change in orientation of the axle of each of these one or more idler wheels relative to the frame 11 of the snow vehicle 10 (i.e., (i.e., deformation of the polymeric material 186 around the idler wheel's axle). For instance, in some embodiments, the polymeric material 186 of the rail 144 may deform to allow an angular displacement of the axle of the idler wheel relative to the frame 11 of the snow vehicle 10 of at least 5°, in some cases at least 10°, in some cases at least 15°, in some cases at least 20°, and in some cases even more. In some examples, this may allow a linear displacement of the axle of the idler wheel relative to the frame 11 of the snow vehicle 10 of at least 5 mm, in some cases at least 10 mm, and in some cases even more.

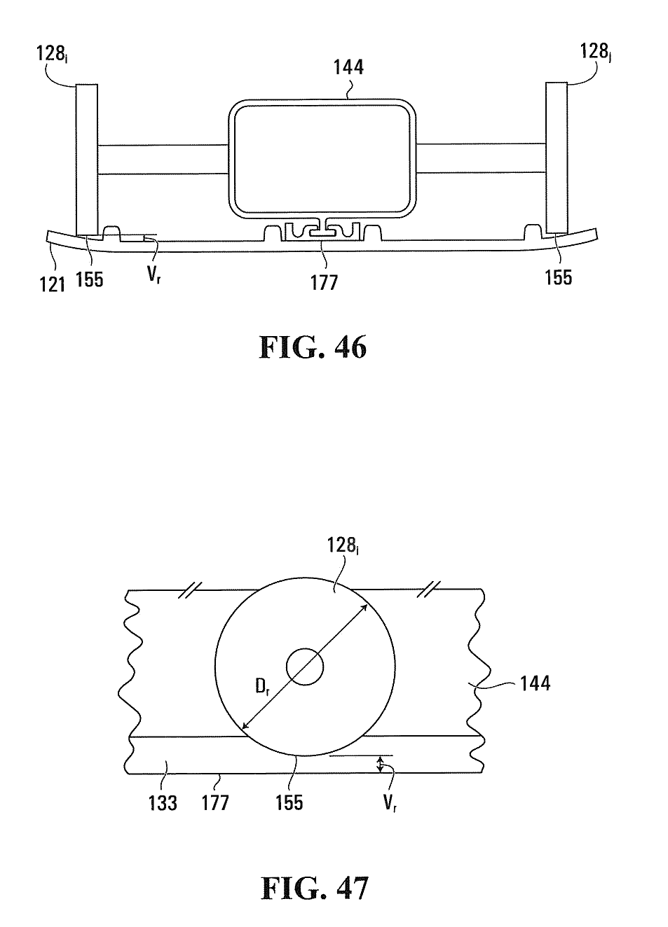

In addition to or instead of being allowed by changing the orientation of one or more of the surfaces of the track-engaging assembly 124 that are in contact with the bottom run 166 of the track 121 relative to the frame 11 of the vehicle 10, in some embodiments, movement of the bottom run 166 of the track 121 relative to the frame 11 of the vehicle 10 in the heightwise direction of the vehicle 10 to facilitate transitioning to the leaning position of the vehicle 10 may be allowed by the offset Vᵣ between the sliding surface 177 of the rail 144 and the bottom 155 of each of the roller wheels 128₁-128₆ in the heightwise direction of the track system 16, as discussed above in relation to FIGS. 46 and 47. Notably, this allows the bottom run 166 of the track 121 to deflect until it engages the bottom 155 of one or more of the roller wheels 128₁-128₆ when the vehicle 10 is leaning.

Thus, in some embodiments, as the vehicle 10 transitions from its upright position to its leaning position, there may first be a change in the orientation of one or more of the surfaces of the track-engaging assembly 124 that are in contact with the bottom run 166 of the track 121 relative to the frame 11 of the vehicle 10 and then the bottom run 166 of the track 121 may deflect because of the offset Vᵣ between the sliding surface 177 of the rail 144 and the bottom 155 of each of the roller wheels 128₁-128₆.

In this embodiment, the track system 16 comprises a mounting arrangement 210 to mount the track system 16 to the snow bike 10. More particularly, in this embodiment, the mounting arrangement 210 comprises a transmission 212 for transmitting power from the powertrain 12 of the snow bike 10 to the drive wheels 122₁, 122₂ of the track-engaging assembly 124, and a subframe 214 for interconnecting the frame 123 of the track system 16 and the frame 11 of the snow bike 10.

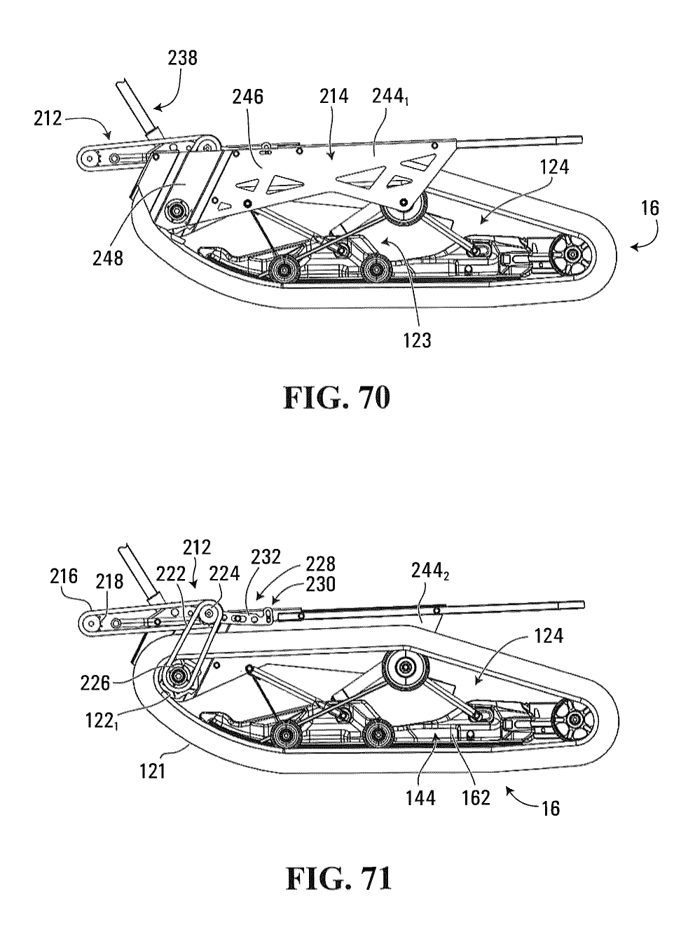

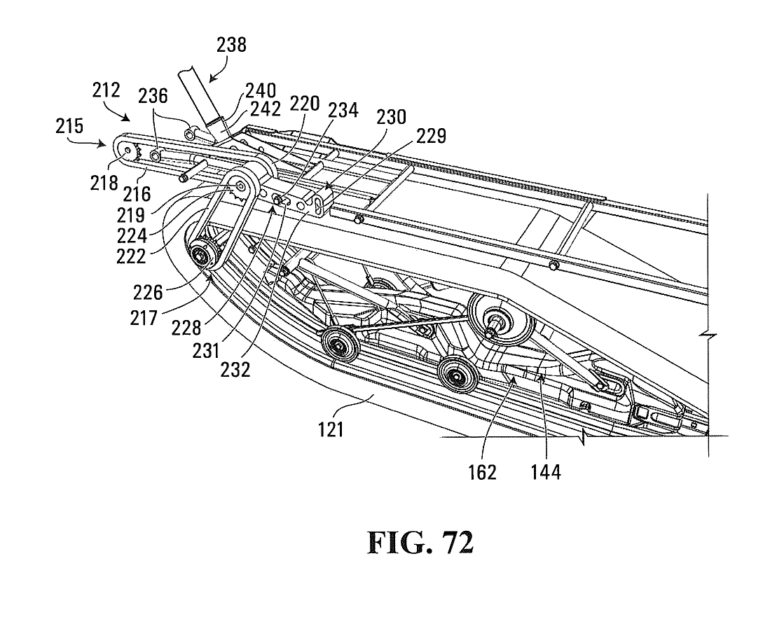

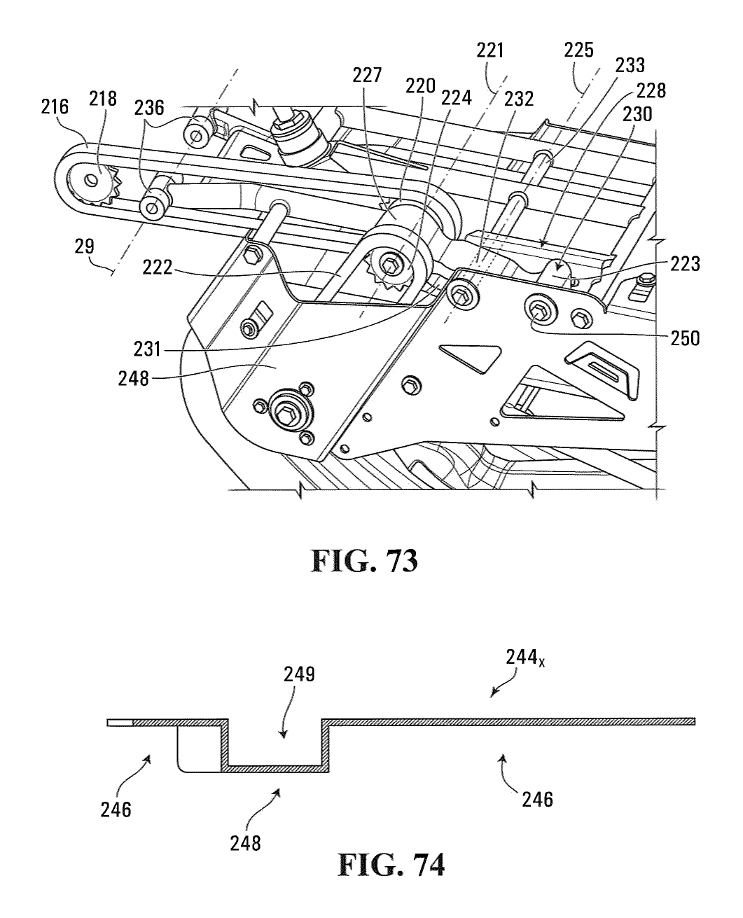

In this example, with reference to FIGS. 70 to 73, the transmission 212 comprises an input transmission portion 215 and an output transmission portion 217. The input transmission portion 215 comprises wheels 218, 220 and an elongate transmission link 216 for transmitting motion between the wheel 218 and the wheel 220. The wheel 218 of the input transmission portion 215 is configured to be rotated by power from the powertrain 12 of the snow bike 10 (e.g., mounted to a driven axle of the powertrain 12). The output transmission portion 217 comprises wheels 224, 226 and an elongate transmission link 222 for transmitting motion between the wheel 224 and the wheel 226. The wheel 226 is configured to rotate the drive wheels 122₁, 122₂ of the track system 16 (e.g., mounted to an axle to which the drive wheels 122₁, 122₂ are mounted). The wheel 220 of the input transmission portion 215 and the wheel 224 of the output transmission portion 217 are mounted on a floating axle 219 which defines an axis of rotation 221 that is common to both of the wheels 220, 224. In this case, each of the elongate transmission links 216, 222 is a chain and each of the wheels 218, 220, 224, 226 is a sprocket. The elongate transmission link 216, 222 and/or the wheels 218, 220, 224, 226 may be implemented in any other suitable way in other embodiments (e.g., transmission belts).

In this embodiment, the mounting arrangement 210 of the track system 16 comprises a tensioner 228 for adjusting a tension in each of the chains 216, 222. In this example, the tensioner 228 is configured to simultaneously adjust the tension in each of the chains 216, 222.

More particularly, in this embodiment, the tensioner 228 comprises an actuator 230 movable in response to a command to adjust the tension in each of the chains 216, 222. In this example, the actuator 230 is manually operable by a user such that the command can be provided by the user by manually operating the actuator 230.

The actuator 230 may be implemented in any suitable way. For example, in this embodiment, the actuator 230 comprises a lever 232 carrying the sprockets 220, 224 and movable relative to the frame 123 of the track system 16 to change a position of the sprockets 220, 224 relative to the sprockets 218, 226. More particularly, the lever 232 comprises a proximal end portion 223 from which the lever 232 may be grasped and a distal end portion 227 receiving the floating axle 219 (e.g., via a bearing) which supports the sprockets 220, 224. The lever 232 also comprises a first opening 231 between the proximal and distal end portions 223, 227 and a second opening 229 at the proximal end portion 223. The first opening 231 receives therein a fixed axle 233 of the subframe 214 that extends in the widthwise direction of the track system 16. The second opening 229 is configured to receive a fastener 250 for affixing the lever 232 to the subframe 214.

The floating axle 219 is selectively movable via actuation of the lever 232. In particular, when the fastener 250 is loosened from engagement with a corresponding fastening element (e.g., a nut), the lever 232 is pivotable about a pivot 234 defined by the fixed axle 233 and having a pivot axis 225. This allows the floating axle 219, which is supported at the distal portion 227 of the lever 232, to pivot about the pivot axis 225. In this example, the second opening 229 of the lever 232 is a slot (e.g., an arcuate slot) in order to allow the proximal end portion 223 of the lever 232 to be secured to the subframe 214 once the lever 232 has been pivoted.

The floating axle 219 may also be displaced linearly by the lever 232. More specifically, the first opening 231 of the lever 232 can be a slot extending in a longitudinal direction of the lever 232 such that the lever 232 can be displaced linearly through the engagement of the fixed axle 233 with the slot 231 of the lever 232. In this case, an opening in an elongated lateral member of the subframe 214 which receives therein the fastener 250 may be configured as a slot that extends in the longitudinal direction of the track system 16.

The pivoting and linear motions of the floating axle 219 allows selectively moving the floating axle 219 and therefore the sprockets 220, 224 closer to or further from the sprockets 218, 226. This movement of the sprockets 220, 224 induces a change in the tension of each of the chains 216, 222 that can be effected simultaneously.

In other embodiments, the actuator 230 may comprise any other type of actuator. For instance, in some embodiments, the actuator 230 may comprise an electromechanical actuator (e.g., a linear actuator) or a fluidic actuator (e.g., a hydraulic or pneumatic actuator). Also, in other embodiments, the command for moving the actuator 230 may be generated automatically (e.g., by a sensor sensing that the tension is inappropriate and is to be changed).

The subframe 214 of the mounting arrangement 210 comprises a plurality of links 236, 238 between the frame 123 of the track system 16 and the frame 11 of the motorcycle 10. In this embodiment, the link 236 pivotally interconnects the frame 123 of the track system 16 and the frame 11 of the motorcycle 10 to allow vertical movement of the frame 123 of the track system 16 relative to the frame 11 of the motorcycle 10. In this case, the link 236 pivotally interconnects the frame 123 of the track system 16 and the frame 11 of the motorcycle 10 at a pivot axis 29 of the frame 11 of the motorcycle 10 at which the swing arm 61 of the motorcycle 10 would be connected. The link 238 extends between the frame 123 of the track system 16 and a mount 255 on the frame 11 of the motorcycle 10 at which the shock absorber 59 of the motorcycle's rear suspension unit 25 would be connected.

In this embodiment, the link 238 is resiliently deformable (i.e., changeable in configuration) to allow the frame 123 of the track system 16 to move relative to the frame 11 of the motorcycle 10. This may help to absorb shocks and/or otherwise improve ride comfort. More particularly, the link 238 comprises a resilient element 240 that is configured to resiliently deform (i.e., change in configuration) from a first configuration to a second configuration in response to a load and recover the first configuration in response to removal of the load. For example, in this embodiment, the resilient element 240 comprises an elastomeric material 242 (e.g., rubber). In other embodiments, the resilient element 240 comprises a spring, such as a coil spring (e.g., a metallic or polymeric coil spring), an elastomeric spring (e.g., a rubber spring), a leaf spring, a fluid spring (i.e., a spring including a liquid or gas contained in a container such as a cylinder or a bellows and variably compressed by a piston or other structure, such as an air spring or other gas spring or a piston-cylinder arrangement), or any other elastic object that changes in configuration under load and recovers its initial configuration when the load is removed.

In this embodiment, the subframe 214 comprises a pair of elongated lateral members 244₁, 244₂ that are elongated in the longitudinal direction of the track system 16 and disposed outside of the lateral edges 129₁, 129₂ of the track 121 such that the track 121 is located between the elongated lateral members 244₁, 244₂ of the subframe 214. As shown in FIG. 74 which portrays a top cross-sectional view of an elongated lateral member 244ₓ, in this embodiment, the elongated lateral member 244ₓ comprises a first portion 246 and a second portion 248 that projects laterally outwardly from the first portion 246 to define a recess 249 to receive the sprockets 224, 226 and the chain 222. The first portion 246 of the elongated lateral member 244ₓ is thus closer to the track 121 than the second portion 248 of that elongated lateral member 244ₓ in the widthwise direction of the track system 16. This reduces an envelope of the track system 16, which may provide more space for the user (e.g., around footrests of the motorcycle 10).

In this example, each of the elongated lateral members 244₁, 244₂ is plate-like with its first portion 246 being generally planar. The elongated lateral members 244₁, 244₂ may have any other suitable shape in other embodiments. Moreover, in some embodiments, the subframe 214 may comprise additional elongated lateral members 245₁, 245₂ configured to be connected with the elongated lateral members 244₁, 244₂ in order to cover for the transmission 212.

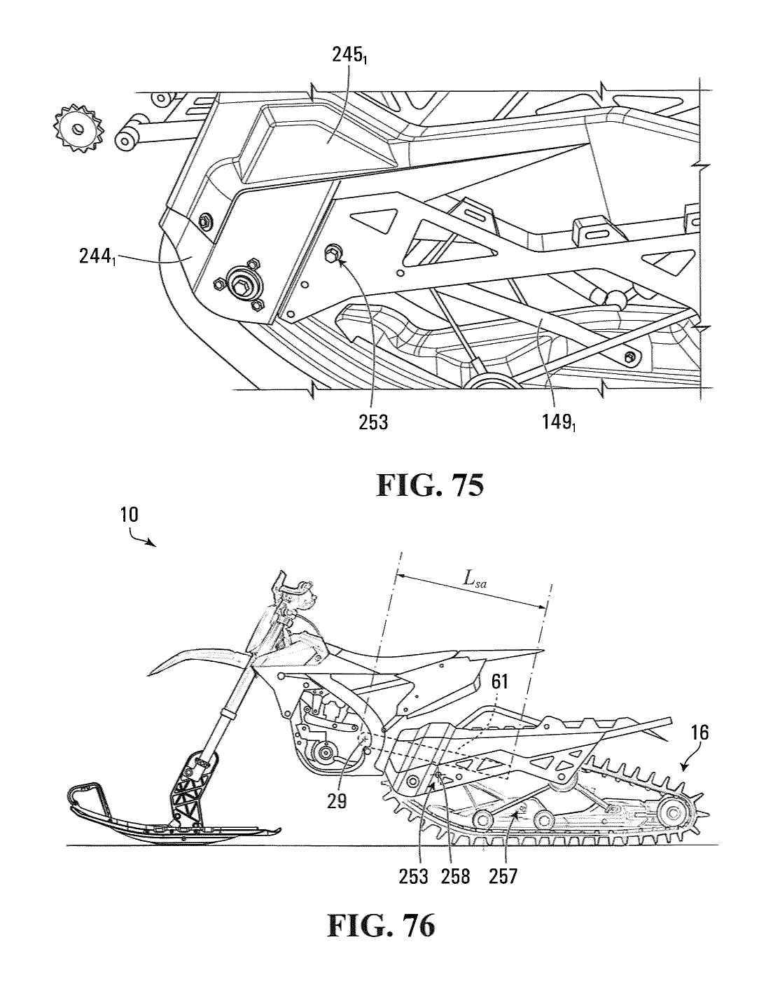

In this embodiment, as shown in FIG. 75, the frame member 149₁ of the frame 123 of the track system 16 extends upwardly and forwardly from the rail 144 to the subframe 214 of the mounting arrangement 210 to interconnect the rail 144 and the subframe 214 such that the rail 144 is movable relative to the subframe 214. In this embodiment, the rail 144 is pivotable relative to the subframe 214. More particularly, in this embodiment, the frame member 149₁ is pivotally mounted to the subframe 214 at a pivot 253 and pivotally mounted to the rail 144 at a pivot 257.

In some embodiments, a pivot axis 258 of the pivot 253 between the link 149₁ of the frame 123 and the subframe 214 may be located so as to optimally balance loading (e.g., weight) between the track system 16 in the rear of the vehicle 10 and the ski system 14 in the front of the vehicle 10.

For example, in this embodiment where the track system 16 replaces the rear wheel 19 of the motorcycle 10 that would be carried by the swing arm 25, a distance between the pivot axis 29 of the motorcycle 10 and the pivot axis 258 of the pivot 253 between the link 149₁ and the subframe 214 may be related to (e.g., less than) a length Lₛₐ of the swing arm 25 of the motorcycle 10 that has been removed. For instance, with additional reference to FIG. 76, in some embodiments, a ratio of (i) the distance between the pivot axis 29 of the motorcycle 10 and the pivot axis 258 of the pivot 253 between the link 149₁ and the subframe 214 over (ii) the length Lₛₐ of the swing arm 25 of the motorcycle 10 that has been removed may be no more than 0.8, in some cases no more than 0.7, in some cases no more than 0.6, and in some cases even less (e.g., 0.5).

This positioning of the pivot axis 258 of the pivot 253 may allow a better distribution of the weight of the vehicle 10 between the ski system 14 and the track system 16 compared to conventional track system designs. For example, this may allow a decreased weight being applied at the ski system 14 compared to similar vehicles equipped with conventional track designs. In some cases, it may enhance performance of the vehicle 10 on flat and rough terrain and/or result in a better balance of stability and hill climbing ability of the vehicle 10.

In some embodiments, a leaning capability of the ski system 14 and a leaning capability of the track 16 when the vehicle 10 is banked may be generally “matched”. For instance, in some embodiments, the leaning angle β allowed by the ski 28 of the ski system 14 and the leaning angle δ allowed by the track system 16 may be similar. For example, in some embodiments, a ratio of the leaning angle β allowed by the ski 28 of the ski system 14 over the leaning angle δ allowed by the track system 16 may be between 1.15 and 0.85, in some cases between 1.1 and 0.9, in some cases between 1.05 and 0.95, and in some cases closer to or even equal to 1.

Although in this embodiment the snow vehicle 10 is a motorcycle in which the ski system 14 and the track system 16 are part of the conversion system 13 that is mounted in place of the front wheel 17 and the rear wheel 19 of the motorcycle, in other embodiments, the snow vehicle 10 may be designed and originally built with the ski system 14 and the track system 16 by a manufacturer of the snow vehicle 10, i.e., the snow vehicle 10 may never have been a motorcycle.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Any feature of any embodiment discussed herein may be combined with any feature of any other embodiment discussed herein in some examples of implementation.

In case of any discrepancy, inconsistency, or other difference between terms used herein and terms used in any document incorporated by reference herein, meanings of the terms used herein are to prevail and be used.

Although various embodiments and examples have been presented, this was for the purpose of describing, but not limiting, the invention. Various modifications and enhancements will become apparent to those of ordinary skill in the art and are within the scope of the invention, which is defined by the appended claims.

1. A ski system for a vehicle on snow, the ski system comprising:
a) a ski to slide on the snow; and
b) a ski mount to connect the ski to the vehicle;
wherein the ski is configured to facilitate a transition from an upright position of the vehicle to a leaning position of the vehicle when the vehicle is banked.

2. The ski system of claim 1, wherein: the ski comprises a ground-engaging lower side to slide on the snow and an upper side opposite to the ground-engaging lower side and facing towards the ski mount; and the ground-engaging lower side of the ski comprises a ground-engaging lower surface and a plurality of keels projecting from the ground-engaging lower surface and spaced apart in a widthwise direction of the ski.

3. The ski system of claim 2, wherein the plurality of keels comprises four keels.

4. The ski system of claim 2, wherein: the plurality of keels comprises a plurality of central keels and a plurality of lateral keels; and the central keels are disposed between the lateral keels in the widthwise direction of the ski.

5. The ski system of claim 4, wherein each central keel projects lower than each lateral keel in a thickness direction of the ski.

6. The ski system of claim 5, wherein the central keel is taller than the lateral keel.

7. The ski system of claim 6, wherein a ratio of a height of the central keel over a height of the lateral keel is at least 2.

8. The ski system of claim 7, wherein the ratio of the height of the central keel over the height of the lateral keel is at least 3.

9. The ski system of claim 4, wherein the central keels are spaced from a midpoint of the ski in the widthwise direction of the ski.

10. The ski system of claim 4, wherein a ratio of a spacing of the central keels in the widthwise direction of the ski over a width of the ski is at least 0.2.

11. The ski system of claim 10, wherein the ratio of the spacing of the central keels in the widthwise direction of the ski over the width of the ski is at least 0.3.

12. The ski system of claim 1, wherein: the ski comprises a ground-engaging lower side to slide on the snow and an upper side opposite to the ground-engaging lower side and facing towards the ski mount; and a ratio of a dimension of a bottom area of the ground-engaging lower side of the ski in the widthwise direction of the ski over a width of the ski is at least 0.2.

13. The ski system of claim 12, wherein the ratio of the dimension of the bottom area of the ground-engaging lower side of the ski in the widthwise direction of the ski over the width of the ski is at least 0.4.

14. The ski system of claim 1, wherein the ski allows a leaning angle of at least 20°.

15. The ski system of claim 1, wherein the ski allows a leaning angle of at least 25°.

16. The ski system of claim 1, wherein the ski is configured to apply more pressure on the ground inward of a midpoint of the ski in a widthwise direction of the ski when the vehicle is banked.

17. The ski system of claim 1, wherein the ski is configured to apply more pressure on the ground inside of a turning radius of the vehicle.

18. The ski system of claim 1, wherein the ski is configured such that, when the vehicle is banked, a point of maximal pressure of the ski on the ground is located inward of a midpoint of the ski in a widthwise direction of the ski.

19. The ski system of claim 18, wherein the point of maximal pressure of the ski on the ground is located between a lateral edge of the ski and the midpoint of the ski in the widthwise direction of the ski.

20. The ski system of claim 4, wherein the central keels and the lateral keels are shaped to create a body of snow between a given one the central keels and an adjacent one of the lateral keels when the vehicle is banked that is similar to a body of snow between the central keels when the vehicle is upright.

21. The ski system of claim 4, wherein the central keels and the lateral keels are shaped to create a body of snow between a given one the central keels and an adjacent one of the lateral keels when the vehicle is banked that tapers upwardly and a body of snow between the central keels when the vehicle is upright that tapers upwardly.

22. The ski system of claim 4, wherein: the central keels and the lateral keels are shaped to create a body of snow between a given one the central keels and an adjacent one of the lateral keels when the vehicle is banked and a body of snow between the central keels when the vehicle is upright; and a ratio between a cross-sectional area of the body of snow between the given one of the central keels and the adjacent one of the lateral keels when the vehicle is banked and a cross-sectional area of the body of snow between the central keels when the vehicle is upright is between 0.7 and 1.3.

23. The ski system of claim 22, wherein the ratio between the cross-sectional area of the body of snow between the given one of the central keels and the adjacent one of the lateral keels when the vehicle is banked and the cross-sectional area of the body of snow between the central keels when the vehicle is upright is between 0.8 and 1.2.

24. The ski system of claim 1, wherein lowest points of the ski are spaced from a steering axis of the ski.

25. The ski system of claim 4, wherein the central keels are spaced from a steering axis of the ski.

26. The ski system of claim 4, wherein segments of the central keels move generally tangentially to a rotational motion of the ski about a steering axis of the ski.

27. The ski system of claim 1, wherein a ratio of (i) a lateral distance between a lowest point of the ski and a steering axis of the ski in a widthwise direction of the ski over (ii) a width of the ski is at least 0.2.

28. The ski system of claim 27, wherein the ratio of (i) the lateral distance between the lowest point of the ski and the steering axis of the ski in the widthwise direction of the ski over (ii) the width of the ski is at least 0.3.

29. The ski system of claim 1, wherein the ski is pivotable relative to the ski mount about a pivot axis.

30. The ski system of claim 29, wherein the pivot axis is located such that a drag force of the snow on the ski substantially does not create a moment on the ski about the pivot axis.

31. The ski system of claim 29, wherein the pivot axis is located to intersect a drag force of the snow on the ski.

32. The ski system of claim 29, wherein the pivot axis is not located above a floatation surface of an upper side of the ski.

33. The ski system of claim 32, wherein the pivot axis is located below the floatation surface of the upper side of the ski.

34. The ski system of claim 1, wherein: the ski comprises a ground-engaging lower side to slide on the snow and an upper side opposite to the ground-engaging lower side and facing towards the ski mount; the ground-engaging lower side of the ski comprises a ground-engaging lower surface and a plurality of keels projecting from the ground-engaging lower surface and spaced apart in a widthwise direction of the ski; the ski is pivotable relative to the ski mount about a pivot axis; and the pivot axis intersects at least one of the keels.

35. The ski system of claim 29, wherein the pivot axis is disposed to create a trail of the ski forward of a connection of the ski mount to a front steerable member of the vehicle.

36. The ski system of claim 35, wherein the pivot axis is located forward of the connection of the ski mount to the front steerable member of the vehicle in a longitudinal direction of the ski system.

37. The ski system of claim 36, wherein a ratio of (i) a distance between the pivot axis and the connection of the ski mount to the front steerable member of the vehicle in the longitudinal direction of the ski system over (ii) a distance between the connection of the ski mount to the front steerable member of the vehicle and an intersection of a steering axis of the ski with the ground in the longitudinal direction of the ski system is at least 0.1.

38. The ski system of claim 37, wherein the ratio of (i) the distance between the pivot axis and the connection of the ski mount to the front steerable member of the vehicle in the longitudinal direction of the ski system over (ii) the distance between the connection of the ski mount to the front steerable member of the vehicle and the intersection of the steering axis of the ski with the ground in the longitudinal direction of the ski system is at least 0.3.

39. The ski system of claim 29, wherein the ski comprises a front rocker section and a rear flat section.

40. The ski system of claim 39, wherein the front rocker section extends over at least a majority of a distance between the pivot axis of the ski and a front end of the ski in a longitudinal direction of the ski.

41. The ski system of claim 40, wherein the front rocker section extends over at least three-quarters of the distance between the pivot axis of the ski and the front end of the ski in the longitudinal direction of the ski.

42. The ski system of claim 40, wherein the front rocker section extends over at least four-fifths of the distance between the pivot axis of the ski and the front end of the ski in the longitudinal direction of the ski.

43. The ski system of claim 40, wherein the front rocker section extends over substantially an entirety of the distance between the pivot axis of the ski and the front end of the ski in the longitudinal direction of the ski.

44. The ski system of claim 29, wherein the ski is curved upwardly from the pivot axis of the ski to a front end of the ski.

45. The ski system of claim 1, wherein the ski mount is resiliently deformable.

46. The ski system of claim 1, wherein the ski mount is connectable to a front steerable member of the vehicle and is not stiffer than the front steerable member of the vehicle.

47. The ski system of claim 1, wherein the ski mount is connectable to a front steerable member of the vehicle and is less stiff than the front steerable member of the vehicle.

48. The ski system of claim 47, wherein a torsional stiffness of the ski mount is less than a torsional stiffness of the front steerable member of the vehicle.

49. The ski system of claim 47, wherein a bending stiffness of the ski mount is less than a bending stiffness of the front steerable member of the vehicle.

50. The ski system of claim 1, wherein the ski mount comprises a resilient material.

51. The ski system of claim 50, wherein the resilient material makes up at least a majority of the ski mount.

52. The ski system of claim 50, wherein a modulus of elasticity of the resilient material is no more than 20 GPa.

53. The ski system of claim 50, wherein the resilient material is a polymeric material.

54. The ski system of claim 50, wherein the ski mount comprises a hollow structural member made of the resilient material.

55. The ski system of claim 1, wherein the ski mount is configured to be clamped to a front steerable member of the vehicle.

56. The ski system of claim 1, wherein the ski mount is adjustably connectable to a front steerable member of the vehicle.

57. The ski system of claim 56, wherein the ski mount is configured to adjust a position in which the ski mount is connected to the front steerable member of the vehicle in a heightwise direction of the vehicle.

58. The ski system of claim 57, wherein a ratio of a distance of adjustment of the position in which the ski mount is connected to the front steerable member of the vehicle over a height of the ski mount is at least 0.1.

59. The ski system of claim 1, wherein the ski is a sole ski of the vehicle when the ski mount connects the ski to the vehicle.

60. The ski system of claim 1, wherein the ski is disposed in a center of the vehicle in a widthwise direction of the vehicle when the ski mount connects the ski to the vehicle.

61. The ski system of claim 1, wherein the ski system is configured to replace a front wheel of the vehicle and the ski is disposed to contact the ground where the front wheel would contact the ground.

62. The ski system of claim 1, wherein the ski system is configured to replace a front wheel of the vehicle.

63. The ski system of claim 2, wherein the ski mount is configured to connect the ski to a front steerable member of the vehicle.

64. The ski system of claim 1, wherein the vehicle is a motorcycle and the ski system is configured to replace a front wheel of the motorcycle.

65. The ski system of claim 4, wherein the ski mount is configured to connect the ski to a front fork of the motorcycle.

66. A vehicle comprising the ski system of claim 1.

67. The vehicle of claim 66, wherein the vehicle is a motorcycle and the ski system replaces a front wheel of the motorcycle.

68. A ski system for a vehicle on snow, the ski system comprising:
a) a ski to slide on the snow; and
b) a ski mount to connect the ski to the vehicle;
wherein: the ski is disposed in a center of the vehicle in a widthwise direction of the vehicle when the ski mount connects the ski to the vehicle; the ski comprises a ground-engaging lower side to slide on the snow and an upper side opposite to the ground-engaging lower side and facing towards the ski mount; and the ground-engaging lower side of the ski comprises a ground-engaging lower surface and four keels projecting from the ground-engaging lower surface and spaced apart in a widthwise direction of the ski.

69. A ski system for a vehicle on snow, the ski system comprising:
a) a ski to slide on the snow; and
b) a ski mount to connect the ski to the vehicle;
wherein: the ski is disposed in a center of the vehicle in a widthwise direction of the vehicle when the ski mount connects the ski to the vehicle; the ski comprises a ground-engaging lower side to slide on the snow and an upper side opposite to the ground-engaging lower side and facing towards the ski mount; the ground-engaging lower side of the ski comprises a ground-engaging lower surface and a plurality of keels projecting from the ground-engaging lower surface and spaced apart in a widthwise direction of the ski; and every keel of the ski is spaced from a midpoint of the ski in the widthwise direction of the ski.

70. A ski system for a vehicle on snow, the ski system comprising:
a) a ski to slide on the snow; and
b) a ski mount to connect the ski to the vehicle;
wherein the ski allows a leaning angle of at least 20°.

71. A ski system for a vehicle on snow, the ski system comprising:
a) a ski to slide on the snow; and
b) a ski mount to connect the ski to the vehicle;
wherein the ski is configured to apply more pressure on the ground inward of a midpoint of the ski in a widthwise direction of the ski when the vehicle is banked.

72. A ski system for a vehicle on snow, the ski system comprising:
a) a ski to slide on the snow; and
b) a ski mount to connect the ski to the vehicle;
wherein lowest points of the ski are spaced from a steering axis of the ski.

73. A ski system for a vehicle on snow, the ski system comprising:
a) a ski to slide on the snow; and
b) a ski mount to connect the ski to the vehicle;
wherein: the ski is pivotable relative to the ski mount about a pivot axis; and the pivot axis is located to intersect a drag force of the snow on the ski.

74. A ski system for a vehicle on snow, the ski system comprising:
a) a ski to slide on the snow; and
b) a ski mount to connect the ski to the vehicle;
wherein: the ski is pivotable relative to the ski mount about a pivot axis; and the pivot axis is not located above a floatation surface of an upper side of the ski.

75. A ski system for a vehicle on snow, the ski system comprising:
a) a ski to slide on the snow; and
b) a ski mount to connect the ski to the vehicle;
wherein: the ski is pivotable relative to the ski mount about a pivot axis; and the pivot axis is located forward of a connection of the ski mount to a front steerable member of the vehicle in a longitudinal direction of the ski system.

76. A ski system for a vehicle on snow, the ski system comprising:
a) a ski to slide on the snow; and
b) a ski mount to connect the ski to the vehicle;
wherein: the ski is pivotable relative to the ski mount about a pivot axis; the ski comprises a front rocker section and a rear flat section; and the front rocker section extends over at least a majority of a distance between the pivot axis of the ski and a front end of the ski in a longitudinal direction of the ski.

77. A ski system for a vehicle on snow, the ski system comprising:
a) a ski to slide on the snow; and
b) a ski mount to connect the ski to the vehicle;
wherein the ski mount is resiliently deformable.

78. A ski system for a vehicle on snow, the ski system comprising:
a) a ski to slide on the snow; and
b) a ski mount to connect the ski to a front steerable member of the vehicle;
wherein the ski mount is less stiff than the front steerable member of the vehicle.

79. A ski system for a vehicle on snow, the ski system comprising:
a) a ski to slide on the snow; and
b) a ski mount to connect the ski to a front steerable member of the vehicle, wherein the ski mount is adjustably connectable to a front steerable member of the vehicle.

80. A track for a track system providing traction to a vehicle, the track system being disposed in a rear of the vehicle, the vehicle comprising a ski system disposed in a front of the vehicle and turnable to steer the vehicle, the ski system comprising a ski disposed in a center of the vehicle in a widthwise direction of the vehicle, the track system comprising a track-engaging assembly to drive the track and guide the track around the track-engaging assembly, the track being elastomeric to move around the track-engaging assembly, the track comprising:
a) an inner side for facing the track-engaging assembly;
b) a ground-engaging outer side for engaging the ground, the ground-engaging outer side comprising a ground-engaging outer surface and a plurality of traction projections projecting from the ground-engaging outer surface and spaced apart in a longitudinal direction of the track, each traction projection occupying at least a majority of at least one of lateral halves of the track in a widthwise direction of the track.

81. The track of claim 80, wherein the traction projection occupies at least three-quarters of at least one of the lateral halves of the track in the widthwise direction of the track.

82. The track of claim 80, wherein the traction projection occupies substantially an entirely of at least one of the lateral halves of the track in the widthwise direction of the track.

83. The track of claim 80, wherein the traction projections are staggered relative to one another in the longitudinal direction of the track.

84. A track for a track system providing traction to a vehicle, the track system being disposed in a rear of the vehicle, the vehicle comprising a ski system disposed in a front of the vehicle and turnable to steer the vehicle, the ski system comprising a ski disposed in a center of the vehicle in a widthwise direction of the vehicle, the track system comprising a track-engaging assembly to drive the track and guide the track around the track-engaging assembly, the track being elastomeric to move around the track-engaging assembly, the track comprising:
a) an inner side for facing the track-engaging assembly;
b) a ground-engaging outer side for engaging the ground, the ground-engaging outer side comprising a ground-engaging outer surface and a plurality of traction projections projecting from the ground-engaging outer surface and spaced apart in a longitudinal direction of the track, each traction projection being at least as high in a lateral edge portion of the track than outside of the lateral edge portion of the track, the lateral edge portion of the track extending from a lateral edge of the track in a widthwise direction of the track for no more than 20% of a width of the track.

85. The track of claim 84, wherein the lateral edge portion of the track extends from the lateral edge of the track in the widthwise direction of the track for no more than 10% of the width of the track.

86. The track of claim 84, wherein the lateral edge portion of the track extends from the lateral edge of the track in the widthwise direction of the track for no more than 5% of the width of the track.

87. A track for a track system providing traction to a vehicle, the track system being disposed in a rear of the vehicle, the vehicle comprising a ski system disposed in a front of the vehicle and turnable to steer the vehicle, the ski system comprising a ski disposed in a center of the vehicle in a widthwise direction of the vehicle, the track system comprising a track-engaging assembly to drive the track and guide the track around the track-engaging assembly, the track being elastomeric to move around the track-engaging assembly, the track comprising:
a) an inner side for facing the track-engaging assembly;
b) a ground-engaging outer side for engaging the ground, the ground-engaging outer side comprising a ground-engaging outer surface and a plurality of traction projections projecting from the ground-engaging outer surface and spaced apart in a longitudinal direction of the track, each traction projection remaining substantially level in a widthwise direction of the track.

88. A track system for traction of a vehicle on snow, the track system being mountable in a rear of the vehicle, the vehicle comprising a ski system disposed in a front of the vehicle and turnable to steer the vehicle, the ski system comprising a ski disposed in a center of the vehicle in a widthwise direction of the vehicle, the track system comprising:
a) a track comprising a ground-engaging outer side for engaging the ground and an inner side opposite to the ground-engaging outer side; and
b) a track-engaging assembly for driving and guiding the track around the track-engaging assembly, the track being elastomeric to move around the track-engaging assembly, the track-engaging assembly comprising:
a drive wheel for driving the track; and
an elongate support comprising a rail extending in a longitudinal direction of the track system along a bottom run of the track, the elongate support comprising a sliding surface for sliding on the inner side of the track along the bottom run of the track, the rail comprising polymeric material making up at least a majority of the rail.

89. The track system of claim 88, wherein the rail overlaps a centerline of the track in a widthwise direction of the track system.

90. The track system of claim 88, wherein the rail comprises a hollow interior.

91. The track system of claim 88, wherein the elongate support comprises an elongate reinforcement extending along at least part of the rail and including reinforcing material that is stiffer than the polymeric material of the rail.

92. A track system for traction of a vehicle on snow, the track system being mountable in a rear of the vehicle, the vehicle comprising a ski system disposed in a front of the vehicle and turnable to steer the vehicle, the ski system comprising a ski disposed in a center of the vehicle in a widthwise direction of the vehicle, the track system comprising:
a) a track comprising a ground-engaging outer side for engaging the ground and an inner side opposite to the ground-engaging outer side; and
b) a track-engaging assembly for driving and guiding the track around the track-engaging assembly, the track being elastomeric to move around the track-engaging assembly, the track-engaging assembly comprising:
a drive wheel for driving the track; and
an elongate support comprising a rail extending in a longitudinal direction of the track system along a bottom run of the track, the elongate support comprising a sliding surface for sliding on the inner side of the track along the bottom run of the track, the rail overlapping a centerline of the track in a widthwise direction of the track system.

93. A track system for traction of a vehicle on snow, the track system comprising:
a) a track comprising a ground-engaging outer side for engaging the ground and an inner side opposite to the ground-engaging outer side; and
b) a track-engaging assembly for driving and guiding the track around the track-engaging assembly, the track being elastomeric to move around the track-engaging assembly, the track-engaging assembly comprising:
a drive wheel for driving the track;
an elongate support comprising a rail extending in a longitudinal direction of the track system along a bottom run of the track, the elongate support comprising a sliding surface for sliding on the inner side of the track along the bottom run of the track; and
a plurality of roller wheels for rolling on the inner side of the track along the bottom run of the track, the roller wheels being mounted to the elongate support;
wherein, in a cross-section of the track system in a widthwise direction of the track system, the sliding surface and a bottom of a given one of the roller wheels are offset in a heightwise direction of the track system.

94. The track system of claim 93, wherein: the given one of the roller wheels is a first one of the roller wheels; in the cross-section of the track system the widthwise direction of the track system, the sliding surface and a bottom of a second one of the roller wheels are offset in the heightwise direction of the track system; and the sliding surface is disposed between the first one of the roller wheels and the second one of the roller wheels in the widthwise direction of the track system.

95. The track system of claim 93, wherein the bottom of the given one of the roller wheels is located higher than the sliding surface in the heightwise direction of the track system.

96. The track system of claim 93, wherein a ratio of an offset between the sliding surface and the bottom of the given one of the roller wheels in the heightwise direction of the track system over a height of the track system is at least 0.05.

97. The track system of claim 93, wherein the given one of the roller wheels is a first given one of the roller wheels and a diameter of the first given one of the roller wheels is different than a diameter of a second given one of the roller wheels that is spaced from the first given one of the roller wheels in the longitudinal direction of the track system.

98. A track system for traction of a vehicle on snow, the track system comprising:
a) a track comprising a ground-engaging outer side for engaging the ground and an inner side opposite to the ground-engaging outer side; and
b) a track-engaging assembly for driving and guiding the track around the track-engaging assembly, the track being elastomeric to move around the track-engaging assembly, the track-engaging assembly comprising:
a drive wheel for driving the track;
an elongate support comprising a rail extending in a longitudinal direction of the track system along a bottom run of the track, the elongate support comprising a sliding surface for sliding on the inner side of the track along the bottom run of the track; and
a plurality of roller wheels for rolling on the inner side of the track along the bottom run of the track, the roller wheels being mounted to the elongate support;
wherein:
an orientation of a surface of the track-engaging assembly in contact with the bottom run of the track relative to the frame of the vehicle is changeable when the vehicle travels;
in a cross-section of the track system in a widthwise direction of the track system, the sliding surface and a bottom of a given one of the roller wheels are offset in a heightwise direction of the track system; and
when the vehicle transitions from an upright position to a leaning position, the orientation of the surface of the track-engaging assembly in contact with the bottom run of the track relative to the frame of the vehicle changes and then the bottom run of the track deflects because of the sliding surface and the bottom of the given one of the roller wheels that are offset in the heightwise direction of the track system.

99. A system for traction of a vehicle, the system comprising:
a) a ski system mountable in a front of the vehicle and turnable to steer the vehicle, the ski system comprising a ski disposed in a center of the vehicle in a widthwise direction of the vehicle; and
b) a track system mountable in a rear of the vehicle to generate traction, the track system comprising a track and a track-engaging assembly to drive the track and guide the track around the track-engaging assembly, the track being elastomeric to move around the track-engaging assembly, the track comprising a ground-engaging outer side for engaging the ground and an inner side opposite to the ground-engaging outer side;
wherein a leaning capability of the ski system and a leaning capability of the track when the vehicle is banked are generally matched.

100. The track system of claim 99, wherein a ratio of a leaning angle allowed by the ski over a leaning angle allowed by the track system is between 1.15 and 0.85.

101. The track system of claim 99, wherein a ratio of a leaning angle allowed by the ski over a leaning angle allowed by the track system is between 1.1 and 0.9.

102. The track system of claim 99, wherein a ratio of a leaning angle allowed by the ski over a leaning angle allowed by the track system is between 1.05 and 0.95.

103. A track system for traction of a vehicle on snow, the track system being mountable in a rear of the vehicle, the vehicle comprising a ski system disposed in a front of the vehicle and turnable to steer the vehicle, the ski system comprising a ski disposed in a center of the vehicle in a widthwise direction of the vehicle, the track system comprising:
a) a track comprising a ground-engaging outer side for engaging the ground and an inner side opposite to the ground-engaging outer side; and
b) a track-engaging assembly for driving and guiding the track around the track-engaging assembly, the track being elastomeric to move around the track-engaging assembly, the track-engaging assembly comprising a drive wheel for driving the track;
c) a transmission for transmitting power from a powertrain of the vehicle to the drive wheel, the transmission comprising:
an input transmission portion connectable to the powertrain of the vehicle, the input transmission portion comprising wheels and an elongate transmission link to transmit motion between the wheels of the input transmission portion; and
an output transmission portion connectable to the drive wheel, the output transmission portion comprising wheels and an elongate transmission link to transmit motion between the wheels of the output transmission portion; and
d) a tensioner for simultaneously adjusting a tension of the elongate transmission link of the input transmission portion and a tension of the elongate transmission link of the output transmission portion.

104. A track system for traction of a vehicle on snow, the track system being mountable in a rear of the vehicle, the vehicle comprising a ski system disposed in a front of the vehicle and turnable to steer the vehicle, the ski system comprising a ski disposed in a center of the vehicle in a widthwise direction of the vehicle, the track system comprising:
a) a track comprising a ground-engaging outer side for engaging the ground and an inner side opposite to the ground-engaging outer side;
b) a track-engaging assembly for driving and guiding the track around the track-engaging assembly, the track being elastomeric to move around the track-engaging assembly, the track-engaging assembly comprising a drive wheel for driving the track;
c) a transmission for transmitting power from a powertrain of the vehicle to the drive wheel; and
d) a subframe for interconnecting the track system to a frame of the vehicle, the subframe comprising a pair of elongated lateral members that are elongated in a longitudinal direction of the track system and disposed outside of lateral edges of the track such that the track is located between the elongated lateral members, a given one of the elongated lateral members defining a recess to receive at least part of the transmission.
